(19) United States
(12) Patent Application Publication
(10) Pub. No.: US 2021/0277599 A1
(43) Pub. Date: Sep. 9, 2021

(54) SHEET MANUFACTURING APPARATUS AND CONTROL METHOD FOR SHEET MANUFACTURING APPARATUS

(71) Applicant: SEIKO EPSON CORPORATION, Tokyo (JP)

(72) Inventors: Takao MIKOSHIBA, Shiojiri, Nagano (JP); Yoshinobu MONBETSU, Matsumoto, Nagano (JP); Masanori KOJIMA, Suwa-gun, Shimosuwa-machi, Nagano (JP); Takeshi KIMOTO, Ichikawa, Chiba (JP)

(21) Appl. No.: 16/328,391

(22) PCT Filed: Aug. 21, 2017
(86) PCT No.: PCT/JP2017/029759

§ 371 Date: Feb. 26, 2019

(30) Foreign Application Priority Data
Aug. 31, 2016 (JP) 2016-169671

(51) Int. Cl. D21C 5/02; D21H 17/33; D21H 23/20

(52) U.S. Cl. CPC D21C 5/02; G06F 3/14; D21H 23/20; D21H 17/33

(57) ABSTRACT

A sheet manufacturing apparatus is supplied with a raw material including fibers and manufactures a sheet by processing the supplied raw material. The sheet manufacturing apparatus includes a control unit that displays a user interface in which raw material information related to the supplied raw material, manufacturing information related to the manufactured sheet, and processing information related to processing of the sheet are displayed.

### CROSS-REFERENCE TO RELATED APPLICATIONS

This application is a U.S. National stage application of International Patent Application No. PCT/JP2017/029759, filed on Aug. 21, 2017, which claims priority under 35 U.S.C. § 119(a) to Japanese Patent Application No. 2016-169671, filed in Japan on Aug. 31, 2016. The entire disclosure of Japanese Patent Application No. 2016-169671 is hereby incorporated herein by reference.

### TECHNICAL FIELD

The present invention relates to a sheet manufacturing apparatus and a control method for a sheet manufacturing apparatus.

### BACKGROUND ART

In the related art, a technology for displaying a user interface (screen) displaying information for easily managing an operating state of an apparatus in a sheet manufacturing apparatus (old paper recycling processing apparatus) has been known (for example, refer to Japanese Unexamined Patent Application Publication No. 2013-87370).

However, in Japanese Unexamined Patent Application Publication No. 2013-87370, a configuration in which information having the same or similar contents is displayed in one user interface is disclosed. Thus, information that is assumed to be desired to be referred to at the same time by a user may be displayed in different user interfaces. In this case, the user needs to refer to each information by transitioning the user interface, and there is room for improvement in user's convenience of use.

### SUMMARY

The present invention is conceived in view of such a matter, and an object of the invention is to improve user's convenience of use with respect to display of a user interface in a sheet manufacturing apparatus that manufactures a sheet.

In order to resolve the above problem, a sheet manufacturing apparatus of the present invention is a sheet manufacturing apparatus that is supplied with a raw material including fibers and manufactures a sheet by processing the supplied raw material, the apparatus including a control unit that displays a user interface in which raw material information related to the supplied raw material, manufacturing information related to the manufactured sheet, and processing information related to processing of the sheet are displayed.

According to the configuration of the present invention, a user can refer to the raw material information, the manufacturing information, and the processing information at the same time through the same user interface without transitioning the user interface, and user's convenience of use is improved. Particularly, the raw material information, the manufacturing information, and the processing information are information having correlating contents and are assumed to be information that the user desires to refer to at the same time and compare. Thus, according to the present invention, user's convenience of use can be more appropriately improved.

In addition, in the present invention, the raw material information includes at least any one information of information related to an amount of the raw material supplied and consumed in a predetermined period, information related to a remaining amount of the raw material, and information related to the amount of the raw material consumed after manufacturing of the sheet based on the supplied raw material is initiated.

According to the configuration of the present invention, by referring to the user interface, the user can easily and appropriately recognize any of the information related to the amount of the raw material supplied and consumed in a predetermined period, the information related to the remaining amount of the raw material, and the information related to the amount of the raw material consumed after manufacturing of the sheet based on the supplied raw material is initiated.

In addition, in the present invention, the manufacturing information includes at least any one information of information related to the number of sheets manufactured in a predetermined period and information related to the number of sheets manufactured after manufacturing of the sheet based on the supplied raw material is initiated.

According to the configuration of the present invention, by referring to the user interface, the user can easily and appropriately recognize any of the information related to the number of sheets manufactured in a predetermined period and the information related to the number of sheets manufactured after manufacturing of the sheet based on the supplied raw material is initiated.

In addition, in the present invention, the raw material has a paper shape.

According to the configuration of the present invention, user's convenience of use of the sheet manufacturing apparatus that is supplied with the raw material of a paper shape and manufactures the sheet can be improved.

In addition, in the present invention, the user interface is configured with a plurality of blocks corresponding to a content of displayed information, and the raw material information and the manufacturing information are displayed in the same block.

The content of the raw material information is correlated with the content of the manufacturing information. It is assumed that the user desires to refer to the raw material information and the manufacturing information at the same time and compare the contents of those information. Accordingly, by displaying the manufacturing information and the raw material information in the same block, the user can appropriately recognize that the manufacturing information and the raw material information are correlating information, and can refer to those information at the same time and appropriately compare the contents of those information.

In addition, in the present invention, the sheet of a predetermined color is capable of being manufactured, and the processing information includes information related to a color of the manufactured sheet.

According to the configuration of the present invention, by referring to the processing information displayed in the user interface, the user can easily and appropriately recognize the color of the manufactured sheet.

In addition, the present invention further includes a plurality of resin cartridges that retain resin of a plurality of colors by color, in which in a predetermined step of manufacturing the sheet, resin is supplied from one or the plurality of resin cartridges with respect to a predetermined material based on the raw material, and the processing information includes information related to a color of resin supplied with respect to the predetermined material as the information related to the color of the manufactured sheet.

According to the configuration of the present invention, by referring to the processing information in the user interface, the user can easily and appropriately recognize the color of the resin supplied with respect to the predetermined material.

In addition, in the present invention, the processing information includes information related to a proportion of each color as the information related to the color of resin supplied with respect to the predetermined material.

According to the configuration of the present invention, by referring to the processing information in the user interface, the user can easily and appropriately recognize the proportion of the color of the supplied resin.

In addition, in the present invention, the sheet of a predetermined size is capable of being manufactured, and the processing information includes information related to a size of the manufactured sheet.

According to the configuration of the present invention, by referring to the processing information in the user interface, the user can easily and appropriately recognize the size of the manufactured sheet.

In addition, in the present invention, the sheet of a predetermined thickness is capable of being manufactured, and the processing information includes information related to a thickness of the manufactured sheet.

According to the configuration of the present invention, by referring to the processing information in the user interface, the user can easily and appropriately recognize the thickness of the manufactured sheet.

In addition, in the present invention, the control unit displays warning information related to warning as a list in the user interface.

According to the configuration of the present invention, by referring to the user interface, the user can easily and appropriately recognize the warning.

In addition, in the present invention, the control unit displays state information related to a state of an apparatus main body in the user interface.

According to the configuration of the present invention, by referring to the user interface, the user can easily and appropriately recognize the state of the apparatus main body.

In addition, in the present invention, the state information includes information that indicates whether or not a process of manufacturing the sheet is being executed.

According to the configuration of the present invention, by referring to the user interface, the user can easily and appropriately recognize whether or not the sheet manufacturing apparatus 1 is executing the process of manufacturing the sheet.

In addition, in the present invention, the state information includes information related to an operation time from initiation of manufacturing of the sheet based on the supplied raw material.

According to the configuration of the present invention, by referring to the user interface, the user can easily and appropriately recognize the operation time from initiation of manufacturing of the sheet based on the supplied raw material.

In addition, in the present invention, the user interface includes an operation button that provides an instruction to initiate a process of manufacturing the sheet, and the control unit initiates the process of manufacturing the sheet in a case where an operation performed on the operation button is detected.

According to the configuration of the present invention, the user can initiate manufacturing of the sheet by an easy work of operating the operation button without transitioning the user interface to another user interface.

In addition, in order to resolve the above problem, the present invention is a control method for a sheet manufacturing apparatus that is supplied with a raw material including fibers and manufactures a sheet by processing the supplied raw material, the method including displaying a user interface in which raw material information related to the supplied raw material, manufacturing information related to the manufactured sheet, and processing information related to processing of the sheet are displayed.

According to the configuration of the present invention, a user can refer to the raw material information, the manufacturing information, and the processing information at the same time through the same user interface without transitioning the user interface, and user's convenience of use is improved. Particularly, the raw material information, the manufacturing information, and the processing information are information having correlating contents and are assumed to be information that the user desires to refer to at the same time and compare. Thus, according to the present invention, user's convenience of use can be more appropriately improved.

### BRIEF DESCRIPTION OF DRAWINGS

FIG. 1 is a front view of a sheet manufacturing apparatus.

FIG. 2 is a flow of each step when a sheet is manufactured.

FIG. 3 is a block diagram illustrating a functional configuration of the sheet manufacturing apparatus.

FIG. 4 is a diagram illustrating a first user interface.

FIG. 5 is a diagram illustrating a second user interface.

FIG. 6 is a diagram illustrating a third user interface.

FIG. 7 is a diagram illustrating a fourth user interface.

FIG. 8 is a diagram illustrating a fifth user interface.

FIG. 9 is a diagram illustrating the fifth user interface.

FIG. 10 is a diagram illustrating a sixth user interface.

FIG. 11 is a diagram illustrating the fifth user interface.

FIG. 12 is a diagram illustrating the fifth user interface.

FIG. 13 is a diagram illustrating a menu screen.

FIG. 14 is a diagram illustrating a seventh user interface.

FIG. 15 is a diagram illustrating an eighth user interface.

FIG. 16 is a diagram illustrating the seventh user interface.

FIG. 17 is a diagram illustrating a ninth user interface.

FIG. 18 is a diagram illustrating a tenth user interface.

FIG. 19 is a diagram illustrating an eleventh user interface.

FIG. 20 is a diagram illustrating a twelfth user interface.

FIG. 21 is a diagram illustrating a thirteenth user interface.

FIG. 22 is a diagram illustrating a fourteenth user interface.

FIG. 23 is a diagram illustrating a fifteenth user interface.

FIG. 24 is a diagram illustrating a sixteenth user interface.

FIG. 25 is a diagram illustrating the fifteenth user interface.

FIG. 26 is a diagram illustrating the fifteenth user interface.

FIG. 27 is a diagram illustrating the fifteenth user interface.

FIG. 28 is a diagram illustrating a seventeenth user interface.

FIG. 29 is a diagram illustrating an eighteenth user interface.

FIG. 30 is a diagram illustrating a nineteenth user interface.

FIG. 31 is a diagram illustrating a twentieth user interface.

FIG. 32 is a diagram illustrating a twenty-first user interface.

FIG. 33 is a diagram illustrating a twenty-second user interface.

FIG. 34 is a diagram illustrating a twenty-third user interface.

FIG. 35 is a diagram illustrating the twenty-third user interface.

FIG. 36 is a diagram illustrating a twenty-fourth user interface.

FIG. 37 is a diagram illustrating a twenty-fifth user interface.

FIG. 38 is a diagram illustrating a twenty-sixth user interface.

FIG. 39 is a diagram illustrating the fifth user interface.

FIG. 40 is a diagram illustrating a twenty-seventh user interface.

FIG. 41 is a diagram illustrating a twenty-eighth user interface.

FIG. 42 is a diagram illustrating a twenty-ninth user interface.

FIG. 43 is a diagram illustrating the fifth user interface.

FIG. 44 is a diagram illustrating a thirtieth user interface.

FIG. 45 is a diagram illustrating a thirty-first user interface.

FIG. 46 is a diagram illustrating a thirty-second user interface.

FIG. 47 is a diagram illustrating a thirty-third user interface.

FIG. 48 is a diagram illustrating a thirty-fourth user interface.

FIG. 49 is a diagram illustrating a thirty-fifth user interface.

FIG. 50 is a diagram illustrating a thirty-sixth user interface.

FIG. 51 is a diagram illustrating a thirty-seventh user interface.

FIG. 52 is a diagram illustrating a thirty-eighth user interface.

FIG. 53 is a diagram illustrating a thirty-ninth user interface.

FIG. 54 is a diagram illustrating a fortieth user interface.

FIG. 55 is a diagram illustrating a forty-first user interface.

FIG. 56 is a diagram illustrating a forty-second user interface.

FIG. 57 is a diagram illustrating a forty-third user interface.

FIG. 58 is a diagram illustrating the forty-third user interface.

FIG. 59 is a diagram illustrating a forty-fourth user interface.

FIG. 60 is a diagram illustrating a forty-fifth user interface.

FIG. 61 is a diagram illustrating a forty-sixth user interface.

FIG. 62 is a diagram illustrating a forty-seventh user interface.

FIG. 63 is a diagram illustrating a forty-eighth user interface.

FIG. 64 is a diagram illustrating a forty-ninth user interface.

FIG. 65 is a diagram illustrating the forty-ninth user interface.

FIG. 66 is a diagram illustrating a fiftieth user interface.

FIG. 67 is a diagram illustrating a fifty-first user interface.

FIG. 68 is a diagram illustrating a fifty-second user interface.

FIG. 69 is a diagram illustrating a fifty-third user interface.

FIG. 70 is a diagram illustrating a fifty-fourth user interface.

### DESCRIPTION OF EMBODIMENTS

Hereinafter, an embodiment of the present invention will be described with reference to the drawings.

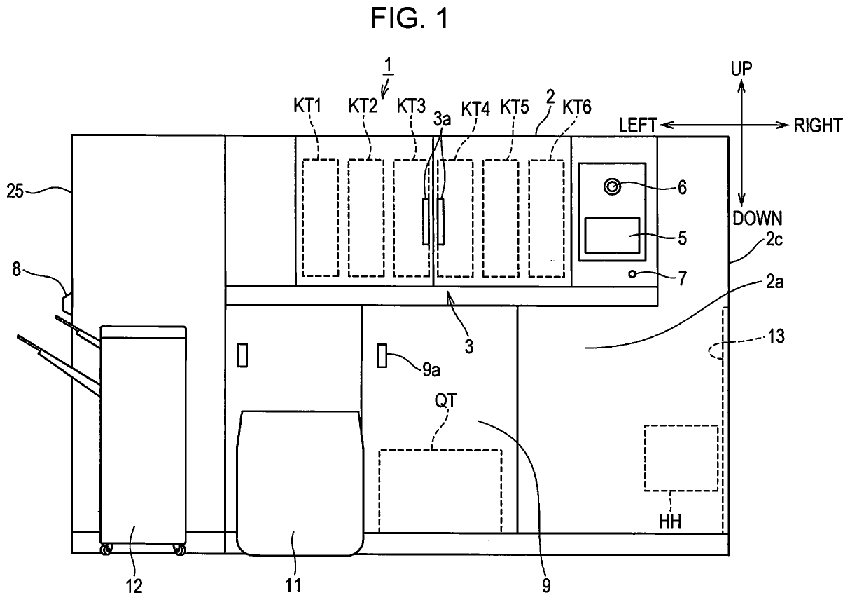

FIG. 1 is a front view of a sheet manufacturing apparatus 1 according to the present embodiment. In the description using FIG. 1, each of upward, downward, leftward, and rightward directions corresponds to a direction illustrated by an arrow in the drawing.

The sheet manufacturing apparatus 1 is an apparatus that is supplied with a raw material including fibers and manufactures a sheet of a predetermined color in a predetermined shape by processing the supplied raw material. In the present embodiment, the raw material supplied to the sheet manufacturing apparatus 1 is old paper of a paper shape. However, the raw material supplied to the sheet manufacturing apparatus 1 is not limited to old paper. The raw material supplied to the sheet manufacturing apparatus 1 may be any raw material including fibers and is exemplified by, for example, pulp, a pulp sheet, fabric including non-woven fabric, or cloth.

As illustrated in FIG. 1, the sheet manufacturing apparatus 1 includes a casing 2 of an approximately rectangular parallelepiped. An opening/closing door 3 that opens and closes an opening disposed in the upper portion of a front surface 2a is disposed in the upper center portion of the front surface 2a of the casing 2. A handle 3a is disposed in the opening/closing door 3. A user can set the opening/closing door 3 to be in an open state or a closed state using the handle 3a. In a case where the opening/closing door 3 is set to be in the open state, a resin cartridge accommodating unit is exposed. The resin cartridge accommodating unit is an accommodating unit that is disposed at a position corresponding to the opening/closing door 3 inside the casing 2 and accommodates a resin cartridge KT1 retaining resin of a first non-added color (P), a resin cartridge KT2 retaining resin of a second non-added color (S), a resin cartridge KT3 retaining resin of white (W), a resin cartridge KT4 retaining resin of yellow (Y), a resin cartridge KT5 retaining resin of magenta (M), and a resin cartridge KT6 retaining resin of cyan (C). Hereinafter, in a case where the resin cartridges KT1 to KT6 are not distinguished from each other, the resin cartridges KT1 to KT6 will be referred to as a “resin cartridge KT”. The first non-added color and the second non-added color mean the color of resin to which color is not added. The resin of the first non-added color and the resin of the second non-added color are different ingredients. Depending on the specifications of recycled paper to be manufactured, only one resin is used, or both are used by mixing at a predetermined ratio. Both may be the same ingredient. The resin cartridge KT will be described below. The opening/closing door 3 is made of a transparent material. The user can visually recognize the state of the resin cartridge KT accommodated in the resin cartridge accommodating unit without setting the opening/closing door 3 to be in the open state. In addition, the user can replace the resin cartridge KT of a predetermined color after exposing the resin cartridge accommodating unit by setting the opening/closing door 3 to be in the open state.

As illustrated in FIG. 1, a touch panel 5 is disposed on the right of the opening/closing door 3 in the front surface 2a of the casing 2. The touch panel 5 is disposed at a position having a height such that in a case where the sheet manufacturing apparatus 1 is disposed in an office, a factory, or other spaces, an adult user who is assumed to operate the apparatus can visually recognize the touch panel 5 easily without changing the attitude and can easily perform a touch operation. For example, the touch panel 5 is disposed at a position where the height of the center portion of the touch panel 5 is approximately 1.4 meters. As will be described below, the touch panel 5 displays a user interface in which various information related to the sheet manufacturing apparatus 1 is displayed.

As illustrated in FIG. 1, an emergency stoppage button 6 is disposed above the touch panel 5 in the front surface 2a of the casing 2. The emergency stoppage button 6 is a button for providing an instruction to urgently stop a process in a case where the sheet manufacturing apparatus 1 is executing a process of manufacturing a sheet. As will be described below, in a case where the emergency stoppage button 6 is switched ON by the user, corresponding information is displayed in the user interface, and then, the process related to manufacturing of the sheet by the sheet manufacturing apparatus 1 is stopped. The user can take an appropriate measure by referring to the user interface. While the emergency stoppage button 6 is a switch of a type that switches between ON and OFF each time the switch is pressed, the emergency stoppage button 6 may be a so-called see-saw type or lever type switch.

As illustrated in FIG. 1, a press type power supply switch 7 is disposed below the touch panel in the front surface 2a of the casing 2. In addition, a rotation type breaker switch 8 is disposed in the center portion in the up-down direction of a left surface 2b of the casing 2. In a state where the sheet manufacturing apparatus 1 is not booted, in order to boot the sheet manufacturing apparatus 1 and set the sheet manufacturing apparatus 1 to be in a state where the process of manufacturing the sheet can be initiated, the user needs to switch the power supply switch 7 ON after switching the breaker switch 8 ON. As will be described below, the user interface in which corresponding information for the operation of the breaker switch 8 and the operation of the power supply switch 7 is displayed is displayed on the touch panel 5. The user can take an appropriate measure by referring to the user interface.

As illustrated in FIG. 1, a front cover 9 is disposed below the opening/closing door 3 in the front surface 2a of the casing 2. A handle 9a is disposed in the front cover 9. The user can set the front cover 9 to be in the open state or the closed state using the handle 9a. In a case where the front cover 9 is set to be in the open state, an in-apparatus tank accommodating unit that is disposed inside the casing 2 is exposed. The in-apparatus tank accommodating unit is an accommodating unit that is disposed at a position corresponding to the opening/closing door 3 inside the casing 2 and accommodates at least an in-apparatus tank QT (described below). The front cover 9 can be set to be in the open state only in the case of a state where a lock set by a lock mechanism, not illustrated, is released.

As will be described below, the in-apparatus tank QT accommodated in the in-apparatus tank accommodating unit needs to be supplied with water from the outside and discharge water to the outside at a predetermined timing. In the case of supplying water to the in-apparatus tank QT and discharging water from the in-apparatus tank QT, the user interface in which corresponding information is displayed is displayed on the touch panel 5. The user can take an appropriate measure by referring to the user interface.

As illustrated in FIG. 1, a paper feeding cassette 11 is disposed in the lower portion of the front surface 2a of the casing 2 in a state where the paper feeding cassette 11 protrudes from the front surface 2a. The paper feeding cassette 11 is a device that accommodates old paper as the raw material. In the case of manufacturing the sheet based on old paper, the old paper accommodated in the paper feeding cassette 11 is supplied into the casing 2 by predetermined means. While illustration is not provided, a paper feeding tray that can accommodate old paper can be optionally mounted on the paper feeding cassette 11.

As illustrated in FIG. 1, the casing 2 that is recessed backward forms a space in the left end portion of the front surface 2a of the casing 2. A paper discharge tray 12 is disposed in the space. The paper discharge tray 12 is a device in which the sheet manufactured by the sheet manufacturing apparatus 1 is discharged and retained in order. A paper discharge stacker can be optionally mounted on the paper discharge tray 12.

As illustrated in FIG. 1, a waste dust box cover 13 is disposed at a predetermined position in a right surface 2c of the casing 2. In a case where the waste dust box cover 13 is set to be in the open state, a waste dust bag accommodating unit that is disposed inside the casing 2 is exposed. The waste dust bag accommodating unit is an accommodating unit that is disposed at a position corresponding to the waste dust box cover 13 of the casing 2 and accommodates at least a waste dust bag HH (described below). The waste dust box cover 13 can be set to be in the open state only in the case of a state where a lock set by a lock mechanism, not illustrated, is released.

As will be described below, the waste dust bag HH retains waste dust that is generated in a predetermined step of manufacturing the sheet. In a case where the amount of waste dust retained in the waste dust bag HH is larger than a predetermined amount, the user needs to replace the old waste dust bag HH with a new waste dust bag HH. In the case of replacing the waste dust bag HH, the user interface in which corresponding information is displayed is displayed on the touch panel 5. The user can take an appropriate measure by referring to the user interface.

Next, basic steps when the sheet manufacturing apparatus 1 manufactures the sheet will be described.

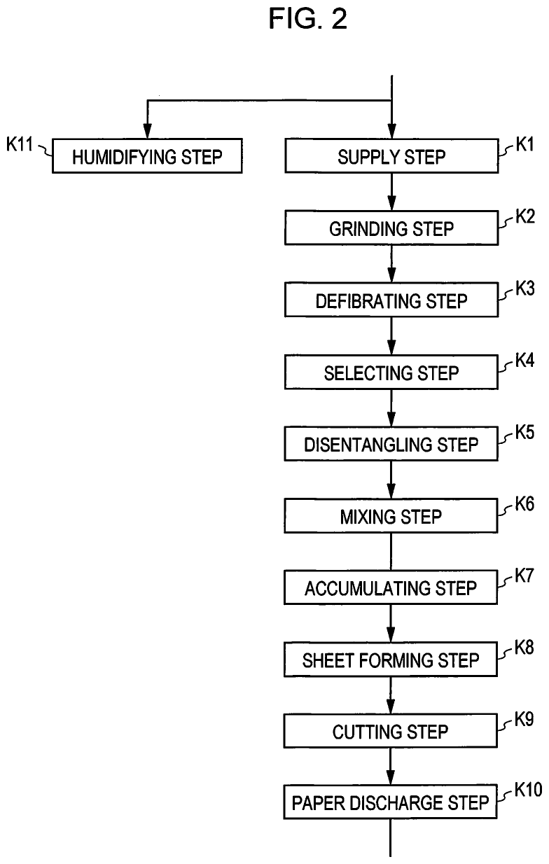

FIG. 2 is a diagram illustrating a flow of steps executed in the case of manufacturing the sheet.

As illustrated in FIG. 2, first, a supply step K1 is executed. In the supply step K1, old paper is supplied to the casing 2 from the paper feeding cassette 11 or the like.

A grinding step K2 is executed after the supply step K1. In the grinding step K2, the old paper as the raw material is cut in the air and is sheared into paper pieces, each of which is a square having a size of 1 to a few centimeters or smaller on each edge.

A defibrating step K3 is executed after the grinding step K2. In the defibrating step K3, defibrated matter is generated by performing defibration by disentangling the raw material sheared in the grinding step K2 into fiber shapes.

A selecting step K4 is executed after the defibrating step K3. In the selecting step K4, lengthy fibers (long fibers) and non-defibrated pieces that are not sufficiently defibrated are selected in the air and removed from the defibrated matter. The removed fibers and non-defibrated pieces are discharged to the waste dust bag HH and retained as waste dust.

A disentangling step K5 is executed after the selecting step K4. In the disentangling step K5, a state where the defibrated matter is easily mixed with resin in a subsequent mixing step K6 is set by disentangling the defibrated matter.

The mixing step K6 is executed after the disentangling step K5. In the mixing step K6, mixed matter is generated by mixing the defibrated matter with resin.

In the mixing step K6, a predetermined amount of resin is supplied from one or a plurality of resin cartridges KT of a predetermined color and is mixed with a predetermined amount of defibrated matter. In the mixing step K6, the color of the manufactured sheet is adjusted depending on the color of the resin cartridge KT supplying resin and the amount of supply of each resin cartridge KT. As will be described below, the user can easily specify the color of supplied resin and the ratio of the amount of supply of resin of each resin cartridge KT that supplies resin, using the user interface displayed on the touch panel 5.

An accumulating step K7 is executed after the mixing step K6. In the accumulating step K7, the mixed matter is dropped in a dispersed manner in the air and is accumulated and transported.

A sheet forming step K8 is executed after the accumulating step K7. In the sheet forming step K8, a precut sheet is generated by pressing and heating the mixed matter accumulated and transported in the accumulating step K7.

A cutting step K9 is executed after the sheet forming step K8. In the cutting step K9, a sheet of a predetermined size is manufactured by cutting the generated precut sheet.

A paper discharge step K10 is executed after the cutting step K9. In the paper discharge step K10, the manufactured sheet is discharged to the paper discharge tray 12 or the like.

In addition, a humidifying step K11 is executed in parallel with above each step. Each unit is appropriately humidified by a humidifier to which water is supplied by the in-apparatus tank QT.

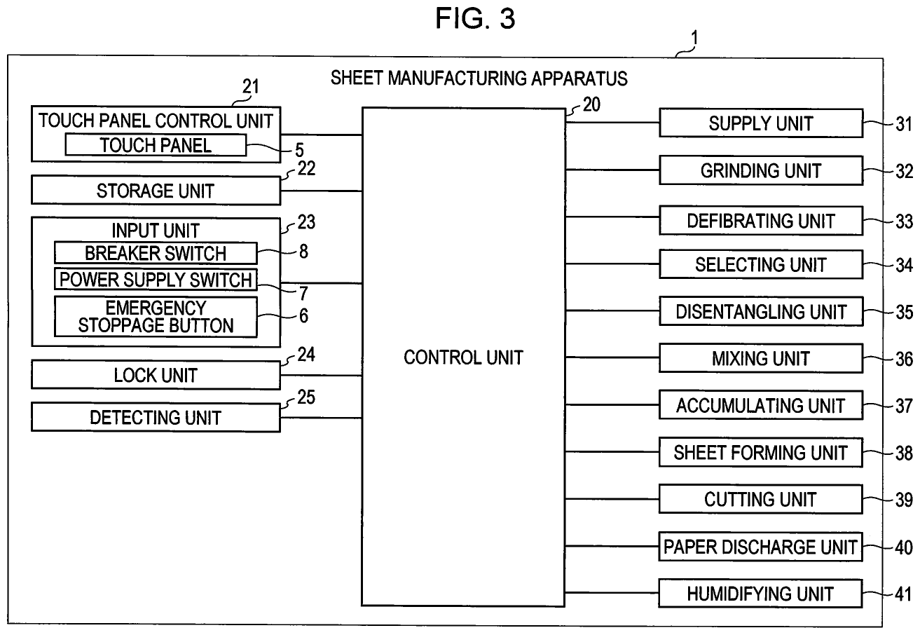

FIG. 3 is a block diagram illustrating a functional configuration of the sheet manufacturing apparatus 1.

As illustrated in FIG. 3, the sheet manufacturing apparatus 1 includes a control unit 20, a touch panel control unit 21, a storage unit 22, an input unit 23, a lock unit 24, a detecting unit 25, a supply unit 31, a grinding unit 32, a defibrating unit 33, a selecting unit 34, a disentangling unit 35, a mixing unit 36, an accumulating unit 37, a sheet forming unit 38, a cutting unit 39, a paper discharge unit 40, and a humidifying unit 41.

The control unit 20 includes a CPU, a ROM, a RAM, an ASIC, a signal processing circuit, and the like and controls each unit of the sheet manufacturing apparatus 1. The control unit 20 executes a process by hardware and software such that the CPU executes the process by reading a program stored in the ROM into the RAM, or the process is executed by a function installed in the ASIC, or the process is executed by performing signal processing by the signal processing circuit.

The touch panel control unit 21 includes the touch panel 5 and controls the touch panel 5 under control of the control unit 20. The touch panel control unit 21 displays various screens including the user interface, described below, on the touch panel 5 under control of the control unit 20. The touch panel control unit 21 detects a touch operation performed on the touch panel 5 and outputs a signal indicating the position of the touch operation to the control unit 20. The control unit 20 executes a process corresponding to the touch operation based on the input from the touch panel control unit 21.

The storage unit 22 includes a non-volatile memory and stores various data.

The input unit 23 detects an operation performed on a switch (including the breaker switch 8, the power supply switch 7, and the emergency stoppage button 6) disposed in the sheet manufacturing apparatus 1 and provides an output to the control unit 20. The control unit 20 executes a process corresponding to the operation performed on the switch based on the input from the input unit 23.

The lock unit 24 includes a lock mechanism that locks a predetermined cover including the front cover 9 or releases the lock, and controls the lock mechanism under control of the control unit 20.

The detecting unit 25 detects a transition of the sheet manufacturing apparatus 1 to a predetermined state, the occurrence of an error, insufficiency of the remaining amount of consumables, and the like and provides a notification to the control unit 20.

The detecting unit 25 detects at least the following matter.

Based on a detection value input from a predetermined sensor, the detecting unit 25 detects a state where the amount of water retained in the in-apparatus tank QT is smaller than a predetermined amount, and there is a possibility that the remaining amount is insufficient. In addition, based on a detection value input from a predetermined sensor, the detecting unit 25 detects the ratio (hereinafter, referred to as an “old paper remaining amount ratio”) of the remaining amount of old paper to the maximum amount of old paper accommodable in the paper feeding cassette 11. In addition, based on a detection value input from a predetermined sensor, for the resin cartridge KT of each color, the detecting unit 25 detects a state where the remaining amount of resin retained in the resin cartridge KT is smaller than a predetermined amount, and there is a possibility that the remaining amount is insufficient. In addition, the detecting unit 25 detects a state where the amount of waste dust retained in the waste dust bag HH is larger than a predetermined amount, and the waste dust bag HH needs to be replaced.

The supply unit 31 is a functional unit that executes the supply step K1. The supply unit 31 includes the paper feeding cassette 11, a transport mechanism that transports the old paper accommodated in the paper feeding cassette 11, and other necessary elements for executing the supply step Kl. The supply unit 31 executes the supply step K1 under control of the control unit 20.

The grinding unit 32 is a functional unit that executes the grinding step K2. The grinding unit 32 includes a cutting mechanism that cuts the old paper in the air, and other necessary elements for executing the grinding step K2. The grinding unit 32 executes the grinding step K2 under control of the control unit 20.

The defibrating unit 33 is a functional unit that executes the defibrating step K3. The defibrating unit 33 includes a defibrating mechanism that disentangles the raw material sheared in the grinding step K2 into fiber shapes, and other necessary elements for executing the defibrating step K3. The defibrating unit 33 executes the defibrating step K3 under control of the control unit 20.

The selecting unit 34 is a functional unit that executes the selecting step K4. The selecting unit 34 includes a selecting mechanism that selects and removes impurities from the defibrated matter and discharges the impurities to the waste dust bag HH, and other necessary elements for executing the selecting step K4. The selecting unit 34 executes the selecting step K4 under control of the control unit 20.

The disentangling unit 35 is a functional unit that executes the disentangling step K5. The disentangling unit 35 includes a disentangling mechanism that disentangles the defibrated matter, and other necessary elements for executing the disentangling step K5. The disentangling unit 35 executes the disentangling step K5 under control of the control unit 20.

The mixing unit 36 is a functional unit that executes the mixing step K6. The mixing unit 36 includes necessary elements for executing the mixing step K6, such as the resin cartridge KT, a mechanism that supplies predetermined resin from a predetermined resin cartridge KT, and a mechanism that mixes the defibrated matter with resin. The mixing unit 36 executes the mixing step K6 under control of the control unit 20.

The accumulating unit 37 is a functional unit that executes the accumulating step K7. The accumulating unit 37 includes a mechanism that accumulates and transports the mixed matter, and other necessary elements for executing the accumulating step K7. The accumulating unit 37 executes the accumulating step K7 under control of the control unit 20.

The sheet forming unit 38 is a functional unit that executes the sheet forming step K8. The sheet forming unit 38 includes a mechanism that presses and heats the accumulated and transported mixing unit, and other necessary elements for executing the sheet forming step K8. The sheet forming unit 38 executes the sheet forming step K8 under control of the control unit 20.

The cutting unit 39 is a functional unit that executes the cutting step K9. The cutting unit 39 includes a cutting mechanism that cuts the precut sheet, and other necessary elements for executing the cutting step K9. The cutting unit 39 executes the cutting step K9 under control of the control unit 20.

The paper discharge unit 40 is a functional unit that executes the paper discharge step K10. The paper discharge unit 40 includes the paper discharge tray 12, a mechanism that discharges the sheet to the paper discharge tray 12, and other necessary elements for executing the paper discharge step K10. The paper discharge unit 40 executes the paper discharge step K10 under control of the control unit 20.

The humidifying unit 41 is a functional unit that executes the humidifying step K11. The humidifying unit 41 includes the in-apparatus tank, the humidifier that is supplied with water from the in-apparatus tank and performs humidification, and other necessary elements for executing the humidifying step K11. The humidifying unit 41 executes the humidifying step K11 under control of the control unit 20.

In the above manner, the sheet manufacturing apparatus 1 manufactures the sheet by executing a plurality of steps in order. In addition, the user needs to perform necessary work (work related to supply of water to the in-apparatus tank, replacement of the waste dust bag HH, resolution of error, and the like) in order for the sheet manufacturing apparatus 1 to normally execute each step.

Accordingly, the control unit 20 of the sheet manufacturing apparatus 1 according to the present embodiment appropriately displays the user interface on the touch panel 5 based on the features of the sheet manufacturing apparatus 1 and improves user's convenience of use.

Hereinafter, the user interface displayed on the touch panel 5 of the sheet manufacturing apparatus 1 and the process executed by the control unit 20 in the case of displaying the user interface will be described along with the work to be performed by the user.

In the following description, a touch operation button refers to an operation button that is displayed in the user interface and can be subjected to a touch operation.

In addition, time is represented in 24-hour format such as “00:00” and “13:05”.

In addition, a period from switching ON of the breaker switch 8 and the power supply switch 7 of the sheet manufacturing apparatus 1 until shutdown of the sheet manufacturing apparatus 1 is referred to as a “power-up period”.

In addition, in the following description, a subject that displays the user interface, displays an image, information, and other objects in the user interface, and transitions one user interface to another user interface is the control unit 20 even in a case where a description is not particularly provided.

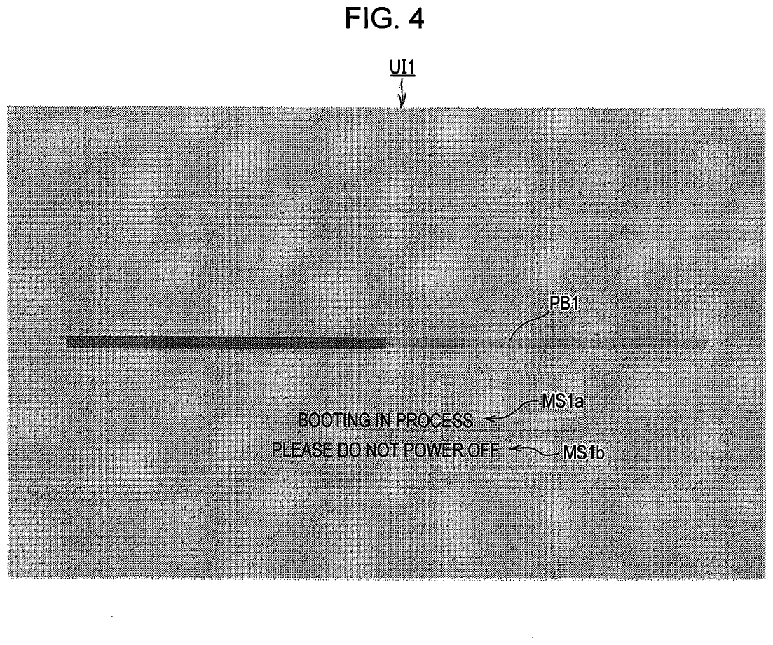

FIG. 4 is a diagram illustrating a first user interface UI1 that is displayed on the touch panel 5 after the breaker switch 8 is ON.

In a case where the breaker switch 8 is switched ON, an operating system (OS) and other programs (firmware, a predetermined application, and the like) are booted by the function of a basic input/output system (BIOS) or a bootloader. The first user interface UI1 is a user interface that represents that the programs are being booted, and represents the progress of booting of the programs.

As illustrated in FIG. 4, the first user interface UI1 includes a progress bar PB1 that represents the progress of booting of the programs. The progress bar PB1 represents the progress of booting of the programs by extending the bar from left toward right in a rectangular frame extending in the left-right direction depending on the progress.

As illustrated in FIG. 4, in the first user interface UI1, a message MS1a (“booting in process”) that indicates that the programs are booting, and a message MS1b (“please do not power off”) that alerts the user not to power off are displayed below the progress bar PB1. By referring to the progress bar PB1 and the messages MS1a and MS1b, the user can easily and appropriately recognize that the programs are being booted, and recognize the progress of booting of the programs and an alert in the current stage.

In a case where switching ON of the breaker switch 8 is detected, the control unit 20 displays the first user interface UI1 on the touch panel 5 by controlling the touch panel control unit 21. In a case where the completion of the booting of the programs is detected, the control unit 20 displays a second user interface UI2 on the touch panel 5 instead of the first user interface UI1 by controlling the touch panel control unit 21.

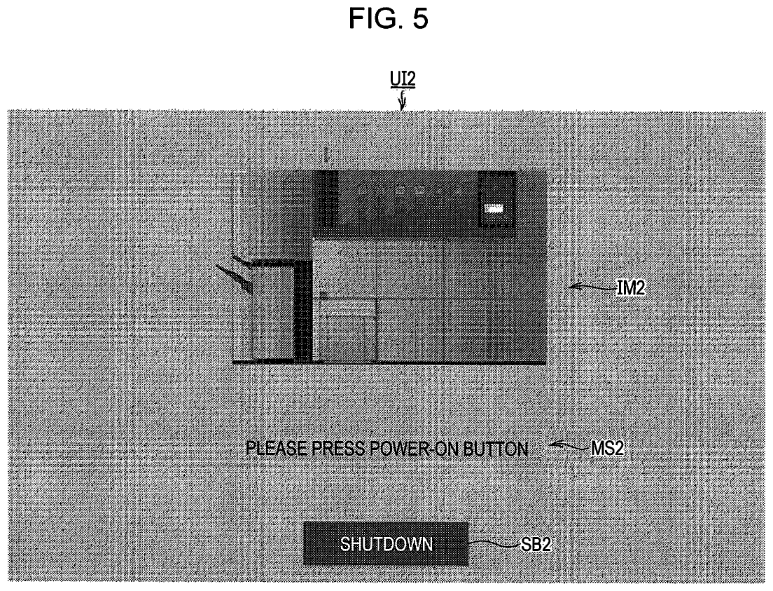

FIG. 5 is a diagram illustrating the second user interface UI2.

In order to operate the sheet manufacturing apparatus 1, the user needs to boot the programs by switching the breaker switch 8 ON and then, switch the power supply switch 7 ON. The second user interface UI2 is a user interface for prompting switching ON of the power supply switch 7.

As illustrated in FIG. 5, in the second user interface UI2, an image IM2 that represents the front view of the sheet manufacturing apparatus 1 is displayed. As illustrated in FIG. 5, in the second user interface UI2, a message MS2 (“please press the power ON button”) that prompts switching ON of the power supply switch 7 is displayed below the image IM2. Information and an image that explicitly show the power supply switch 7 may be displayed in association with the image IM2.

A shutdown button SB2 is displayed below the message MS2. The shutdown button SB2 is a touch operation button for providing an instruction to perform a shutdown.

By referring to the message MS2, the user can easily and appropriately recognize that the power supply switch 7 is to be switched ON. In addition, in a case where the user decides not to operate the sheet manufacturing apparatus 1 due to a predetermined matter, the user can perform a shutdown by an easy work of performing a touch operation on the shutdown button SB2.

In a case where switching ON of the power supply switch 7 is detected, the control unit 20 executes an initialization process (described below). In addition, in a case where switching ON of the power supply switch 7 is detected, the control unit 20 displays a third user interface UI3 on the touch panel 5 instead of the second user interface UI2 by controlling the touch panel control unit 21.

In a case where a touch operation performed on the shutdown button SB2 is detected, the control unit 20 executes a necessary process for the shutdown by controlling each unit and shuts the sheet manufacturing apparatus 1 down.

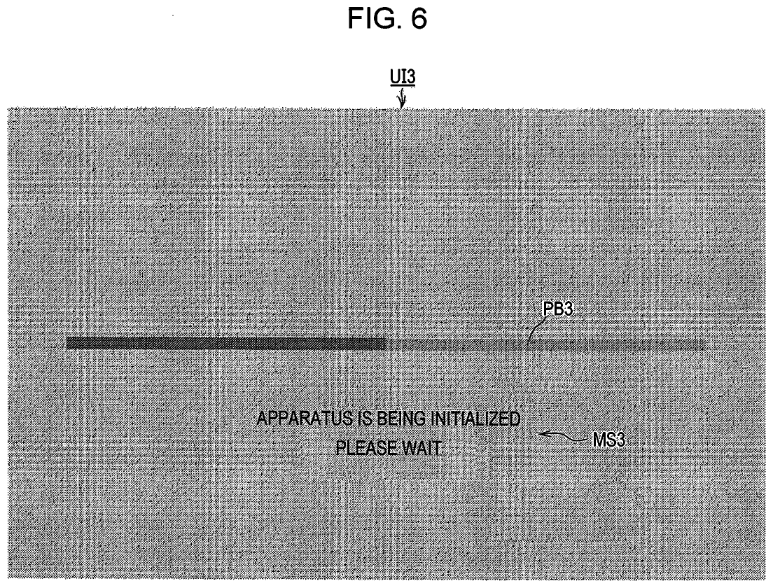

FIG. 6 is a diagram illustrating the third user interface UI3.

As described above, in a case where switching ON of the power supply switch 7 is detected, the control unit 20 executes the initialization process. The initialization process is a process of setting software and hardware to be in an initial state in order to set a state where the operation of the sheet manufacturing apparatus 1 can be initiated. The third user interface UI3 is a user interface that represents that the initialization process is being executed.

As illustrated in FIG. 6, the third user interface UI3 includes a progress bar PB3 that represents the progress of the initialization process.

As illustrated in FIG. 6, in the third user interface UI3, a message MS3 (“the apparatus is being initialized/please wait”) (“/” represents a newline; applies hereafter) that indicates that the initialization process is being executed is displayed below the progress bar PB3. By referring to the progress bar PB3 and the message MS3, the user can easily and appropriately recognize that the initialization process is being executed, and the user is to wait.

In a case where the completion of the initialization process is detected, the control unit 20 displays a fourth user interface UI4 on the touch panel 5 instead of the third user interface UI3 by controlling the touch panel control unit 21.

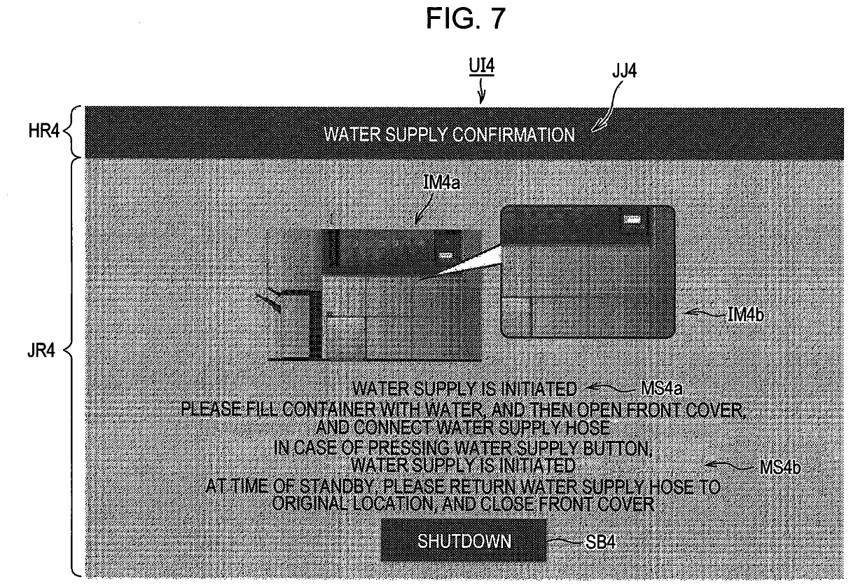

FIG. 7 is a diagram illustrating the fourth user interface UI4.

After the initialization process is completed, the user needs to supply water to the in-apparatus tank QT of the sheet manufacturing apparatus 1. The fourth user interface UI4 is a user interface that represents the necessity to supply water to the in-apparatus tank QT and the procedure of water supply.

As illustrated in FIG. 7, the fourth user interface UI4 includes, as areas, a band-shaped area (hereinafter, referred to as a “state display area”) that extends in the left-right direction in the upper end portion, and an area “hereinafter, referred to as an “information display area”” that is disposed below the state display area.

The state display area is an area'in which information that indicates the current state of the sheet manufacturing apparatus 1, the process currently being performed by the sheet manufacturing apparatus 1, the work to be currently performed by the user, and the like is displayed by a simple message. Hereinafter, in the information displayed in the state display area, information that indicates the current state of the sheet manufacturing apparatus 1, the process currently being performed by the sheet manufacturing apparatus 1, the work to be currently performed by the user, and the like will be referred to as “state information”.

The information display area is an area in which information corresponding to the user interface is displayed.

The fourth user interface UI4 includes a state display area HR4 (state display area) and an information display area JR4 (information display area).

At the time when the fourth user interface UI4 is displayed, the user needs to supply water. Accordingly, state information JJ4 (“water supply confirmation”) that indicates that the user needs to supply water is displayed in the state display area HR4 of the fourth user interface UI4.

In the present embodiment, for a plurality of user interfaces (for example, a fifth user interface UI5 described below) except a specific user interface, the state display area is disposed at the same position as the position of the state display area HR4 in the fourth user interface UI4, and the state information is displayed in the state display area. Accordingly, the following effect is achieved. That is, in a case where the user wants to recognize the current state and the like of the sheet manufacturing apparatus 1, the user can easily and appropriately recognize the current state and the like of the sheet manufacturing apparatus 1 by referring to the state information in the state display area displayed in the user interface without performing an operation or the like on the touch panel 5. Particularly, since the state display area is displayed at the same position in each user interface, the user can recognize the current state and the like of the sheet manufacturing apparatus 1 by referring to the state display area in the same manner without changing the location to be visually recognized depending on the user interface.

As illustrated in FIG. 7, an image IM4a that represents the front view of the sheet manufacturing apparatus 1 is displayed in the information display area JR4 of the fourth user interface UI4. In addition, in the fourth user interface UI4, an image IM4b of the enlarged front cover 9 is displayed in correlation with the position of the front cover 9 in the image IM4a.

As illustrated in FIG. 7, in the fourth user interface UI4, a message MS4a (“water supply is initiated”) that indicates the necessity of water supply is displayed below the image IM4a. A message MS4b (“fill the container with water, and then . . . /in the case of pressing the water supply button . . . /at the time of standby . . . ”) that indicates the procedure of water supply is displayed below the message MS4a.

A shutdown button SB4 is displayed below the message MS4b.

By referring to the message MS4a, the user can easily recognize that water supply is to be performed. In addition, by referring to the message MS4b, the user can easily recognize the procedure of water supply. Particularly, the procedure of water supply includes a work of opening the front cover 9 and a work of closing the front cover 9. However, since the position of the front cover 9 in the sheet manufacturing apparatus 1 is explicitly shown by the image IM4a and the image IM4b, the user can appropriately recognize a necessary work for water supply by referring to the image IM4a and the image IM4b along with the message MS4b. The lock and the release of the lock of the front cover 9 are appropriately executed at an appropriate timing by the control unit 20.

In addition, in a case where the user decides not to operate the sheet manufacturing apparatus 1 due to a predetermined matter, the user can perform a shutdown by an easy work of performing a touch operation on the shutdown button SB4.

In a case where the completion of water supply is detected, the control unit 20 displays a fifth user interface UI5 on the touch panel 5 instead of the fourth user interface UI4 by controlling the touch panel control unit 21.

In a case where a touch operation performed on the shutdown button SB4 is detected, the control unit 20 executes a necessary process for the shutdown by controlling each unit and shuts the sheet manufacturing apparatus 1 down.

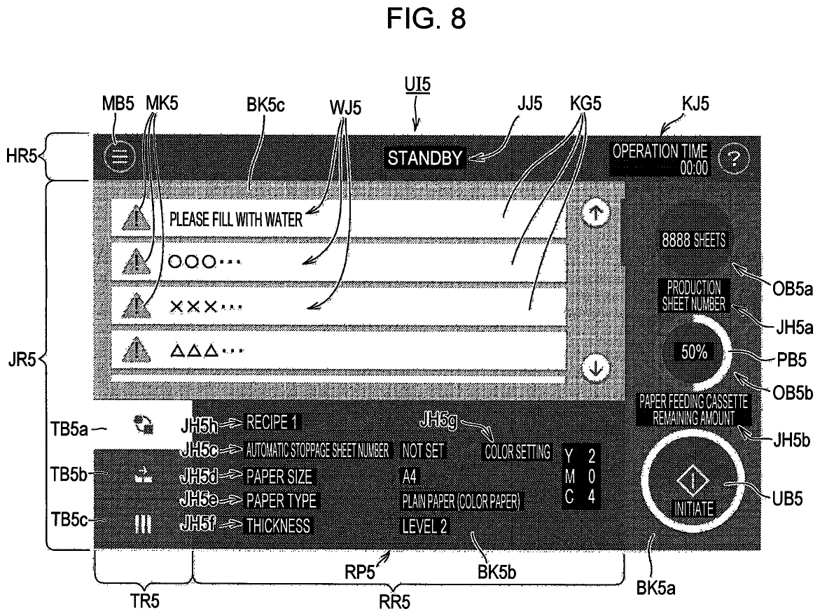

FIG. 8 is a diagram illustrating the fifth user interface UI5.

Particularly, FIG. 8 illustrates the fifth user interface UI5 that is displayed instead of the fourth user interface UI4 depending on the completion of water supply. As will become apparent below, the fifth user interface UI5 is appropriately displayed on the touch panel 5 as a main user interface during the power-up period.

As illustrated in FIG. 8, the fifth user interface UI5 includes a state display area HR5 and an information display area JR5.

In the state display area HR5 illustrated in FIG. 8, state information JJ5 (“standby”) (state information related to the state of the apparatus main body) (information that indicates whether or not the process of manufacturing the sheet is being executed) that indicates that the sheet manufacturing apparatus 1 is not executing the process of manufacturing the sheet is displayed. By referring to the state information JJ5 displayed in the state display area HR5, the user can easily recognize the current state of the sheet manufacturing apparatus 1.

Furthermore, operation time information KJ5 (operation time information) is displayed in the state display area HR5 of the fifth user interface UI5. The operation time information is information that indicates the cumulative amount of time in which the sheet manufacturing apparatus 1 executes the process of manufacturing the sheet after the breaker switch 8 and the power supply switch 7 have been switched ON most recently. By referring to the operation time information KJ5 of the fifth user interface UI5, the user can easily and appropriately recognize the cumulative amount of time.

The content of the operation time information is not limited to the content of the operation time information according to the present embodiment. For example, the operation time information may be information that indicates the length of time that has elapsed after the breaker switch 8 and the power supply switch 7 have been switched ON most recently. In addition, for example, the operation time information may be information that indicates the cumulative amount of time in which the sheet manufacturing apparatus 1 executes the process of manufacturing the sheet in a period from a specific time (for example, the most recent “00:00”) to the current time regardless of switching ON and OFF of the power supply switch 7. In addition, for example, the operation time information may be information that indicates the cumulative amount of time in which the sheet manufacturing apparatus 1 executes the process of manufacturing the sheet in the power-up period immediately before the power-up period to which the current time belongs. In addition, for example, the operation time information may be information that indicates the length of the power-up period immediately before the power-up period to which the current time belongs.

The operation time information is information indicating the state of the sheet manufacturing apparatus 1 and corresponds to the state information.

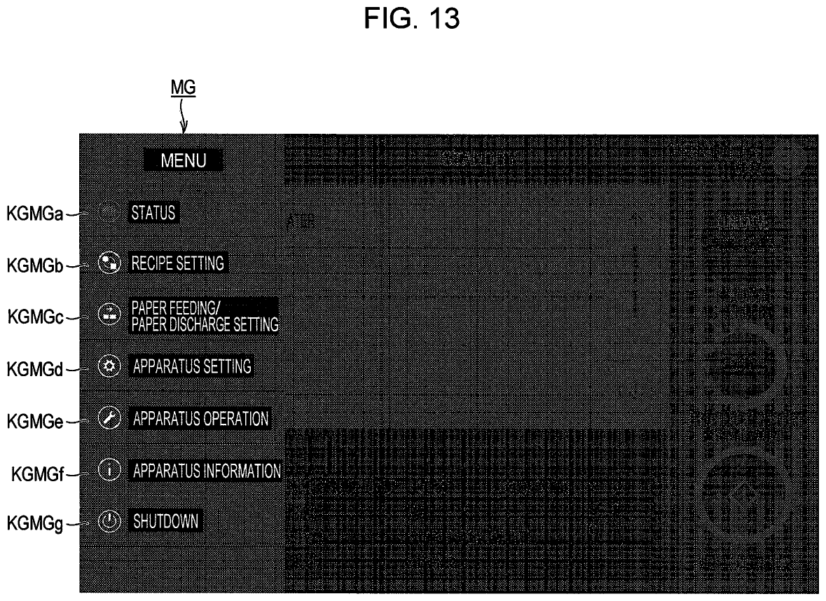

As illustrated in FIG. 8, a menu button MB5 is displayed in the state display area HR5. The menu button MB5 is a touch operation button. In a case where a touch operation performed on the menu button MB5 is detected, the control unit 20 displays a menu screen MG (FIG. 13). The menu screen MG will be described below.

As illustrated in FIG. 8, the information display area JR5 of the fifth user interface UI5 is configured with three blocks corresponding to the content of displayed information. Specifically, the information display area JR5 is configured with a first block BK5a that is positioned in the right end portion and extends in the up-down direction, a second block BK5b that is positioned in the lower portion of the area on the left of the first block BK5a, and a third block BK5c that is positioned above the second block BK5b in the area on the left of the first block BK5a.

The state display area HR5 is an area that is divided depending on the content of information, and is one block.

The first block BK5a is a block in which information including raw material information related to the raw material supplied to the sheet manufacturing apparatus 1 and manufacturing information related to the sheet manufactured by the sheet manufacturing apparatus 1 is displayed.

As illustrated in FIG. 8, a manufacturing information image OB5a that is an image of a circular shape is displayed in the upper portion of the first block BK5a. The manufacturing information image OB5a functions as a touch operation button and can switch information displayed in the image between first manufacturing information (described below) and second manufacturing information (described below) by a touch operation. The first manufacturing information and the second manufacturing information correspond to the “manufacturing information”.

In addition, information JH5a (“production sheet number”) that indicates that the manufacturing information is displayed in the manufacturing information image OB5a is displayed below the manufacturing information image OB5a in correlation with the manufacturing information image OB5a.

In the manufacturing information image OB5a, the following information is displayed as the first manufacturing information depending on the state of the sheet manufacturing apparatus 1. That is, in a case where the sheet manufacturing apparatus 1 does not initiate manufacturing of the sheet at all after the power supply switch 7 is switched ON, information (information related to the number of sheets manufactured in a predetermined period) that indicates the cumulative number of sheets manufactured by the sheet manufacturing apparatus 1 in the power-up period immediately before the power-up period to which the current time belongs is displayed as the first manufacturing information in the manufacturing information image OB5a. By referring to the first manufacturing information displayed in the manufacturing information image OB5a, the user can recognize the number of sheets manufactured in the power-up period immediately before the power-up period to which the current time belongs, and can use the first manufacturing information as an estimation of the number of sheets to be manufactured in the power-up period to which the current time belongs.

Meanwhile, after the sheet manufacturing apparatus 1 initiates manufacturing of the sheet after switching ON of the power supply switch 7, information (information related to the number of sheets manufactured after manufacturing of the sheet based on the supplied raw material is initiated) that indicates the cumulative number of sheets manufactured until the current time by the sheet manufacturing apparatus 1 in the power-up period to which the current time belongs is displayed as the first manufacturing information in the manufacturing information image OB5a. By referring to the first manufacturing information displayed in the manufacturing information image OB5a, the user can easily recognize the number of sheets manufactured until the current time and can use the first manufacturing information in the case of determining whether or not to stop manufacturing.

In addition, in the manufacturing information image OB5a, the following information is displayed as the second manufacturing information. That is, information (information related to the number of sheets manufactured in a predetermined period) that indicates the cumulative number of sheets manufactured by the sheet manufacturing apparatus 1 in a period from a specific time (for example, the most recent “00:00”) until the current time is displayed in the manufacturing information image OB5a. By referring to the second manufacturing information displayed in the manufacturing information image OB5a, the user can easily recognize the cumulative number of sheets manufactured by the sheet manufacturing apparatus 1 from a specific time until the current time. For example, in a case where the specific time is the “most recent “00:00””, the user can recognize the cumulative number of sheets manufactured by the sheet manufacturing apparatus 1 until the current time on a “day” to which the current time belongs.

As described above, the user can switch the information displayed in the manufacturing information image OB5a between the first manufacturing information and the second manufacturing information by an easy work of performing a touch operation on the manufacturing information image OB5a.

The manufacturing information may be configured to include other information. For example, the manufacturing information may include information that indicates the ratio of the number of currently manufactured sheets to an automatic stoppage sheet number (described below).

As illustrated in FIG. 8, in the first block BK5a, a raw material information image OB5b that is an image of a circular shape is displayed below the manufacturing information image OB5a. The raw material information image OB5b functions as a touch operation button and can switch information displayed in the image between first raw material information (described below) and second raw material information (described below) by a touch operation. The first raw material information and the second raw material information correspond to the “raw material information”.

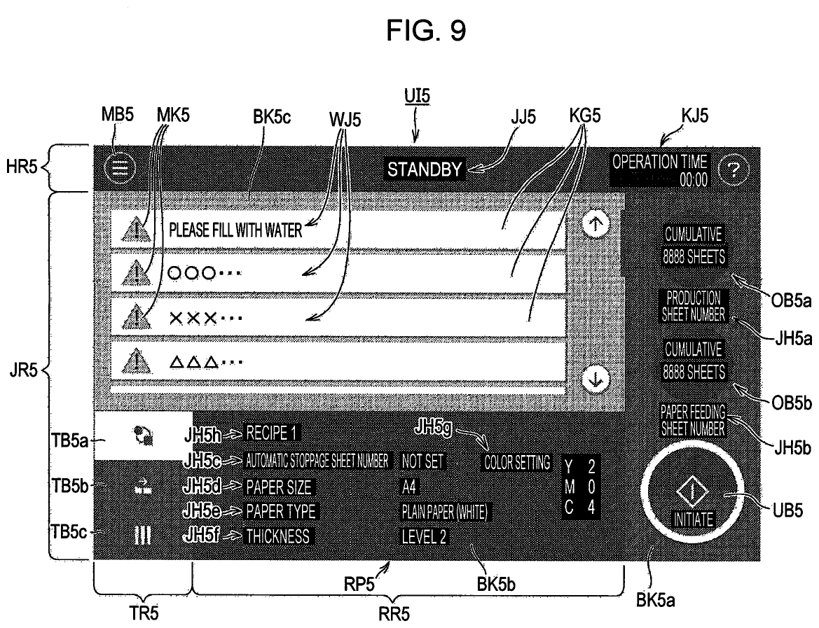

In addition, information JH5b that indicates that the raw material information is displayed in the raw material information image OB5b is displayed below the raw material information image OB5b in correlation with the raw material information image OB5b. Particularly, in a case where the first raw material information is displayed in the raw material information image OB5b, the information JH5b is information (the “remaining amount of the paper feeding cassette 11”; refer to FIG. 8) that indicates that the first raw material information is displayed in the raw material information image OB5b. Meanwhile, in a case where the second raw material information is displayed in the raw material information image OB5b, the information JH5b is information (“paper feeding sheet number”; refer to FIG. 9) that indicates that the second raw material information is displayed in the raw material information image OB5b.

FIG. 8 illustrates the fifth user interface UI5 in a state where the first raw material information is displayed in the raw material information image OB5b.

As illustrated in FIG. 8, in the raw material information image OB5b, the following information is displayed as the first raw material information. That is, in the raw material information image OB5b, information (information related to the remaining amount of the raw material) that represents the old paper remaining amount ratio (the ratio of the remaining amount of old paper to the maximum amount of old paper accommodable in the paper feeding cassette 11) as a percentage is displayed as the first raw material information. In addition, in the case of a state where the first raw material information is displayed in the raw material information image OB5b, a progress bar PB5 that represents the old paper remaining amount ratio is displayed in the raw material information image OB5b along the circumference of the raw material information image OB5b. By referring to the first raw material information displayed in the raw material information image OB5b and the progress bar PB5, the user can easily, appropriately, and intuitively recognize the old paper remaining amount ratio.

FIG. 9 illustrates the fifth user interface U15 in a state where the second raw material information is displayed in the raw material information image OB5b.

As illustrated in FIG. 9, in the raw material information image OB5b, the following information is displayed as the second raw material information. That is, information (information related to the amount of the raw material supplied and consumed in a predetermined period) that indicates the cumulative number of sheets of old paper supplied and consumed in the sheet manufacturing apparatus 1 in a period from a specific time (for example, the most recent “00:00”) until the current time is displayed in the raw material information image OB5b. By referring to the second raw material information displayed in the raw material information image OB5b, the user can easily and appropriately recognize the cumulative number of sheets of old paper supplied and consumed in the sheet manufacturing apparatus 1 from a specific time until the current time. For example, in a case where the specific time is the “most recent “00:00””, the user can recognize the cumulative number of sheets of old paper supplied and consumed in the sheet manufacturing apparatus 1 until the current time on a “day” to which the current time belongs.

The raw material information may be configured to include other information. For example, the raw material information may include information that indicates the cumulative number of sheets of old paper consumed by the sheet manufacturing apparatus 1 in the power-up period immediately before the power-up period to which the current time belongs, or may include information (information related to the amount of the raw material consumed after manufacturing of the sheet based on the supplied raw material is initiated) that indicates the cumulative number of sheets of old paper consumed by the sheet manufacturing apparatus 1 until the current time in the power-up period to which the current time belongs.

In the present embodiment, the manufacturing information (information displayed in the manufacturing information image OB5a) and the raw material information (information displayed in the raw material information image OB5b) are displayed in the same block (first block BK5a). Accordingly, the following effect is achieved. That is, the raw material information is information related to the old paper supplied to the sheet manufacturing apparatus 1. The manufacturing information is information related to the sheet manufactured by processing the old paper supplied to the sheet manufacturing apparatus 1. The content of the raw material information is closely correlated with the content of the manufacturing information. Thus, it is assumed that the user desires to refer to the raw material information and the manufacturing information at the same time and compare the contents of those information. Accordingly, by displaying the manufacturing information and the raw material information in the same block, the user can appropriately recognize that the manufacturing information and the raw material information are correlating information, and can refer to those information at the same time and appropriately compare the contents of those information.

As illustrated in FIG. 8, in the first block BK5a, an operation initiation button UB5 is displayed below the raw material information image OB5b. The operation initiation button UB5 is a touch operation button for providing an instruction to initiate the process of manufacturing the sheet. In a case where a touch operation performed on the operation initiation button UB5 is detected, the control unit 20 initiates manufacturing of the sheet using old paper as the raw material by controlling each unit.

The user interface displayed on the touch panel 5 and details of the process of the control unit 20 in a case where a touch operation is performed on the operation initiation button UB5 will be described below.

In the fifth user interface UI5, the third block BK5c is a block in which warning information WJ5 (warning information) related to warning is displayed as a list.

The warning information WJ5 is information that indicates a request for the user in order to normally execute the process of manufacturing the sheet, information that indicates an error occurring in the sheet manufacturing apparatus 1, or the like.

In the third block BK5c, an item image KG5 of a horizontally long rectangle is linearly displayed in the up-down direction for each warning information WJ5, and the warning information WJ5 is displayed in each item image KG5. In addition, a mark MK5 that alerts the user is displayed in the left portion of each item image KG5. Each item image KG5 is a touch operation button. In a case where a touch operation is performed on the item image KG5, detailed information related to the warning information WJ5 displayed in the item image KG5 is displayed.

By referring to the warning information WJ5 displayed as a list in the third block BK5c, the user can easily and appropriately recognize the warning and can perform a corresponding work based on the recognition.

In addition, in a case where there is information for which the user wants to refer to detailed information in the warning information WJ5 displayed as a list, the user performs a touch operation on the corresponding item image KG5. In a case where a touch operation performed on any item image KG5 is detected, the control unit 20 displays, as a pop-up, a sixth user interface UI6 in which detailed information related to the warning information WJ5 displayed in the item image KG5 subjected to the touch operation is displayed.

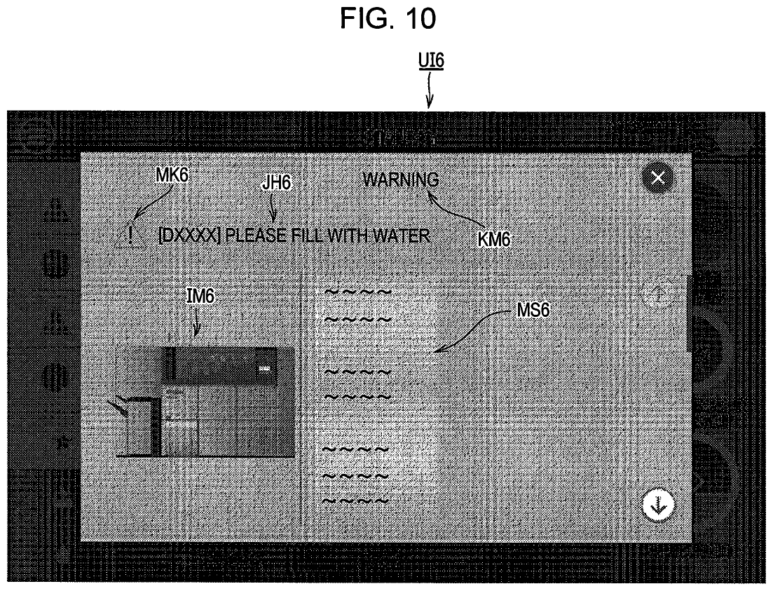

FIG. 10 is a diagram illustrating the sixth user interface UI6.

As illustrated in FIG. 10, warning type information KM6 (“warning”) that indicates the type of warning indicated by the warning information WJ5 selected by the user is displayed in the upper portion of the sixth user interface UI6. By referring to the warning type information KM6, the user can easily and appropriately recognize the type of warning.

In the sixth user interface UI6, information JIM that includes information uniquely identifying the warning and information representing the content of warning as a straightforward message is displayed below the warning type information KM6 in association with a mark MK6 that alerts the user. By referring to the information JH6, the user can easily and appropriately recognize the content of warning. In addition, by using the information that is included in the information JH6 and uniquely identifies the warning, the user can make an inquiry to a person who performs maintenance or the like on the sheet manufacturing apparatus 1.

As illustrated in FIG. 10, in the sixth user interface UI6, an image IM6 that represents the front view of the sheet manufacturing apparatus 1 is displayed below the information JH6, and a message MS6 that represents details of the warning information WJ5 selected by the user is displayed on the right of the image IM6. In a case where the warning is easily understood by explicitly showing a specific location in the sheet manufacturing apparatus 1, information, an image, and other objects that clearly show the specific location are displayed in association with the image IM6.

By referring to the image IM6 and the message MS6, the user can easily and appropriately recognize details of the warning corresponding to the selected warning information WJ5.

As illustrated in FIG. 8, in the fifth user interface UI5, the second block BK5b is a block in which information including processing information related to processing of the sheet is displayed.

As illustrated in FIG. 8, the second block BK5b includes, as areas, a tab display area TR5 (tab display area) formed in the left portion and a corresponding information display area RR5 (tab corresponding display area) formed in the right portion.

The tab display area TR5 is an area in which three tabs TB5a, TB5b, and TB5c from which one tab can be selected are displayed. The corresponding information display area RR5 is an area in which information corresponding to a tab selected in the tab display area TR5 is displayed.

FIG. 8 illustrates the fifth user interface UI5 in a state where the tab TB5a is selected.

The tab TB5a is a tab for providing an instruction to display recipe correlating information RP5 (recipe correlating information) (processing information) related to a selected recipe (described below) in the corresponding information display area RR5. Accordingly, in a case where the tab TB5a is selected, the recipe correlating information RP5 is displayed in the corresponding information display area RR5.

Hereinafter, the “recipe” will be described, and then, the recipe correlating information RP5 will be described.

The recipe is a setting in a case where the sheet manufacturing apparatus 1 manufactures the sheet, and includes a plurality of setting items and a setting value corresponding to each setting item. In the case of manufacturing the sheet, the sheet manufacturing apparatus 1 executes the process in accordance with the recipe. As will become apparent below, in the present embodiment, the user can register 10 recipes of a recipe 1 to a recipe 10 in advance as the recipe and can select one recipe to be used in manufacturing of the sheet from the 10 recipes.

In the present embodiment, the setting items of the recipe include an automatic stoppage sheet number setting item, a paper size setting item, a paper type setting item, a paper thickness setting item, and a color setting item.

The automatic stoppage sheet number setting item is a setting item with which the automatic stoppage sheet number is associated as a setting value. The automatic stoppage sheet number is the number of sheets to be consecutively manufactured after the sheet manufacturing apparatus 1 initiates manufacturing of the sheet. In a case where manufacturing of the sheet corresponding to the automatic stoppage sheet number is completed after manufacturing of the sheet is initiated, the control unit 20 automatically stops the process of manufacturing the sheet.

The paper size setting item is a setting item with which a paper size is associated as a setting value. The paper size is the size of the sheet manufactured by the sheet manufacturing apparatus 1. In the present embodiment, the paper size includes “A4” and “A3”. A configuration in which other sizes (for example, “B5”) are present as the paper size may be used.

The paper type setting item is a setting item with which a paper type is associated as a setting value. The paper type is the type of sheet manufactured by the sheet manufacturing apparatus 1. In the present embodiment, the paper type includes “plain paper (white paper)”, “plain paper (color paper)”, “thick paper (white paper)”, and “thick paper (color paper)”.

In the present embodiment, the “plain paper” for the sheet manufactured by the sheet manufacturing apparatus 1 refers to paper of a predetermined thickness such that the thickness of the sheet is smaller than the thickness of the thick paper described below. The plain paper has flexibility compared to the thick paper. In addition, the “thick paper” for the sheet manufactured by the sheet manufacturing apparatus 1 refers to paper such that the thickness of the sheet is greater than that of the plain paper. As will become apparent below, the user can adjust the thickness of the sheet manufactured by the sheet manufacturing apparatus 1.

In addition, the “white paper” for the sheet manufactured by the sheet manufacturing apparatus 1 refers to paper such that the color of the sheet is white or a white-based color. Hereinafter, white and the white-based color with respect to the color of the manufactured sheet will be simply referred to as “white”. As will become apparent below, the user can adjust the whiteness of the white paper manufactured by the sheet manufacturing apparatus 1.

In addition, the “color paper” for the sheet manufactured by the sheet manufacturing apparatus 1 refers to paper such that the sheet has a color other than white and is colored using resin of any color of cyan, magenta, or yellow. As will become apparent below, the user can adjust the color of the color paper manufactured by the sheet manufacturing apparatus 1.

Paper type: “plain paper (white paper)” is a type that corresponds to a combination of the plain paper and the white paper for the sheet manufactured by the sheet manufacturing apparatus 1.

Paper type: “plain paper (color paper)” is a type that corresponds to a combination of the plain paper and the color paper for the sheet manufactured by the sheet manufacturing apparatus 1.

Paper type: “thick paper (white paper)” is a type that corresponds to a combination of the thick paper and the white paper for the sheet manufactured by the sheet manufacturing apparatus 1.

Paper type: “thick paper (color paper)” is a type that corresponds to a combination of the thick paper and the color paper for the sheet manufactured by the sheet manufacturing apparatus 1.

The paper thickness setting item is a setting item with which a paper thickness is associated as a setting value. The paper thickness is the level of the thickness of the sheet manufactured by the sheet manufacturing apparatus 1. In the present embodiment, the paper thickness is any value of 10 levels of a level 1 to a level 10. For each level, the level 1 is the lowest, and the level 10 is the highest. Thickness is increased stepwise from the level 1 toward the level 10.

The color setting item is a setting item with which a color setting value is associated as a setting value.

In a case where the manufactured sheet is the “color paper”, the color setting value is a setting value that represents the amount of resin supplied with respect to a predetermined amount of the raw material in the mixing step K6 as a value of “0” to “4” for each color of yellow, magenta, and cyan in the case of manufacturing the sheet. Hereinafter, the value of “0” to “4” representing the amount of supply of yellow resin will be referred to as a yellow value. The value of “0” to “4” representing the amount of supply of magenta resin will be referred to as a magenta value. The value of “0” to “4” representing the amount of supply of cyan resin will be referred to as a cyan value.

In addition, in a case where the manufactured sheet is the “white paper”, the color setting value is a setting value that represents the amount of white resin supplied with respect to a predetermined amount of the raw material in the mixing step K6 as a value of “0” to “4” for white in the case of manufacturing the sheet. Hereinafter, the value of “0” to “4” representing the amount of supply of white resin will be referred to as a white value.

As illustrated in FIG. 8, information JH5h (“recipe 1”) that explicitly shows the currently selected recipe is displayed in the corresponding information display area RR5 related to the tab TB5a. In addition, in the corresponding information display area RR5 related to the tab TB5a, information indicating a setting item and a setting value are displayed in association with each other as recipe correlating information RP5 for each of the five setting items. That is, in the corresponding information display area RR5 related to the tab TB5a, the automatic stoppage sheet number (“not set”) is displayed in association with information JH5c (“automatic stoppage sheet number”) that indicates the automatic stoppage sheet number setting item. The paper size (“A4”) is displayed in association with information JH5d (“paper size”) that indicates the paper size setting item. The paper type (“plain paper (white paper)”) is displayed in association with information JH5e (“paper type”) that indicates the paper type setting item. The paper thickness (“level 2”) is displayed in association with information JH5f (“thickness”) that indicates the paper thickness setting item.

In addition, in the corresponding information display area RR5 related to the tab TB5a, in a case where the paper type is the “plain paper (white paper)” or the “thick paper (color paper)”, and the sheet manufactured by the sheet manufacturing apparatus 1 is the “color paper”, the yellow value, the magenta value, and the cyan value are displayed in association with information JH5g (“color setting”) that indicates the color setting item. FIG. 8 illustrates the fifth user interface U15 in which the yellow value, the magenta value, and the cyan value are displayed. Meanwhile, in the corresponding information display area RR5 related to the tab TB5a, in a case where the paper type is the “plain paper (white paper)” or the “thick paper (white paper)”, and the sheet manufactured by the sheet manufacturing apparatus 1 is the “white paper”, the white value is displayed in association with the information JH5g that indicates the color setting item.

By referring to the corresponding information display area RR5 related to the tab TB5a, the user can easily and appropriately recognize the content of the selected recipe, specifically, the item values of all setting items in the selected recipe.

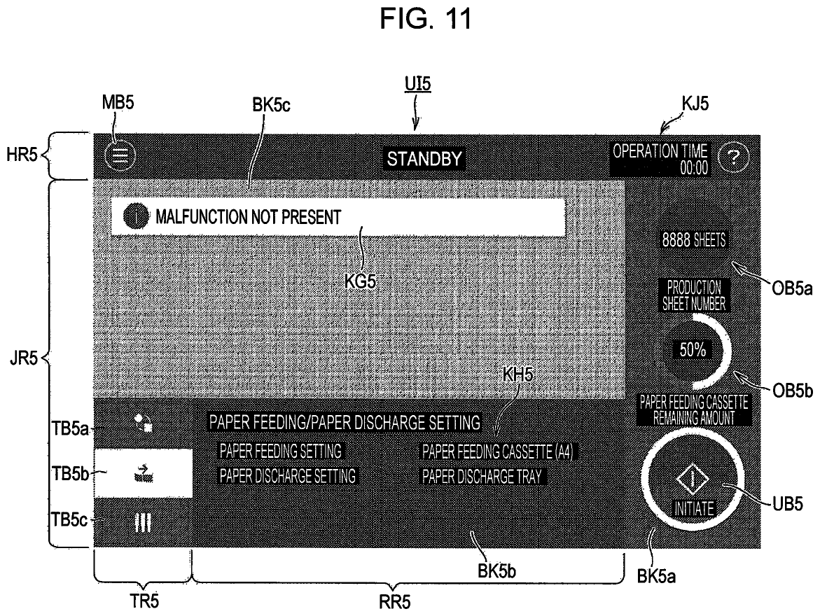

FIG. 11 illustrates the fifth user interface U15 in a state where the tab TB5b is selected.

The tab TB5b is a tab for providing an instruction to display paper feeding/paper discharge information KH5 (paper feeding/paper discharge information) related to paper feeding and paper discharge in the corresponding information display area RR5. Accordingly, in a case where the tab TB5b is selected, the paper feeding/paper discharge information KH5 is displayed in the corresponding information display area RR5.

The paper feeding/paper discharge information KH5 includes information indicating a unit (hereinafter, referred to as a “paper feeding unit”) of a supply source from which the old paper is supplied, and information indicating a unit (hereinafter, referred to as a “paper discharge unit”) of a discharge destination to which the manufactured sheet is discharged. As will become apparent below, the user can perform necessary setting for each of the paper feeding unit and the paper discharge unit depending on the unit mounted on the sheet manufacturing apparatus 1.

By referring to the paper feeding/paper discharge information KH5, the user can easily and appropriately recognize the paper feeding unit and the paper discharge unit.

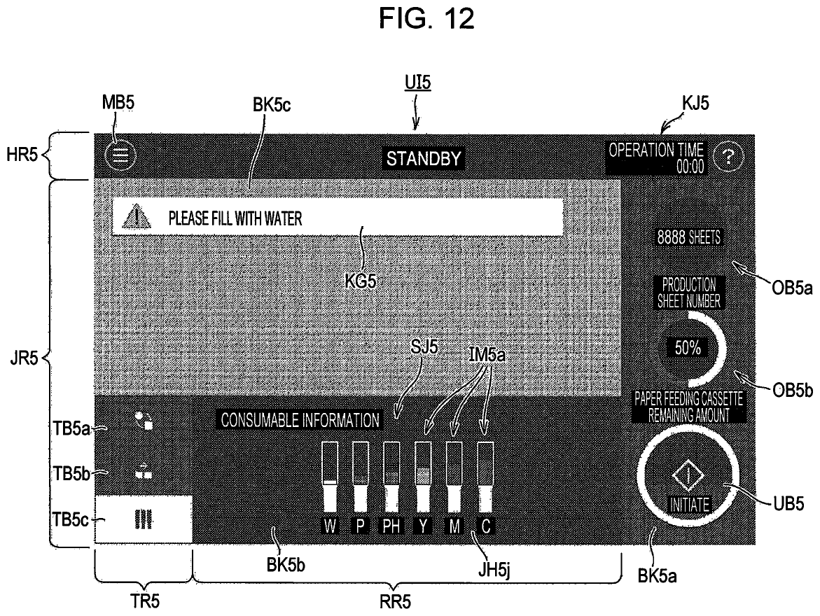

FIG. 12 illustrates the fifth user interface UI5 in a state where the tab TB5c is selected.

The tab TB5c is a tab for providing an instruction to display consumable information SJ5 (consumable information) (processing information) related to consumables in the corresponding information display area RR5. Accordingly, in a case where the tab TB5c is selected, the consumable information SJ5 is displayed in the corresponding information display area RR5.

As illustrated in FIG. 12, in a case where the tab TB5c is selected, information JH5j indicating the color of resin retained in the resin cartridge KT and an image IM5a representing the remaining amount of the resin cartridge KT are displayed in association with each other as the consumable information SJ5 in the corresponding information display area RR5 for each resin cartridge KT. As described above, in the present embodiment, the color of resin includes the first non-added color (P), the second non added color (PH), white (W), yellow (Y), magenta (M), and cyan (C) for each resin cartridge KT.

The image IM5a is an image in which the remaining amount of resin is represented as a bar inside an image resembling the resin cartridge KT.

By referring to the consumable information SJ5, the user can easily and appropriately recognize the remaining amount of each resin cartridge KT.

A configuration in which information indicating that replacement is needed is displayed in the consumable information SJ5 for the resin cartridge KT that needs to be replaced may be used.

In addition, the consumable information SJ5 may include information related to consumables other than the resin cartridge KT.

As described above, the menu button MB5 which is a touch operation button is displayed in the state display area HR5 of the fifth user interface UI5. In a case where a touch operation performed on the menu button MB5 is detected, the control unit 20 displays the menu screen MG in an overlaid manner on the fifth user interface UI5.

FIG. 13 is a diagram illustrating the menu screen MG. As illustrated in FIG. 13, seven item images KGMGa to KGMGg are displayed in the menu screen MG. Each of the seven item images is a touch operation button.

The item image KGMGa is an image for providing an instruction to display the fifth user interface UI5.

The item image KGMGb is an image on which a touch operation is performed in the case of performing setting related to the recipe.

The item image KGMGc is an image on which a touch operation is performed in the case of performing setting related to paper feeding and paper discharge.

The item image KGMGd is an image on which a touch operation is performed in the case of performing predetermined setting related to the sheet manufacturing apparatus 1.

The item image KGMGe is an image on which a touch operation is performed in the case of performing a predetermined operation for the sheet manufacturing apparatus 1.

The item image KGMGf is an image on which a touch operation is performed in the case of referring to predetermined information related to the sheet manufacturing apparatus 1.

The item image KGMGg is an image on which a touch operation is performed in the case of shutting the sheet manufacturing apparatus 1 down.

In a case where a touch operation performed on the item image KGMGb of the menu screen MG is detected, the control unit 20 displays a seventh user interface UI7.

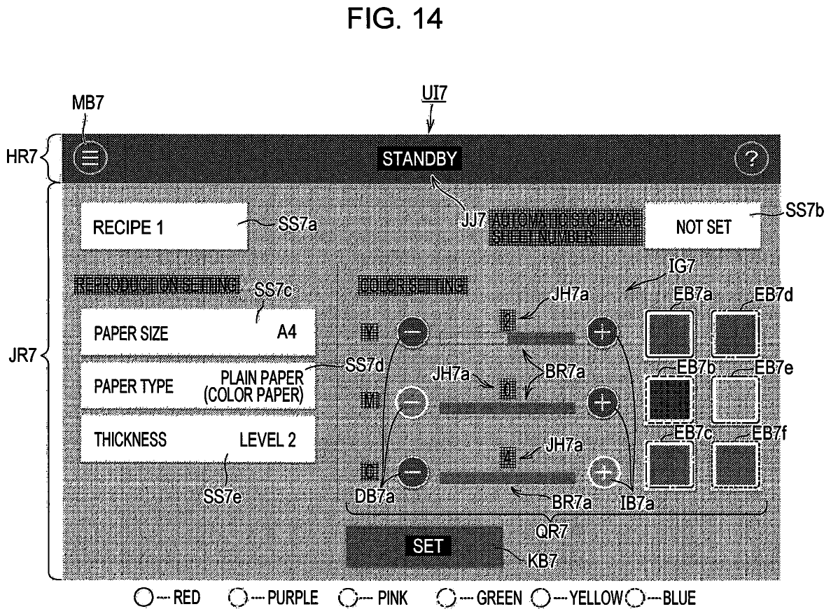

FIG. 14 is a diagram illustrating the seventh user interface UI7.

The seventh user interface UI7 is a user interface for performing setting related to the recipe.

As illustrated in FIG. 14, the seventh user interface UI7 includes a state display area HR7 and an information display area JR7. State information JJ7 (“standby”) and a menu button MB7 are displayed in the state display area HR7.

As illustrated in FIG. 14, a recipe selection button SS7a is disposed in the upper left portion of the information display area JR7 of the seventh user interface UI7. The recipe selection button SS7a is a touch operation button on which a touch operation is performed in the case of selecting the recipe. In addition, information that indicates the currently selected recipe (any of the recipe 1 to the recipe 10) is displayed in the recipe selection button SS7a. By referring to the information displayed in the recipe selection button SS7a, the user can recognize the currently selected recipe. In addition, in the case of selecting the recipe, the user performs a touch operation on the recipe selection button SS7a. In a case where a touch operation performed on the recipe selection button SS7a is detected, the control unit 20 displays an eighth user interface UI8 as a pop-up.

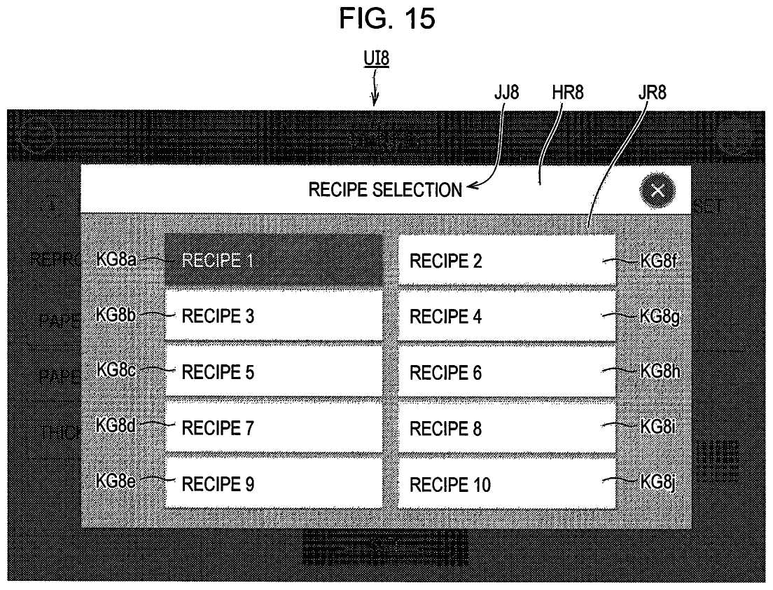

FIG. 15 is a diagram illustrating the eighth user interface UI8.

As described above, the user can register the recipe 1 to the recipe 10 in advance as the recipe and can select one recipe as the recipe to be used in manufacturing of the sheet from the 10 recipes. The eighth user interface UI8 is a user interface for selecting one recipe from the 10 recipes.

As illustrated in FIG. 15, state information JJ8 (“recipe selection”) that indicates that the recipe is to be selected is displayed in a state display area HR8 of the eighth user interface UI8.

As illustrated in FIG. 15, in an information display area JR8 of the eighth user interface UI8, 10 item images KG8a to KG8j are displayed in association with the 10 recipes of the recipe 1 to the recipe 10, respectively. Each of the item images KG8a to KG8j is a touch operation button. The user selects the recipe by performing a touch operation on any image of the item images KG8a to KG8j.

The recipe selected in the eighth user interface UI8 is used as a target recipe of the setting using the seventh user interface UI7. In addition, information that indicates the selected recipe is displayed in the recipe selection button SS7a of the seventh user interface UI7.

As illustrated in FIG. 14, a color setting area QR7 is formed in the right portion of the information display area JR7 of the seventh user interface UI7.

In the color setting area QR7, in a case where the paper type is the “plain paper (color paper)” or the “thick paper (color paper)”, and the sheet manufactured by the sheet manufacturing apparatus 1 is the “color paper”, a coloring value setting screen IG7 (FIG. 14) for setting the yellow value, the magenta value, and the cyan value is displayed.

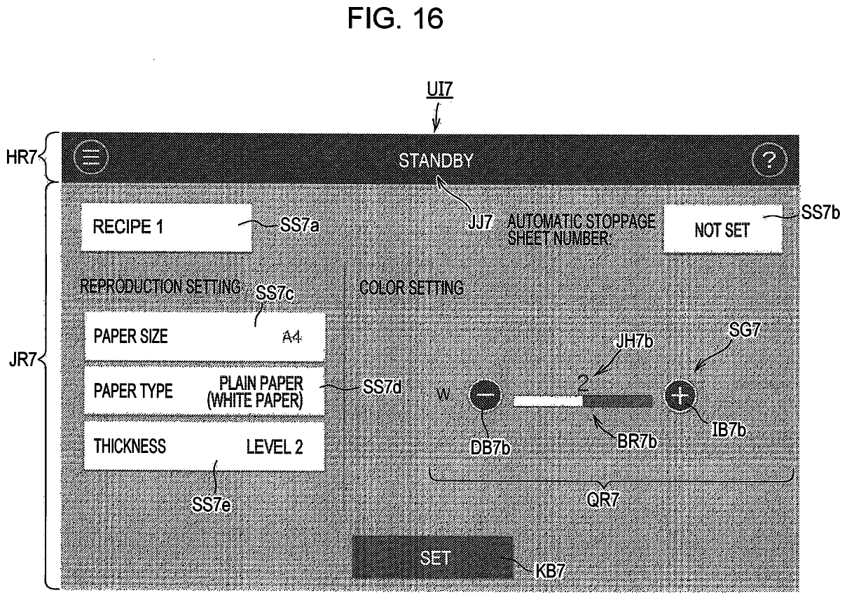

Meanwhile, in the color setting area QR7, in a case where the paper type is the “plain paper (white paper)” or the “thick paper (white paper)”, and the sheet manufactured by the sheet manufacturing apparatus 1 is the “white paper”, a white value setting screen SG7 (FIG. 16) for setting the white value is displayed.

FIG. 14 illustrates the seventh user interface UI7 in which the coloring value setting screen IG7 is displayed.

As illustrated in FIG. 14, in the coloring value setting screen IG7, the current value of each of the yellow value, the magenta value, and the cyan value is represented by a bar BR7a of which the length varies depending on the magnitude of the value, and information JH7a that indicates a specific value. By referring to the combination of the bar BR7a and the information JH7a, the user can easily and appropriately recognize the current value of each of the yellow value, the magenta value, and the cyan value. In addition, a decrement button DB7a for decrementing the value of each color setting value is displayed as a touch operation button on the left of the left end portion of each bar BR7a. In addition, an increment button IB7a for incrementing the value of each color setting value is displayed on the right of the right end portion of each bar BR7a. The user can set each of the yellow value, the magenta value, and the cyan value to a desired value within a range of “0” to “4” by an easy work of performing a touch operation on the decrement button DB7a and the increment button IB7a.

As illustrated in FIG. 14, for each of six colors (in the present embodiment, red, purple, pink, green, yellow, and blue), color selection buttons EB7a to EB7f in which rectangular objects filled with each color are displayed are displayed in the right portion of the coloring value setting screen IG7. Each of the color selection buttons EB7a to EB7f is a touch operation button.

In a case where a touch operation is performed on any one button of the six color selection buttons EB7a to EB7f, the yellow value, the magenta value, and the cyan value are automatically adjusted such that the color of the manufactured sheet is set to a color similar to a color corresponding to the button on which the touch operation is performed. For example, the color corresponding to the color selection button EB7a is red. In a case where a touch operation is performed on the color selection button EB7a, the yellow value, the magenta value, and the cyan value are automatically adjusted such that the color of the manufactured sheet is set to a color similar to red. In addition, the bar BR7a of each color and the information JH7a are set to be in a state where the yellow value, the magenta value, and the cyan value after automatic adjustment are reflected.

It is assumed that in many cases, the user does not appropriately recognize the ratio of yellow, magenta, and cyan to be supplied to the raw material in a case where the user wants to set the color of the manufactured sheet to a predetermined color. Accordingly, according to the present embodiment, the user can set the color of the manufactured sheet to a color similar to any color of at least the six colors by an easy work of performing a touch operation on any of the color selection buttons EB7a to EB7f. Furthermore, after performing a touch operation on the color selection buttons EB7a to EB7f, the user can adjust the yellow value, the magenta value, and the cyan value using the decrement button DB7a and the increment button IB7a, and can more appropriately set the color of the manufactured sheet to be similar to the desired color.

The colors corresponding to the color selection buttons EB7a to EB7f are merely one example and may include other colors. However, the six colors of red, purple, pink, green, yellow, and blue corresponding to the color selection buttons EB7a to EB7f of the present embodiment are representative colors employed as the color of the sheet and are appropriate as colors selectable by the color selection buttons EB7a to EB7f.

FIG. 16 illustrates the seventh user interface UI7 in which the white value setting screen SG7 is displayed.

As illustrated in FIG. 16, in the white value setting screen SG7, the current value of the white value is represented by a bar BR7b of which the length varies depending on the magnitude of the value, and information JH7b that indicates a specific value. By referring to the combination of the bar BR7b and the information JH7b, the user can easily and appropriately recognize the current value of the white value. In addition, a decrement button DB7b for decrementing the value of the white setting value is displayed as a touch operation button on the left of the left end portion of the bar BR7b. In addition, an increment button IB7b for incrementing the value of the white setting value is displayed on the right of the right end portion of the bar BR7b. The user can set the white value to a desired value within the range of “0” to “4” by an easy work of performing a touch operation on the decrement button DB7b and the increment button IB7b.

As illustrated in FIG. 14, an automatic stoppage sheet number setting button SS7b is disposed in the upper right portion of the information display area JR7 of the seventh user interface UI7. The automatic stoppage sheet number setting button SS7b is a touch operation button on which a touch operation is performed in the case of setting the automatic stoppage sheet number. In addition, information that indicates the currently set automatic stoppage sheet number is displayed in the automatic stoppage sheet number setting button SS7b. By referring to the information displayed in the automatic stoppage sheet number setting button SS7b, the user can recognize the currently set automatic stoppage sheet number. In addition, in the case of setting the automatic stoppage sheet number, the user performs a touch operation on the automatic stoppage sheet number setting button SS7b. In a case where a touch operation performed on the automatic stoppage sheet number setting button SS7b is detected, the control unit 20 displays a ninth user interface UI9 as a pop-up.

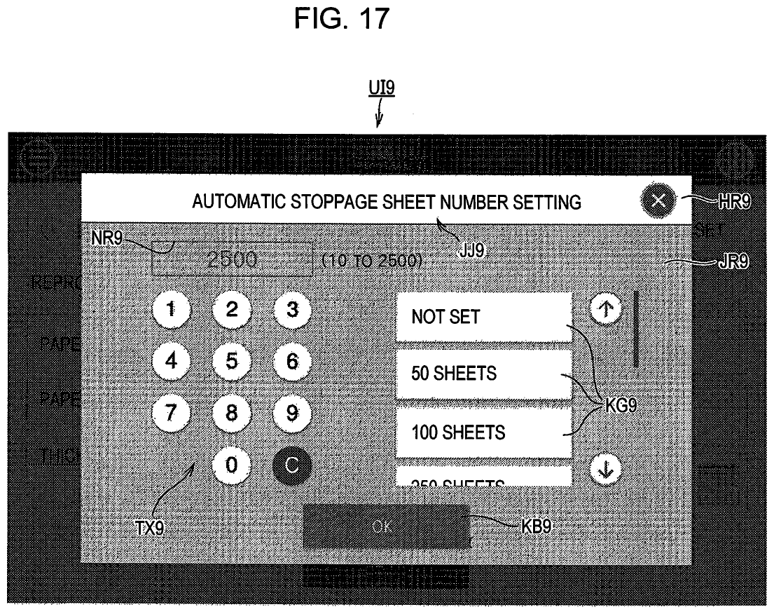

FIG. 17 is a diagram illustrating the ninth user interface UI9.

As illustrated in FIG. 17, state information JJ9 (“automatic stoppage sheet number”) that indicates that the automatic stoppage sheet number is to be set is displayed in a state display area HR9 of the ninth user interface UI9.

As illustrated in FIG. 17, an input field NR9 in which the value of the set automatic stoppage sheet number is input and displayed is displayed in the upper left portion of an information display area JR9 of the ninth user interface UI9. A software ten key TX9 is displayed below the input field NR9. On the right of the software ten key TX9, an item image KG9 that can be selected by a touch operation is displayed as a list for each of a plurality of different automatic stoppage sheet numbers (in FIG. 17, “50 sheets”, “100 sheets”, . . . ). Information that indicates the corresponding automatic stoppage sheet number is displayed in the item image KG9. In addition, information (“not set”) that indicates that setting is not performed is displayed in the leading item image KG9 of the plurality of item images KG9. In a case where the leading item image KG9 is selected by a touch operation, the automatic stoppage sheet number is not set. In this case, the sheet manufacturing apparatus 1 does not perform an automatic stoppage that is based on the fact that the number of manufactured sheets reaches a predetermined number of sheets.

As illustrated in FIG. 17, a confirmation button KB9 for confirming the input is displayed in the lower portion of the information display area JR9 of the ninth user interface UI9.

The user inputs the automatic stoppage sheet number into the input field NR9 by performing a touch operation on the software ten key TX9 and performing a touch operation on any item image KG9. The value of the automatic stoppage sheet number input by the user is displayed in the input field NR9 at all times. In the case of confirming the input, the user performs a touch operation on the confirmation button KB9.

In such a manner, in the present embodiment, the user can use the software ten key TX9 and also use the item image KG9 for setting the automatic stoppage sheet number. The user can easily set the automatic stoppage sheet number using the software ten key TX9 and the item image KG9.

As illustrated in FIG. 14, a paper size setting button SS7c is disposed in the left portion of the information display area JR7 of the seventh user interface UI7. The paper size setting button SS7c is a touch operation button on which a touch operation is performed in the case of setting the paper size. In addition, information that indicates the currently set paper size is displayed in the paper size setting button SS7c. By referring to the information displayed in the paper size setting button SS7c, the user can recognize the currently set paper size. In addition, in the case of setting the paper size, the user performs a touch operation on the paper size setting button SS7c. In a case where a touch operation performed on the paper size setting button SS7c is detected, the control unit 20 displays a tenth user interface UI10 as a pop-up.

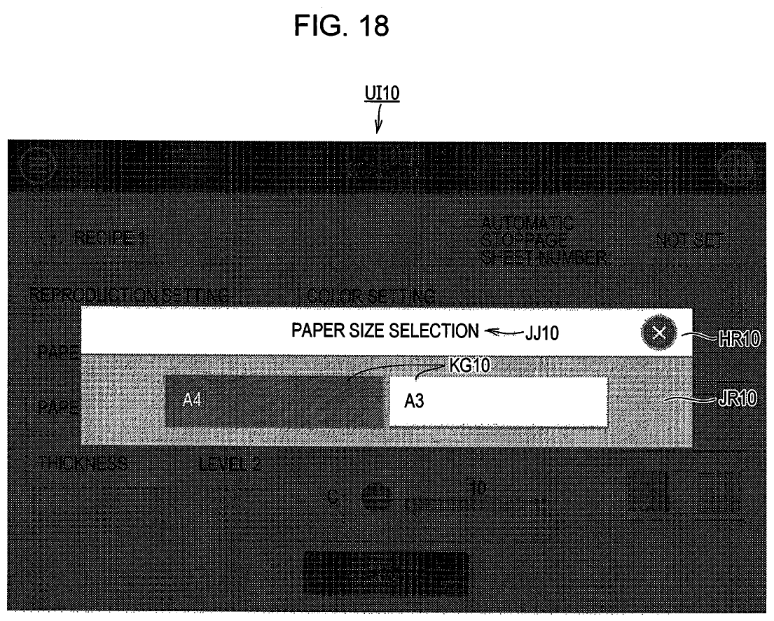

FIG. 18 is a diagram illustrating the tenth user interface UI10.

As illustrated in FIG. 18, state information JJ10 (“paper size selection”) that indicates that the paper size is to be set (selected) is displayed in a state display area HR10 of the tenth user interface UI10.

As illustrated in FIG. 18, an item image KG10 is displayed in association with each selectable paper size (in the present embodiment, “A3” or “A4”) in an information display area JR10 of the tenth user interface UI10. Each item image KG10 is a touch operation button. The user selects and sets the paper size by performing a touch operation on the image of any item image KG10.

As illustrated in FIG. 14, a paper type setting button SS7d is disposed below the paper size setting button SS7c in the left portion of the information display area JR7 of the seventh user interface UI7. The paper type setting button SS7d is a touch operation button on which a touch operation is performed in the case of setting the paper type. In addition, information that indicates the currently set paper type is displayed in the paper type setting button SS7d. By referring to the information displayed in the paper type setting button SS7d, the user can recognize the currently set paper type. In addition, in the case of setting the paper type, the user performs a touch operation on the paper type setting button SS7d. In a case where a touch operation performed on the paper type setting button SS7d is detected, the control unit 20 displays an eleventh user interface UI11 as a pop-up.

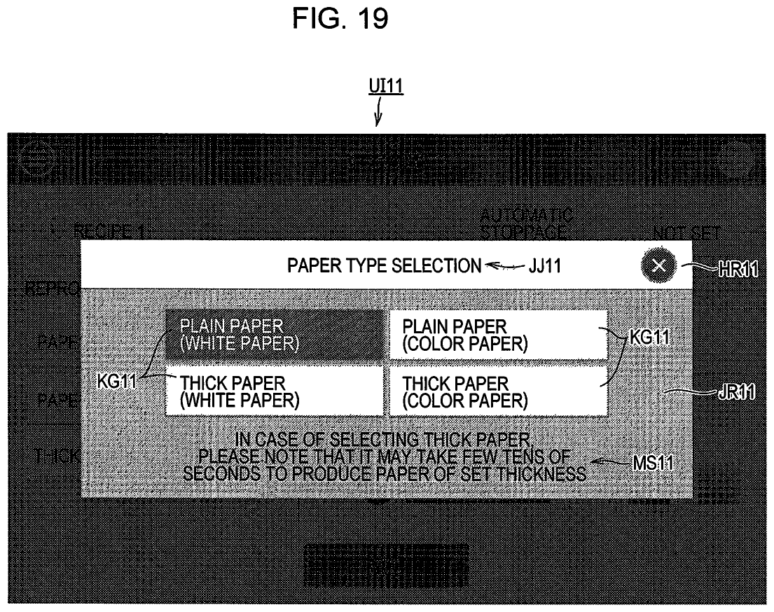

FIG. 19 is a diagram illustrating the eleventh user interface UI11.

As illustrated in FIG. 19, state information JJ11 (“paper type selection”) that indicates that the paper type is to be set (selected) is displayed in a state display area HR11 of the eleventh user interface UI11.

As illustrated in FIG. 19, an item image KG11 is displayed in association with each selectable paper type in an information display area JR11 of the eleventh user interface UI11. Each item image KG11 is a touch operation button. The user selects and sets the paper type by performing a touch operation on the image of any item image KG11.

As illustrated in FIG. 19, a message MS11 (“in the case of selecting the thick paper, . . . /it may take a few tens of seconds . . . ”) that indicates an alert in the case of selecting the thick paper (in the case of selecting paper type: “thick paper (white paper)” or paper type: “thick paper (color paper)”) is displayed in the lower portion of the information display area JR11 of the eleventh user interface UI11. By referring to the message MS11, the user can easily and appropriately recognize the alert in the case of setting the sheet manufactured by the sheet manufacturing apparatus 1 as the thick paper.

As illustrated in FIG. 14, a paper thickness setting button SS7e is disposed below the paper type setting button SS7d in the left portion of the information display area JR7 of the seventh user interface UI7. The paper thickness setting button SS7e is a touch operation button on which a touch operation is performed in the case of setting the paper thickness. In addition, information that indicates the currently set paper thickness (as described above, a level representing the degree of thickness) is displayed in the paper thickness setting button SS7e. By referring to the information displayed in the paper thickness setting button SS7e, the user can recognize the currently set paper thickness. In addition, in the case of setting the paper thickness, the user performs a touch operation on the paper thickness setting button SS7e. In a case where a touch operation performed on the paper thickness setting button SS7e is detected, the control unit 20 displays a twelfth user interface UI12 as a pop-up.

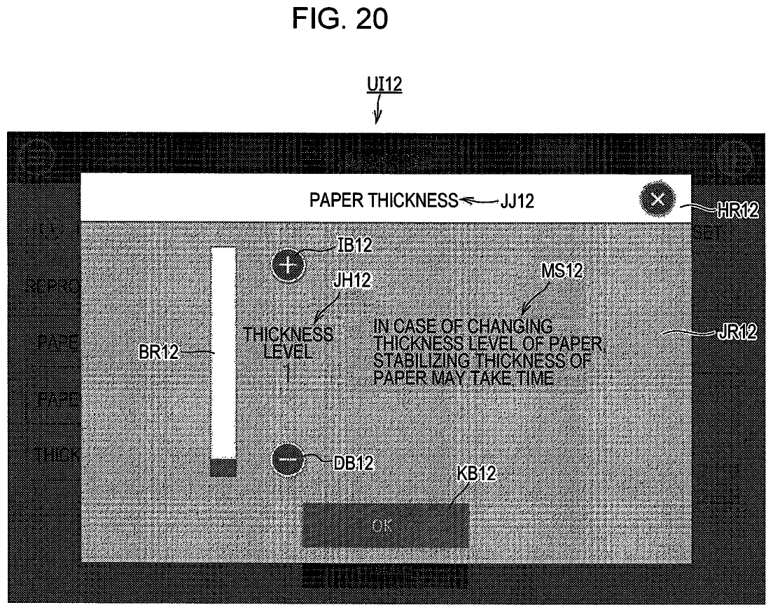

FIG. 20 is a diagram illustrating the twelfth user interface UI12.

As illustrated in FIG. 20, state information JJ12 (“paper thickness”) that indicates that the paper thickness is to be set is displayed in a state display area HR12 of the twelfth user interface UI12.

As illustrated in FIG. 20, in an information display area JR12 of the twelfth user interface UI12, the current level of the paper thickness extends in the up-down direction and is represented by a bar BR12 of which the length varies depending on the magnitude of the level, and information JH12 that indicates a specific value. By referring to the combination of the bar BR12 and the information JH12, the user can easily and appropriately recognize the current level of the paper thickness. In addition, a decrement button DB12 for decrementing the value of the level of the paper thickness is displayed as a touch operation button below the lower end portion of the bar BR12. In addition, an increment button IB12 for incrementing the value of the level of the paper thickness is displayed above the upper end portion of the bar BR12. The user can set the value of the level of the paper thickness to a desired value within a range of “level 1” to “level 10” by an easy work of performing a touch operation on the decrement button DB12 and the increment button IB12.

As illustrated in FIG. 20, a message MS12 (“in the case of changing the level of the paper thickness, . . . /stabilizing the thickness . . . /take time . . . ”) that indicates an alert in the case of changing the level of the paper thickness is displayed on the right of the bar BR12. By referring to the message MS12, the user can easily and appropriately recognize the alert in the case of changing the level of the paper thickness.

As illustrated in FIG. 20, a confirmation button KB12 for confirming an input in the twelfth user interface UI12 is displayed in the lower portion of the information display area JR12 of the twelfth user interface UI12. The user confirms the input and sets the paper thickness by performing a touch operation on the confirmation button KB12.

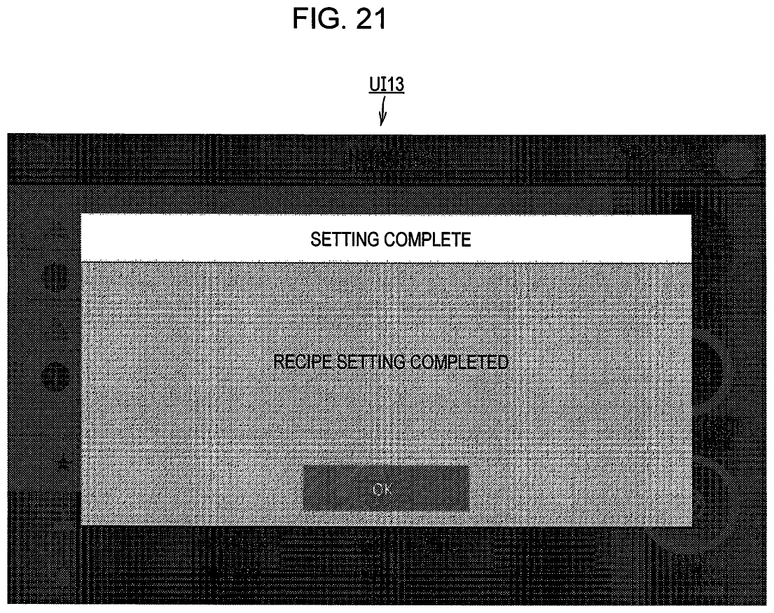

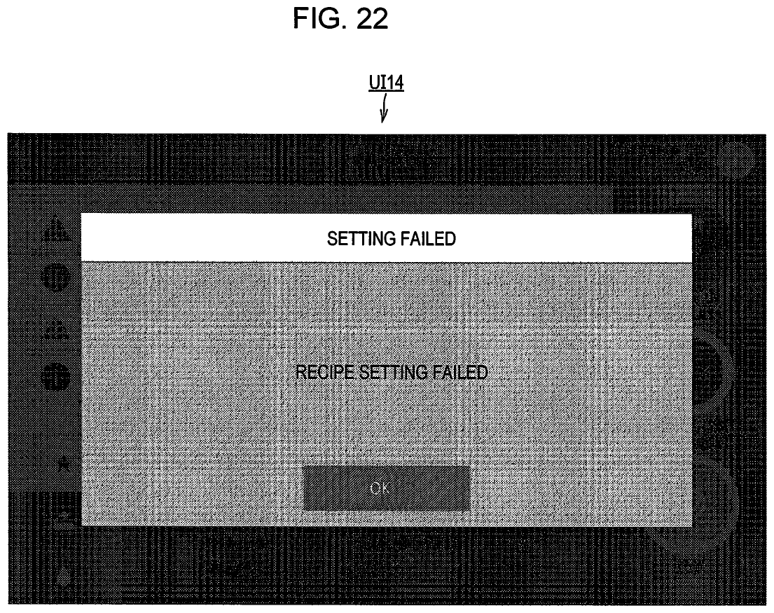

As illustrated in FIG. 14, a confirmation button KB7 is displayed in the lower portion of the information display area JR7 of the seventh user interface UI7. In the case of confirming an input in the seventh user interface UI7 and a user interface belonging to the user interface, the user performs a touch operation on the confirmation button KB7. In a case where a touch operation performed on the confirmation button KB7 is detected, the control unit 20 determines whether or not the setting performed by the user can be normally reflected. For example, the remaining amount of resin of a specific color may be insufficient, and the setting performed by the user may not be normally reflected. In a case where the setting performed by the user can be normally reflected, the control unit 20 notifies the user by displaying a thirteenth user interface UI13 (FIG. 21) in which information indicating that the setting succeeds is displayed, and displays the fifth user interface UI5 in response to an instruction from the user. Meanwhile, in a case where the setting performed by the user cannot be normally reflected, the control unit 20 notifies the user by displaying a fourteenth user interface UI14 (FIG. 22) in which information indicating that the setting fails is displayed, and displays the fifth user interface UI5 in response to an instruction from the user.

In a case where the setting succeeds, in the fifth user interface UI5 that is displayed on the touch panel 5 instead of the seventh user interface UI7, the setting value on which the setting performed using the seventh user interface UI7 is reflected for the selected recipe is displayed in the corresponding information display area RR5 related to the tab TB5a.

In a case where a touch operation performed on the item image KGMGc (an image on which a touch operation is performed in the case of performing setting related to paper feeding and paper discharge) of the menu screen MG illustrated in FIG. 13 is detected, the control unit 20 displays a fifteenth user interface UI15.

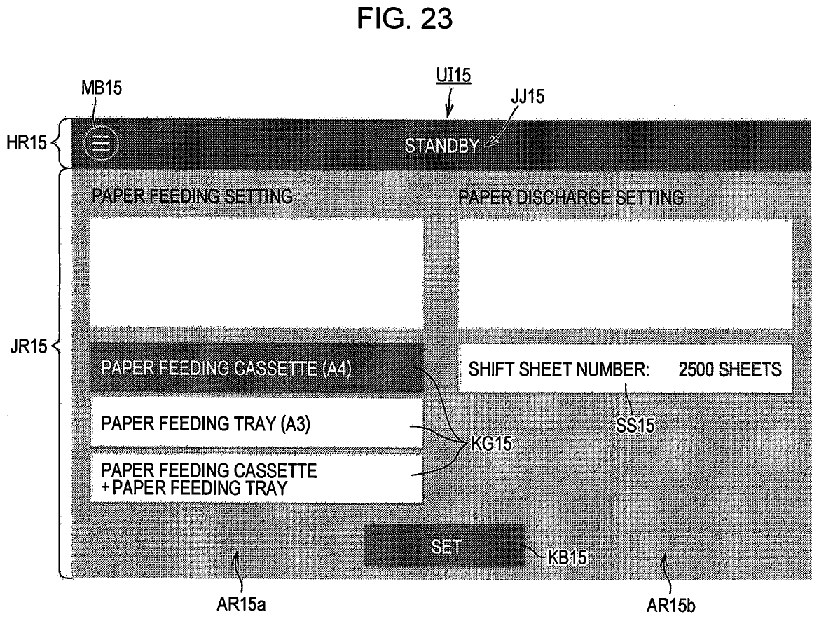

FIG. 23 is a diagram illustrating the fifteenth user interface UI15.

The fifteenth user interface UI15 is a user interface for performing setting related to paper feeding and paper discharge.

As illustrated in FIG. 23, the fifteenth user interface UI15 includes a state display area HR15 and an information display area JR15. State information JJ15 and a menu button MB15 are displayed in the state display area HR15.

In the information display area JR15 of the fifteenth user interface UI15, an area AR15a in the left portion is an area in which setting related to feeding of the old paper is performed, and an area AR15b in the right portion is an area in which setting related to discharge of the sheet is performed.

FIG. 23 illustrates the fifteenth user interface UI15 in a case where the paper feeding cassette 11 and the optional paper feeding tray are mounted as the paper feeding unit on the sheet manufacturing apparatus 1, and the optional paper discharge stacker is mounted as the paper discharge unit on the paper discharge tray 12. For the paper feeding unit and the paper discharge unit, the control unit 20 detects the unit mounted on the sheet manufacturing apparatus 1 and changes the content of the fifteenth user interface UI15 depending on the mounted unit.

As illustrated in FIG. 23, in the case of a state where the optional paper feeding tray is mounted as the paper feeding unit, three item images KG15 that enable selection of any one of the paper feeding cassette 11, the paper feeding tray, and the combination of the paper feeding cassette 11 and the paper feeding tray are displayed in the area AR15a. The user can set the paper feeding unit to be used for supply of the old paper by performing a touch operation on any item image KG15.

As illustrated in FIG. 23, in the case of a state where the optional paper discharge stacker is mounted as the paper discharge unit, a shift sheet number selection button SS15 in which information indicating a shift sheet number is displayed is displayed in the area AR15b. The paper discharge stacker includes a plurality of stacker units that can accommodate the manufactured sheet. The shift sheet number means the number of sheets accommodated in one stacker unit. In a case where a number of sheets corresponding to the shift sheet number accommodated in one stacker unit is detected, the control unit 20 switches the discharge destination of the sheet from the one stacker unit to another stacker unit in accordance with a predetermined order.

In a case where a touch operation performed on the shift sheet number selection button SS15 is detected, the control unit 20 displays a sixteenth user interface UI16 as a pop-up.

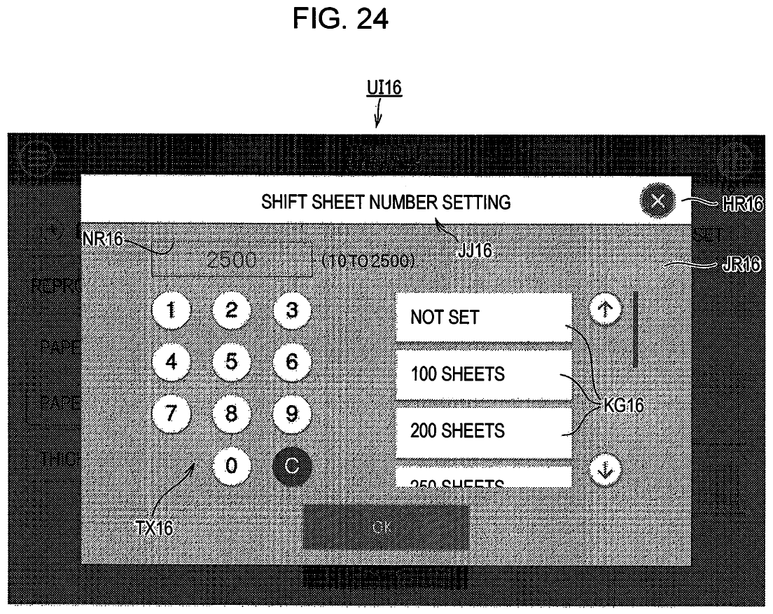

FIG. 24 is a diagram illustrating the sixteenth user interface UI16.

The display content of the sixteenth user interface UI16 is the same as the display content of the ninth user interface UI9 described using FIG. 17. That is, as illustrated in FIG. 24, state information JJ16 (“shift sheet number setting”) that indicates that the shift sheet number is to be set is displayed in a state display area HR16 of the sixteenth user interface UI16. In addition, in an information display area JR16 of the sixteenth user interface UI16, an input field NR16 in which the value of the set shift sheet number is input and displayed, a software ten key TX16, and a plurality of item images KG16 that enable selection of one automatic stoppage sheet number from a plurality of predetermined automatic stoppage sheet numbers by a touch operation are displayed.

In such a manner, in the present embodiment, the user can use the software ten key TX16 and also use the item image KG16 for setting the shift sheet number.

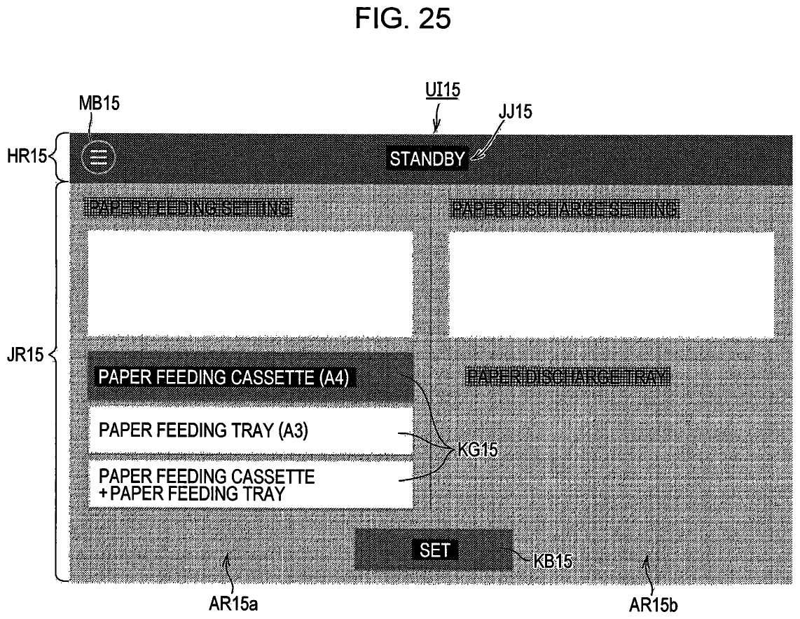

FIG. 25 illustrates the fifteenth user interface UI15 in a case where the optional paper feeding tray is mounted as the paper feeding unit on the sheet manufacturing apparatus 1, and the paper discharge tray 12 is mounted as the paper discharge unit on the sheet manufacturing apparatus 1 (in a case where the optional paper discharge stacker is not mounted).

As illustrated in FIG. 25, in the case of a state where the paper discharge tray 12 is mounted as the paper discharge unit on the sheet manufacturing apparatus 1, information that indicates that the paper discharge tray 12 is set as the paper discharge unit of the paper discharge destination of the sheet is displayed in the area AR15b.

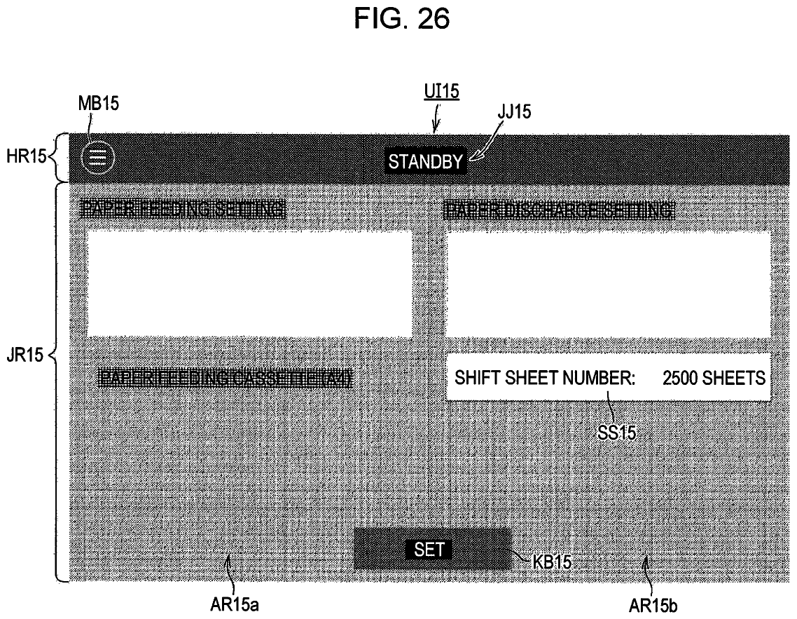

FIG. 26 illustrates the fifteenth user interface UI15 in a case where the paper feeding cassette 11 is mounted (the optional paper feeding tray is not mounted) as the paper feeding unit on the sheet manufacturing apparatus 1, and the optional paper discharge stacker is mounted as the paper discharge unit on the sheet manufacturing apparatus 1.

In the case of a state where the optional paper feeding tray is not mounted as the paper feeding unit on the sheet manufacturing apparatus 1, the paper feeding unit of the supply source of the old paper is automatically set as the paper feeding cassette 11. Accordingly, as illustrated in FIG. 26, information that indicates that the paper feeding cassette 11 is set as the paper feeding unit of the supply source of the old paper is displayed in the area AR15a.

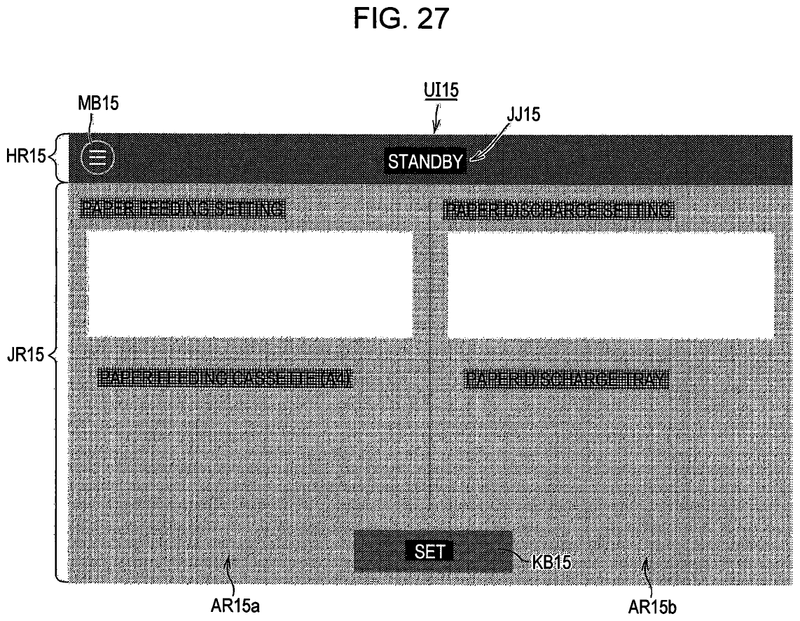

FIG. 27 illustrates the fifteenth user interface UI15 in the case of a state where the paper feeding cassette 11 is mounted as the paper feeding unit on the sheet manufacturing apparatus 1 in a state where the optional paper feeding tray is not mounted, and the paper discharge tray 12 is mounted as the paper discharge unit on the sheet manufacturing apparatus 1 in a state where the optional paper discharge stacker is not mounted.

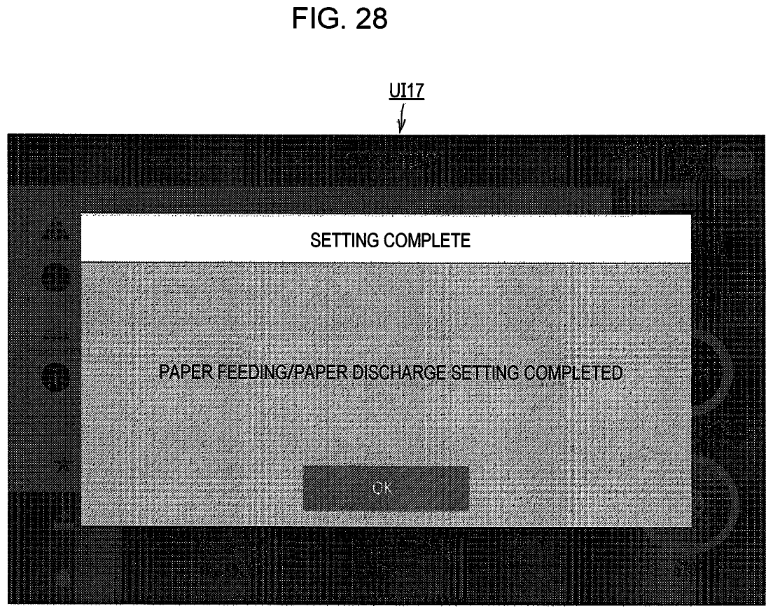

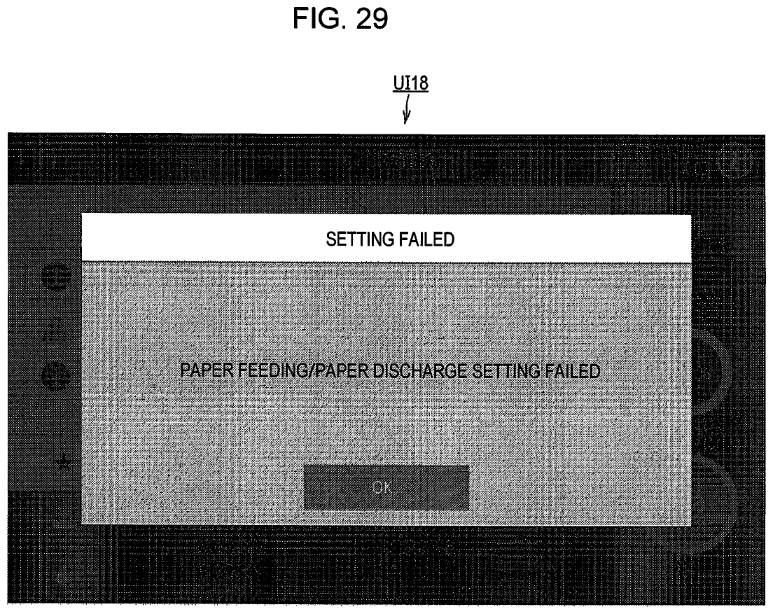

As illustrated in FIG. 23, a confirmation button KB15 for confirming an input in the user interface is displayed in the lower portion of the information display area JR15 of the fifteenth user interface UI15. In the case of confirming an input in the fifteenth user interface UI15 and a user interface belonging to the user interface, the user performs a touch operation on the confirmation button KB15. In a case where a touch operation performed on the confirmation button KB15 is detected, the control unit 20 determines whether or not the setting performed by the user can be normally reflected. In a case where the setting performed by the user can be normally reflected, the control unit 20 notifies the user by displaying a seventeenth user interface UI17 (FIG. 28) in which information indicating that the setting succeeds is displayed, and displays the fifth user interface UI5 in response to an instruction from the user. Meanwhile, in a case where the setting performed by the user cannot be normally reflected, the control unit 20 notifies the user by displaying an eighteenth user interface UI18 (FIG. 29) in which information indicating that the setting fails is displayed, and displays the fifth user interface UI5 in response to an instruction from the user.

In a case where the setting succeeds, in the fifth user interface UI5 that is displayed on the touch panel 5 instead of the seventeenth user interface UI17, information on which the setting performed using the fifteenth user interface UI15 is reflected is displayed in the corresponding information display area RR5 related to the tab TB5b.

In a case where a touch operation performed on the item image KGMGd (an image on which a touch operation is performed in the case of performing predetermined setting on the sheet manufacturing apparatus 1) of the menu screen MG illustrated in FIG. 13 is detected, the control unit 20 displays a nineteenth user interface UI19.

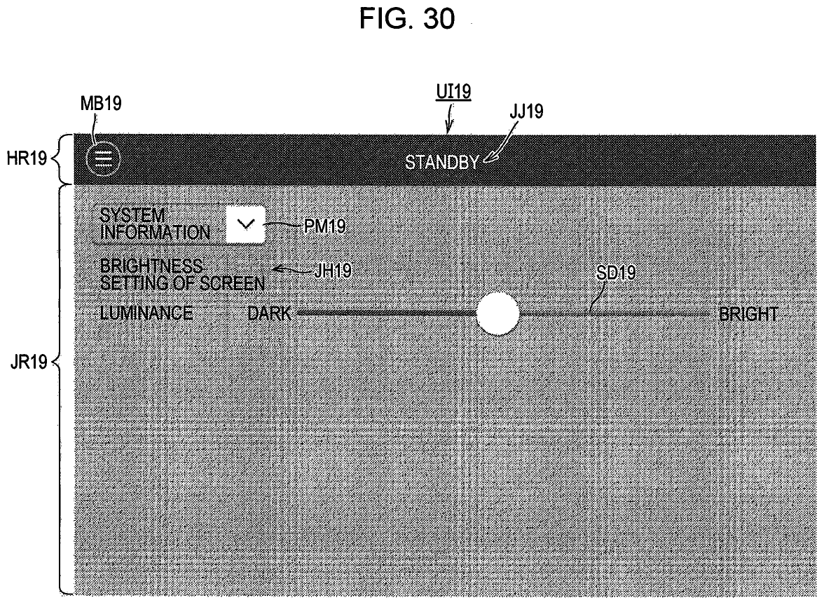

FIG. 30 is a diagram illustrating the nineteenth user interface UI19.

As illustrated in FIG. 30, the nineteenth user interface UI19 includes a state display area HR19 and an information display area JR19. State information JJ19 (“standby”) and a menu button MB19 are displayed in the state display area HR19.

As illustrated in FIG. 30, an item selection pull-down menu PM19 is disposed in the upper left portion of the information display area JR19 of the nineteenth user interface UI19. The item selection pull-down menu PM19 is a pull-down menu in which a target that is set by the nineteenth user interface UI19 is displayed as an item. In FIG. 30, the item selection pull-down menu PM19 is in a state where the pull-down menu is closed. The user can select the target to be set using the nineteenth user interface UI19 by selecting one item among items displayed in the item selection pull-down menu PM19.

The nineteenth user interface UI19 in FIG. 30 is a user interface for setting the brightness (luminance) of the screen displayed on the touch panel 5.

As illustrated in FIG. 30, in the information display area JR19 of the nineteenth user interface UI19, information JH19 that indicates that the nineteenth user interface UI19 is a user interface for performing setting of the brightness of the screen is displayed below the item selection pull-down menu PM19.

As illustrated in FIG. 30, a slider SD19 for adjusting the brightness of the screen is displayed in the center portion of the nineteenth user interface UI19. The user can adjust the brightness of the screen by an easy work of moving a knob of the slider SD19.

In a case where a touch operation performed on the item image KGMGe (an image on which a touch operation is performed in the case of performing a predetermined operation on the sheet manufacturing apparatus 1) of the menu screen MG illustrated in FIG. 13 is detected, the control unit 20 displays a twentieth user interface UI20.

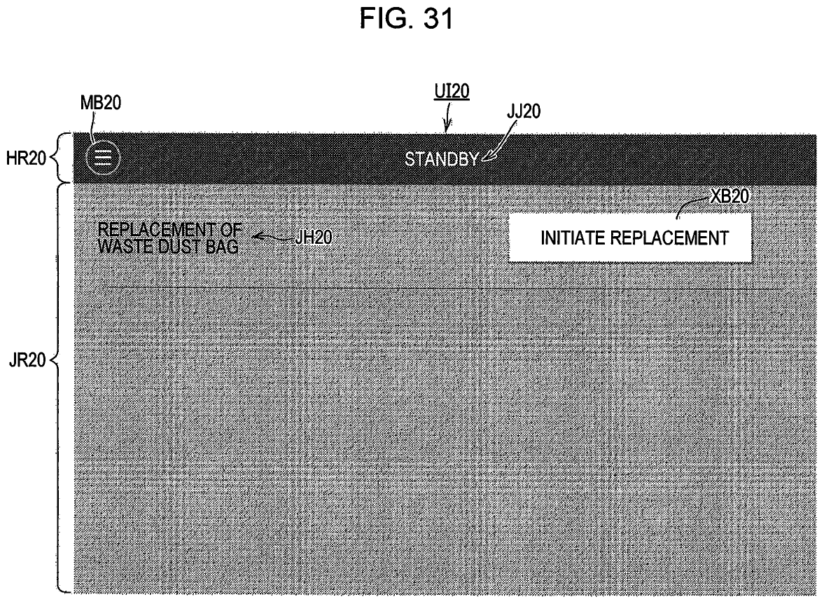

FIG. 31 is a diagram illustrating the twentieth user interface UI20.

As illustrated in FIG. 31, the twentieth user interface UI20 includes a state display area HR20 and an information display area JR20. State information JJ20 (“standby”) and a menu button MB20 are displayed in the state display area HR20.

In the present embodiment, the operation performed on the sheet manufacturing apparatus 1 is “replacement of the waste dust bag HH”. However, the operation performed on the sheet manufacturing apparatus 1 is not limited to “replacement of the waste dust bag HH”.

As illustrated in FIG. 31, in the information display area JR20 of the twentieth user interface UI20, information JH2O that explicitly shows that the operation performed on the sheet manufacturing apparatus 1 is “replacement of the waste dust bag HH”, and a replacement initiation button XB20 for providing an instruction to initiate replacement of the waste dust bag HH are displayed. The replacement initiation button XB20 is a touch operation button. In the case of replacing the waste dust bag HH, the user performs a touch operation on the replacement initiation button XB20. In a case where a touch operation performed on the replacement initiation button X1320 is detected, the control unit 20 displays a twenty-first user interface UI21 as a pop-up.

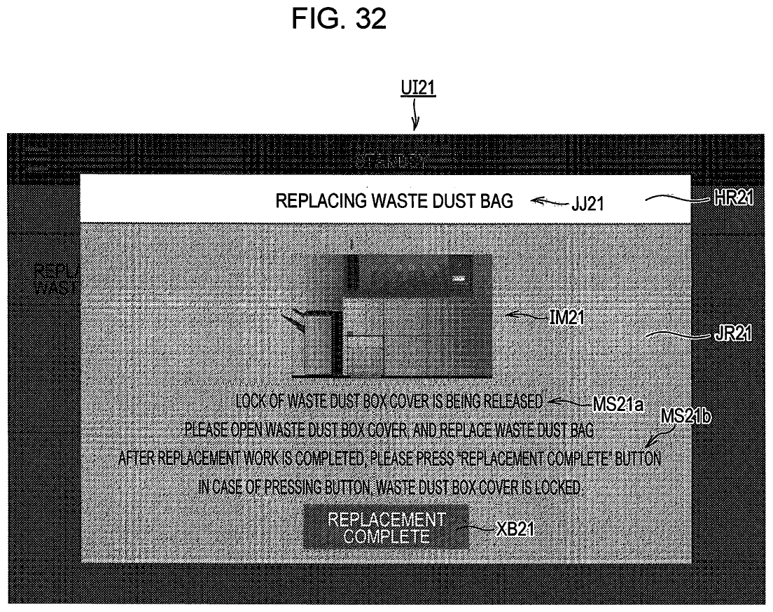

FIG. 32 is a diagram illustrating the twenty-first user interface UI21.

As illustrated in FIG. 32, the twenty-first user interface UI21 includes a state display area HR21 and an information display area JR21. State information JJ21 (“replacing the waste dust bag”) that indicates that the waste dust bag HH is being replaced is displayed in the state display area HR21.

As illustrated in FIG. 32, an image IM21 that represents the front view of the sheet manufacturing apparatus 1 is displayed in the information display area JR21 of the twenty-first user interface UI21. A message MS21a (“the waste dust box cover . . . ”) that indicates a state where the lock of the waste dust box cover 13 is released is displayed below the image IM21. In a case where a touch operation performed on the replacement initiation button XB20 of the twenty-first user interface UI20 (FIG. 31) is detected, the control unit 20 releases the lock of the waste dust box cover 13 by controlling the lock unit 24. By referring to the message MS21a, the user can easily and appropriately recognize the state where the lock of the waste dust box cover 13 is released.

As illustrated in FIG. 32, a message MS21b (“open the waste dust box cover . . . /after the replacement work is completed . . . /in the case of pressing the button . . . ”) that indicates a procedure at the time of replacing the waste dust bag HH is displayed below the message MS21a. By referring to the message MS21b, the user can easily and appropriately recognize the procedure at the time of replacing the waste dust bag HH. In the twenty-first user interface UI21, the image IM21 that represents the front view of the sheet manufacturing apparatus 1 is displayed. Thus, using such a fact, a configuration in which information, an image, and other objects indicating the position and the like of the waste dust box cover are displayed in association with the image IM21 may be used.

As indicated by the message MS21b, the procedure of replacing the waste dust bag HH includes a work of opening the waste dust box cover 13. In a case where opening of the waste dust box cover is detected, the control unit 20 displays a twenty-second user interface UI22 as a pop-up.

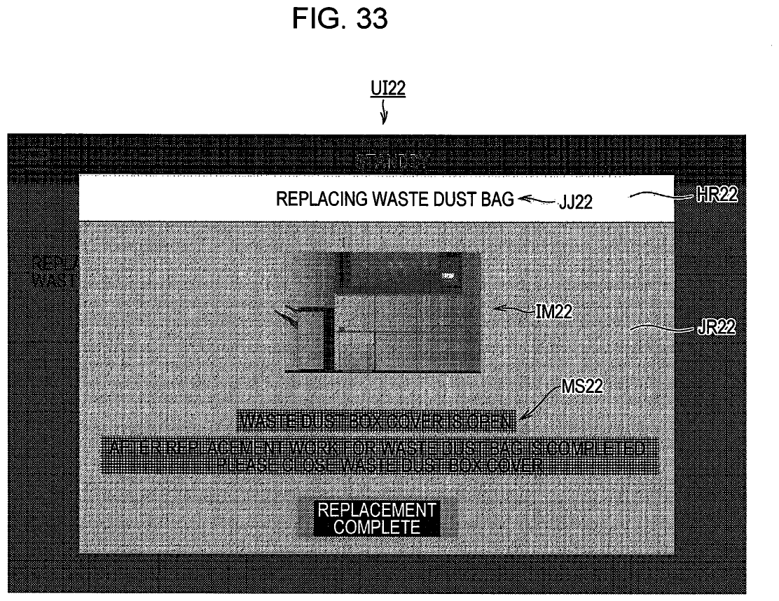

FIG. 33 is a diagram illustrating the twenty-second user interface UI22.

As illustrated in FIG. 33, the twenty-second user interface UI22 includes a state display area HR22 and an information display area JR22. State information JJ22 (“replacing the waste dust bag”) that indicates that the waste dust bag HH is being replaced is displayed in the state display area HR22.

As illustrated in FIG. 33, an image IM22 that represents the front view of the sheet manufacturing apparatus 1 is displayed in the information display area JR22 of the twenty-second user interface UI22. A message MS22 that indicates a state where the waste dust box cover 13 is open, and the necessity to close the waste dust box cover 13 in a case where replacement of the waste dust bag HH is completed is displayed below the image IM22.

By referring to the message MS22, the user can easily and appropriately recognize the current status of the waste dust box and the necessity to close the waste dust box cover 13 in a case where replacement of the waste dust bag HH is completed.

In a case where closing of the waste dust box cover 13 is detected, the control unit 20 displays the twenty-first user interface UI21.

As illustrated in FIG. 32, a replacement complete button XB21 is displayed in the lower portion of the twenty-first user interface UI21. In a case where replacement of the waste dust bag HH is completed, the user performs a touch operation on the replacement complete button XB21. In a case where a touch operation performed on the replacement complete button XB21 is detected, the control unit 20 executes a corresponding process.

In a case where a touch operation performed on the item image KGMGf (an image on which a touch operation is performed in the case of referring to predetermined information related to the sheet manufacturing apparatus 1) of the menu screen MG illustrated in FIG. 13 is detected, the control unit 20 displays a twenty-third user interface UI23.

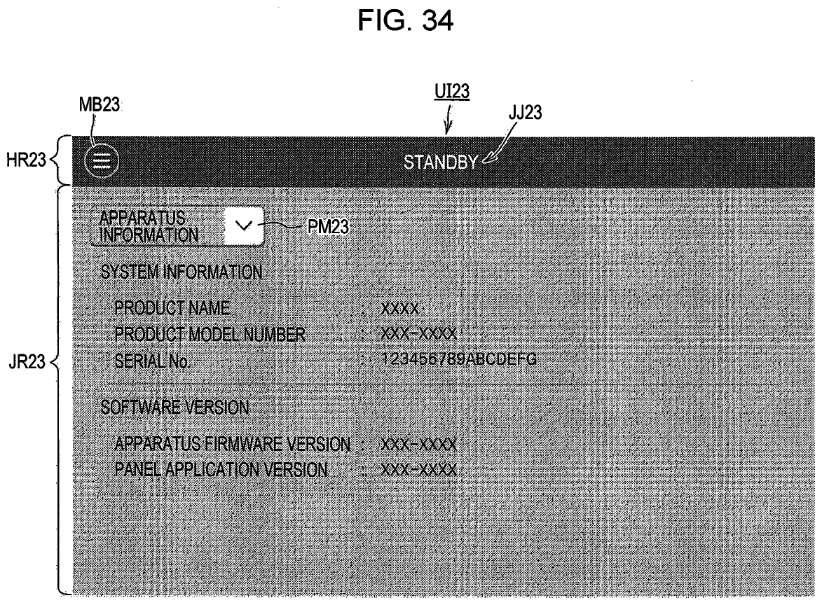

FIG. 34 is a diagram illustrating the twenty-third user interface UI23.

As illustrated in FIG. 34, the twenty-third user interface UI23 includes a state display area HR23 and an information display area JR23. State information JJ23 (“standby”) and a menu button MB23 are displayed in the state display area HR23.

As illustrated in FIG. 34, an item selection pull-down menu PM23 is disposed in the upper left portion of the information display area JR23 of the twenty-third user interface UI23. The item selection pull-down menu PM23 is a pull-down menu in which a target for referring to detailed information by the twenty-third user interface UI23 is displayed as an item. In FIG. 34, the item selection pull-down menu PM23 is in a state where the pull-down menu is closed. The user can select the target to be set using the twenty-third user interface UI23 by selecting one item among items displayed in the item selection pull-down menu PM23.

FIG. 34 illustrates the twenty-third user interface UI23 in a state where “apparatus information” is selected as a target for referring to detailed information.

The apparatus information includes a product name, a product number, and a serial No of the sheet manufacturing apparatus 1 as system information. In addition, the apparatus information includes the version of the firmware of the sheet manufacturing apparatus 1 and the version of an application controlling display of the touch panel 5 as software versions.

As illustrated in FIG. 34, information included in the apparatus information is displayed in the twenty-third user interface UI23 related to the apparatus information. By referring to the twenty-third user interface UI23 related to the apparatus information, the user can easily and appropriately recognize the apparatus information.

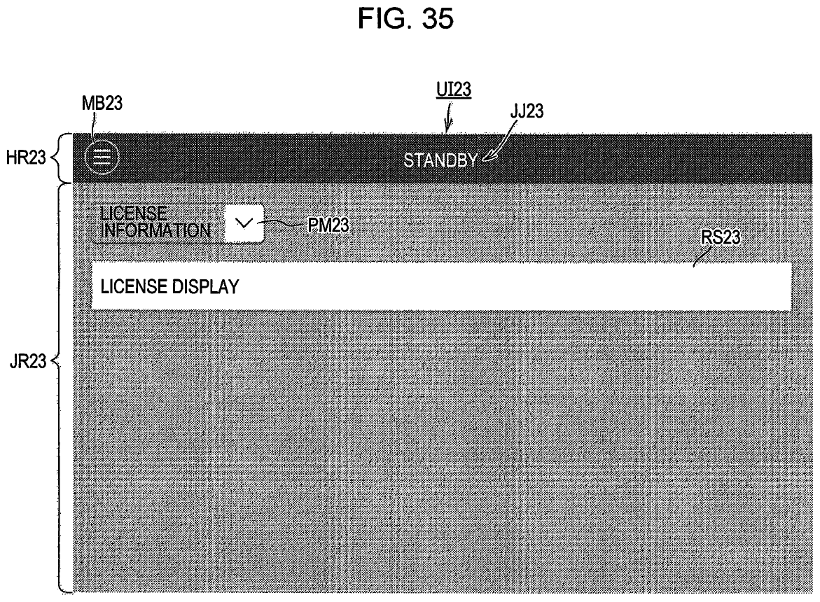

FIG. 35 illustrates the twenty-third user interface UI23 in a state where “license information” is selected as a target for referring to detailed information.

The license information is information related to the license of the sheet manufacturing apparatus 1.

As illustrated in FIG. 35, a license display button RS23 is displayed in the twenty-third user interface UI23 related to the license information. The license display button RS23 is a touch operation button on which a touch operation is performed in the case of referring to detailed information related to the license. In a case where an operation performed on the license display button RS23 of the twenty-third user interface UI23 related to the license information is detected, the control unit 20 displays a twenty-fourth user interface UI24 as a pop-up.

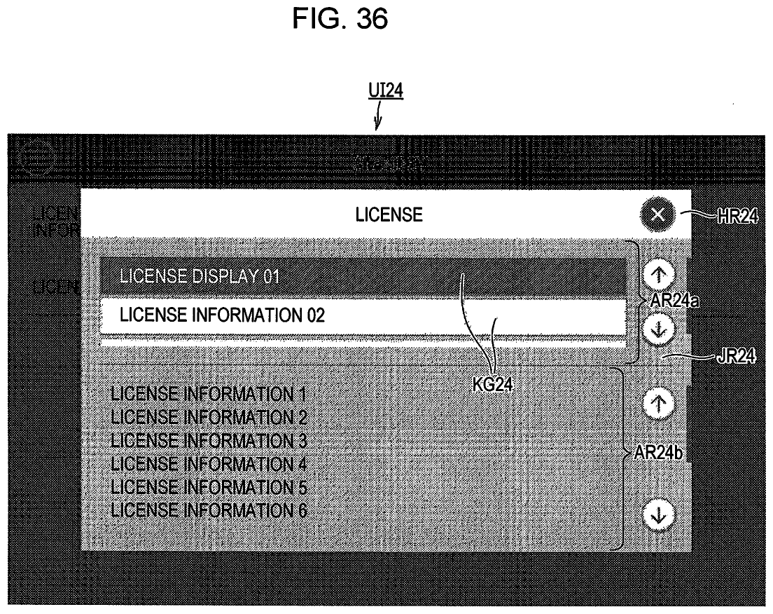

FIG. 36 is a diagram illustrating the twenty-fourth user interface UI24.

As illustrated in FIG. 36, the twenty-fourth user interface UI24 includes a state display area HR24 and an information display area JR24. State information JJ23 (“license”) that indicates that information related to the license is being displayed is displayed in the state display area HR24.

As illustrated in FIG. 36, the information display area JR24 of the twenty-fourth user interface UI24 includes, as areas, an area AR24a formed in the upper portion and an area AR24b formed in the lower portion. The area AR24a is an area in which one item is selected from a plurality of items related to the license. As illustrated in FIG. 36, an item image KG24 is displayed in association with each item in the area AR24a. Each item image KG24 is a touch operation button. The user selects the item by performing a touch operation on the image of any item image KG24.

As illustrated in FIG. 36, information that is related to the license and corresponds to the item selected in the area AR24a is displayed in the area AR24b. By referring to the information displayed in the area AR24b, the user can easily and appropriately recognize information that is related to the license and corresponds to the selected item.

As illustrated in FIG. 8, the operation initiation button UB5 is displayed in the first block BK5a of the fifth user interface UI5. The operation initiation button UB5 is a touch operation button for providing an instruction to initiate the process of manufacturing the sheet by the sheet manufacturing apparatus 1. In a case where a touch operation performed on the operation initiation button UB5 is detected, the control unit 20 displays a twenty-fifth user interface UI25 as a pop-up without immediately initiating the process of manufacturing the sheet.

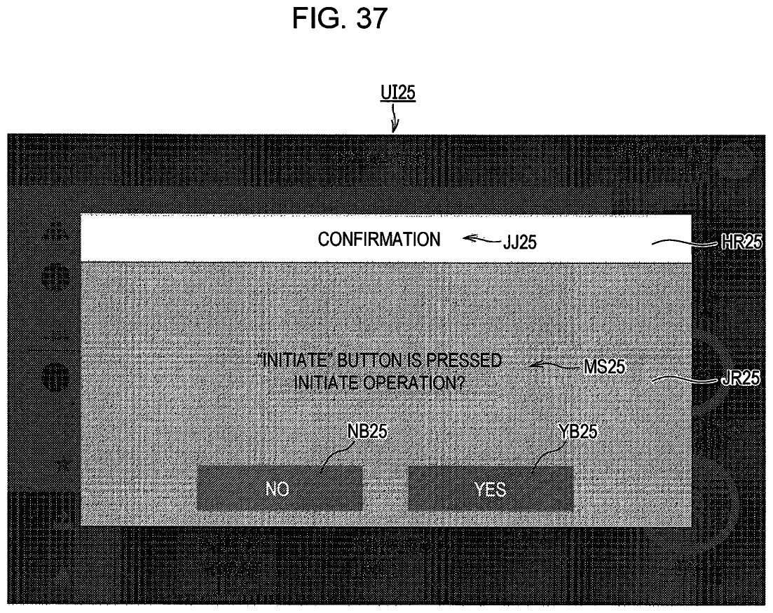

FIG. 37 is a diagram illustrating the twenty-fifth user interface UI25.

The twenty-fifth user interface UI25 is a user interface for causing the user to confirm initiation of the process of manufacturing the sheet.

As illustrated in FIG. 37, the twenty-fifth user interface UI25 includes a state display area HR25 and an information display area JR25. State information JJ25 (“confirmation”) that indicates that initiation of the process of manufacturing the sheet is being confirmed is displayed in the state display area HR25.

As illustrated in FIG. 37, a message MS25 (“the “initiate” button is pressed/initiate operation?”) that makes an inquiry to the user about whether or not to initiate the process of manufacturing the sheet is displayed in the information display area JR25 of the twenty-fifth user interface UI25. In addition, in the information display area JR25, a negative button NB25 on which a touch operation is performed in the case of canceling initiation of the process, and a positive button YB25 on which a touch operation is performed in the case of providing an instruction to initiate the process are displayed below the message MS25. In the case of canceling initiation of the process related to manufacturing of the sheet, the user performs a touch operation on the negative button NB25. In the case of initiating manufacturing of the sheet, the user performs a touch operation on the positive button YB25.

It is assumed that even in a case where the user performs a touch operation on the operation initiation button UB5 of the fifth user interface UI5, the case of canceling initiation of the process may occur due to a predetermined matter. In addition, it is assumed that a case where a touch operation is erroneously performed on the operation initiation button UB5 may occur. Even in those cases, the process related to manufacturing of the sheet is not immediately initiated in response to the touch operation performed on the operation initiation button UB5. A configuration in which the twenty-fifth user interface UI25 causes the user to confirm initiation of the process related to manufacturing of the sheet and initiates the process only after an instruction is provided from the user again is used. Thus, the occurrence of an event in which the process is unnecessarily initiated can be prevented.

In a case where a touch operation performed on the negative button NB25 of the twenty-fifth user interface UI25 is detected, the control unit 20 cancels initiation of the process related to manufacturing of the sheet.

In a case where a touch operation performed on the positive button YB25 of the twenty-fifth user interface UI25 is detected, the control unit 20 executes a necessary initiation preparation process for initiating the process related to manufacturing of the sheet and displays a twenty-sixth user interface UI26 on the touch panel 5. The initiation preparation process is a process that is performed in advance in order to normally perform the process related to manufacturing of the sheet. For example, as the initiation preparation process, the control unit 20 executes initial operation confirmation for a predetermined mechanism, executes a process for setting a predetermined mechanism to be in an operable state, and detects the presence of error based on an input from a predetermined sensor.

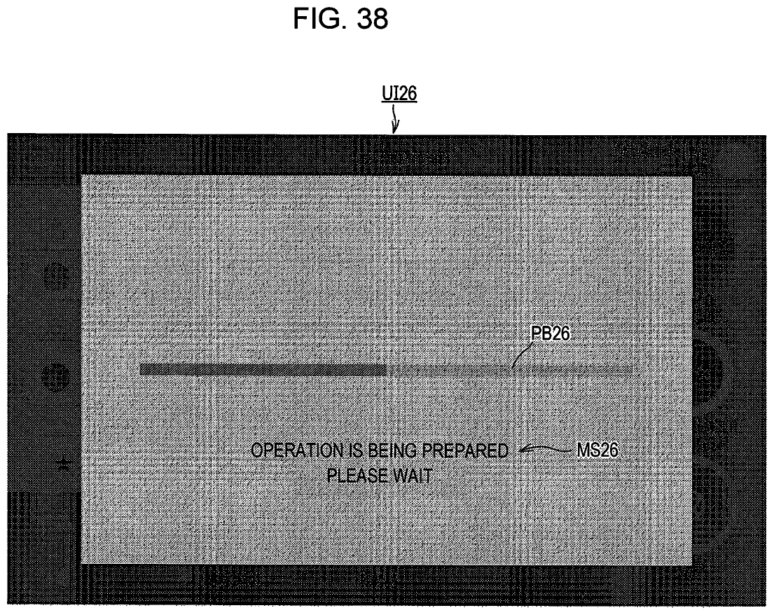

FIG. 38 is a diagram illustrating the twenty-sixth user interface UI26.

The twenty-sixth user interface UI26 is a user interface that represents that the initiation preparation process is being executed, and represents the progress of the initiation preparation process.

As illustrated in FIG. 38, the twenty-sixth user interface UI26 includes a progress bar PB26 that represents the progress of the initiation preparation process.

As illustrated in FIG. 38, in the twenty-sixth user interface UI26, a message MS26 (“operation is being prepared/please wait”) that indicates that the initiation preparation process is being executed, and the user is to wait is displayed below the progress bar PB26. By referring to the progress bar PB26 and the message MS26, the user can easily and appropriately recognize that the initiation preparation process is being executed, and recognize a situation in which the user is to wait.

In a case where completion of the initiation preparation process is detected, the control unit 20 stops displaying the twenty-sixth user interface UI26 and displays the fifth user interface UI5.

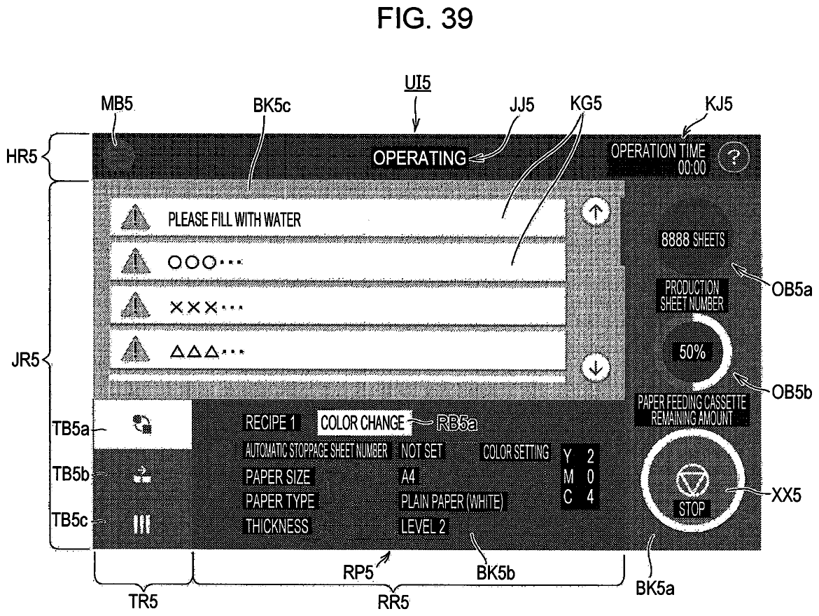

FIG. 39 is a diagram illustrating the fifth user interface UI5 that is displayed after initiation of the process related to manufacturing of the sheet.

Particularly, FIG. 39 illustrates the fifth user interface UI5 in a state where the corresponding information display area RR5 related to the tab TB5a is displayed.

As is apparent from comparison between FIG. 8 and FIG. 39, an operation stoppage button XX5 is displayed instead of the operation initiation button UB5 during execution of the process related to manufacturing of the sheet. The operation stoppage button XX5 is a touch operation button for providing an instruction to stop the process. The screen displayed on the touch panel 5 and the process of the control unit 20 in a case where a touch operation is performed on the operation stoppage button XX5 will be described below.

As is apparent from comparison between FIG. 8 and FIG. 39, during execution of the process related to manufacturing of the sheet, a color change instruction button RB5a is displayed on the right of the information JH5h indicating the selected recipe in the corresponding information display area RR5 related to the tab TB5a. The color change instruction button RB5a is a touch operation button that is operated in the case of changing the color of the manufactured sheet.

In a case where a touch operation performed on the color change instruction button RB5a is detected, the control unit 20 displays a twenty-seventh user interface UI27 as a pop-up.

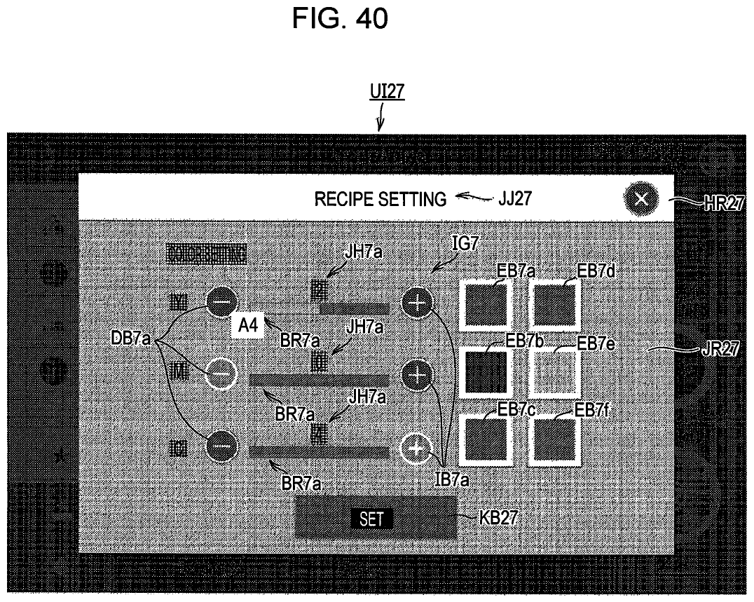

FIG. 40 is a diagram illustrating the twenty-seventh user interface UI27.

Particularly, FIG. 40 illustrates the twenty-seventh user interface UI27 in a case where the sheet manufactured by the sheet manufacturing apparatus 1 is the “color paper”.

As illustrated in FIG. 40, the twenty-seventh user interface UI27 includes a state display area HR27 and an information display area JR27. State information JJ27 (“recipe setting”) is displayed in the state display area HR27.

As is apparent from comparison between FIG. 40 and FIG. 14, in a case where the sheet manufactured by the sheet manufacturing apparatus 1 is the “color paper”, the content of the twenty-seventh user interface UI27 is the same as the content of the color setting area QR7 of the seventh user interface UI7 illustrated in FIG. 14. Accordingly, information, images, and other objects displayed in the twenty-seventh user interface UI27 in FIG. 40 will be designated by the same reference signs as the reference signs of information, images, and other objects displayed in the color setting area QR7 of the seventh user interface UI7 illustrated in FIG. 14 and will not be described in detail.

While illustration is not provided, in a case where the sheet manufactured by the sheet manufacturing apparatus 1 is the “white paper”, the content of the twenty-seventh user interface UI27 is the same as the content of the color setting area QR7 of the seventh user interface UI7 in FIG. 16.

The user can easily perform setting related to color using the twenty-seventh user interface UI27 in the same manner as the case of using the seventh user interface UI7.

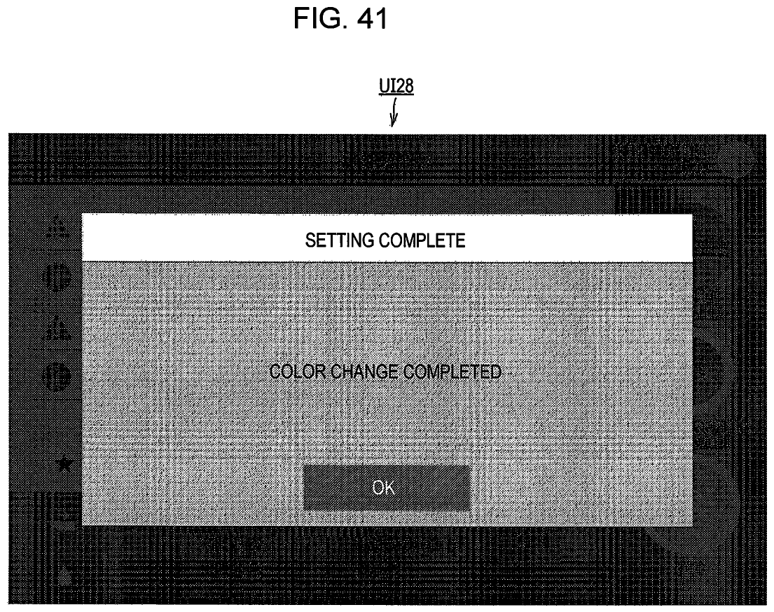

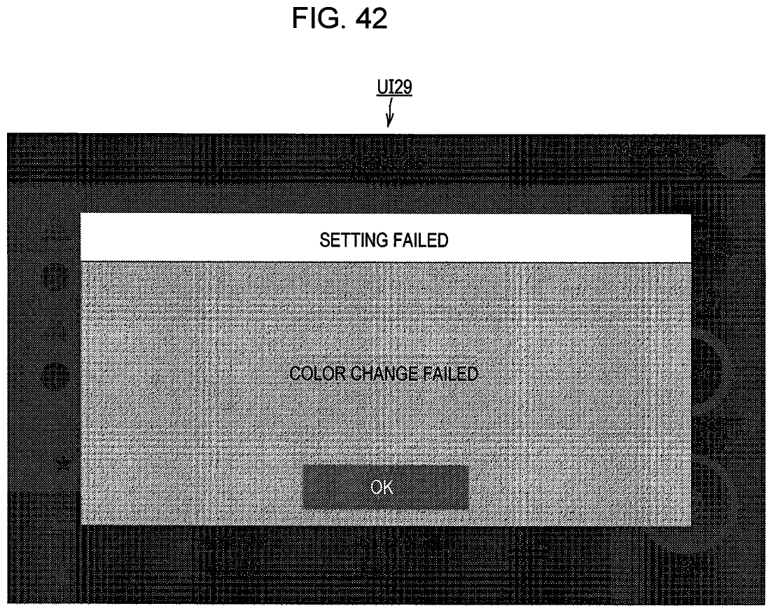

As illustrated in FIG. 40, a confirmation button KB27 for confirming an input into the twenty-seventh user interface UI27 is displayed in the lower portion of the information display area JR27 of the twenty-seventh user interface UI27. In the case of confirming the input in the twenty-seventh user interface UI27, the user performs a touch operation on the confirmation button KB27. In a case where a touch operation performed on the confirmation button KB27 is detected, the control unit 20 determines whether or not the setting performed by the user can be normally reflected. In a case where the setting performed by the user can be normally reflected, the control unit 20 notifies the user by displaying a twenty-eighth user interface UI28 (FIG. 41) in which information indicating that the setting succeeds is displayed, and displays the fifth user interface UI5 in response to an instruction from the user. Meanwhile, in a case where the setting performed by the user cannot be normally reflected, the control unit 20 notifies the user by displaying a twenty-ninth user interface UI29 (FIG. 42) in which information indicating that the setting fails is displayed, and displays the fifth user interface UI5 in response to an instruction from the user.

In a case where the setting succeeds, in the fifth user interface UI5 that is displayed on the touch panel 5 instead of the twenty-seventh user interface UI27, the setting value on which the setting performed using the twenty-seventh user interface UI27 is reflected for the selected recipe is displayed in the corresponding information display area RR5 related to the tab TB5a.

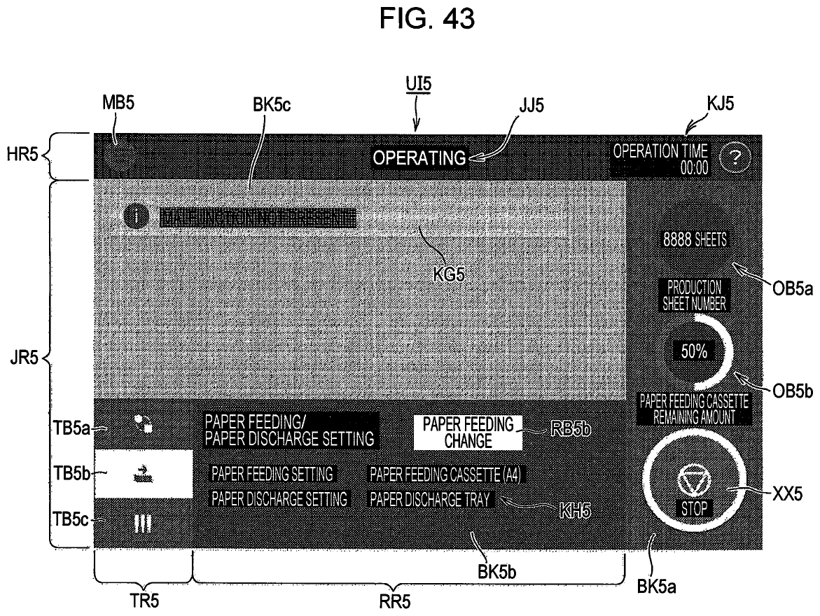

FIG. 43 is a diagram illustrating the fifth user interface UI5 in a state where the corresponding information display area RR5 related to the tab TB5b is displayed.

As is apparent from comparison between FIG. 43 and FIG. 11, during execution of the process related to manufacturing of the sheet, a paper feeding change instruction button RB5b is displayed in the corresponding information display area RR5 related to the tab TB5b. The paper feeding change instruction button RB5b is a touch operation button on which a touch operation is performed in the case of changing the setting related to feeding of the old paper.

In a case where a touch operation performed on the paper feeding change instruction button RB5b is detected, the control unit 20 displays a thirtieth user interface UI30 as a pop-up.

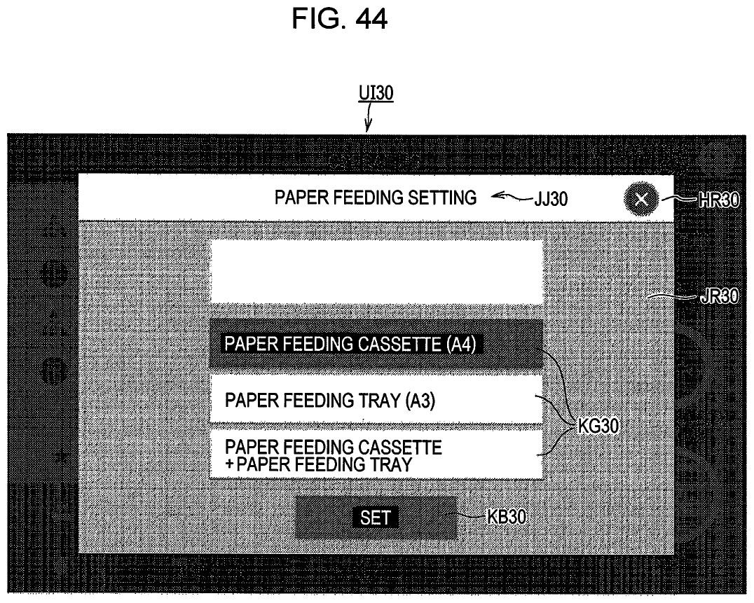

FIG. 44 is a diagram illustrating the thirtieth user interface UI30.

As illustrated in FIG. 44, the thirtieth user interface UI30 includes a state display area HR30 and an information display area JR30. State information JJ30 that indicates that setting related to paper feeding is performed is displayed in the state display area HR30.

As illustrated in FIG. 44, the content of the thirtieth user interface UI30 is changed depending on the paper feeding unit mounted on the sheet manufacturing apparatus 1, and the content is the same as the content of the area AR15a of the fifteenth user interface UI15. Accordingly, in the case of a state where the optional paper feeding tray is mounted as the paper feeding unit, three item images KG30 that enable selection of any one of the paper feeding cassette 11, the paper feeding tray, and the combination of the paper feeding cassette 11 and the paper feeding tray are displayed in the information display area JR30. The user can set the paper feeding unit to be used for supply of the old paper by performing a touch operation on any item image KG30. Accordingly, information, images, and other objects displayed in the thirtieth user interface UI30 in FIG. 44 will be designated by the same reference signs as the reference signs of information, images, and other objects displayed in the area AR15a of the fifteenth user interface UI15 illustrated in FIG. 23 and will not be described in detail.

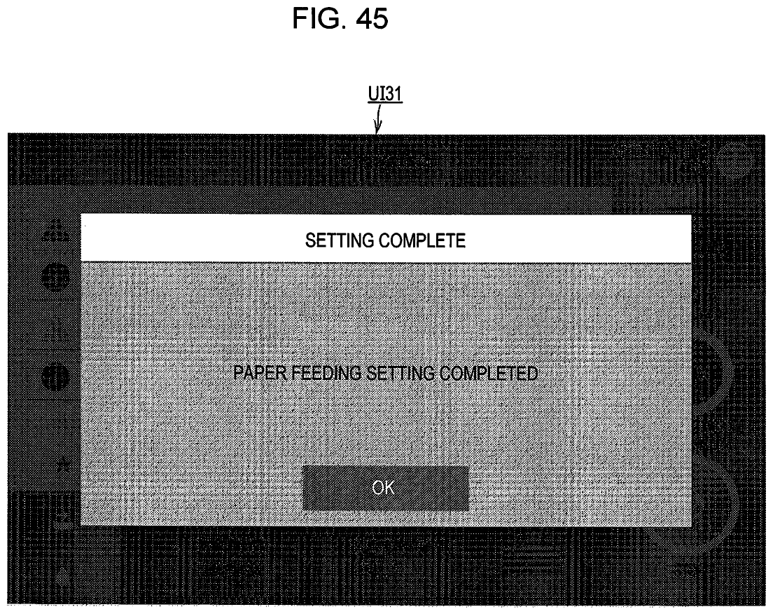

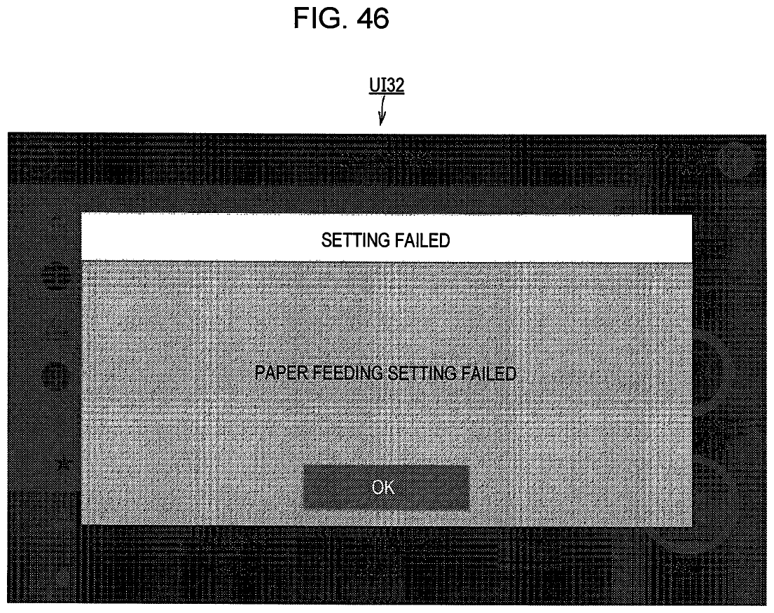

As illustrated in FIG. 44, a confirmation button KB30 for confirming an input into the thirtieth user interface UI30 is displayed in the lower portion of the information display area JR30 of the thirtieth user interface UI30. In the case of confirming the input in the thirtieth user interface UI30, the user performs a touch operation on the confirmation button KB30. In a case where a touch operation performed on the confirmation button KB30 is detected, the control unit 20 determines whether or not the setting performed by the user can be normally reflected. In a case where the setting performed by the user can be normally reflected, the control unit 20 notifies the user by displaying a thirty-first user interface UI31 (FIG. 45) in which information indicating that the setting succeeds is displayed, and displays the fifth user interface UI5 in response to an instruction from the user. Meanwhile, in a case where the setting performed by the user cannot be normally reflected, the control unit 20 notifies the user by displaying a thirty-second user interface UI32 (FIG. 46) in which information indicating that the setting fails is displayed, and displays the fifth user interface UI5 in response to an instruction from the user.

In a case where the setting succeeds, in the fifth user interface UI5 that is displayed on the touch panel 5 instead of the thirty-first user interface UI31, information on which the setting performed using the thirtieth user interface UI30 is reflected is displayed in the corresponding information display area RR5 related to the tab TB5b.

As described above, during execution of the process related to manufacturing of the sheet, the operation stoppage button XX5 is displayed in the fifth user interface UI5 (refer to FIG. 39).

In a case where a touch operation performed on the operation stoppage button XX5 is detected, the control unit 20 displays a thirty-third user interface UI33 as a pop-up without immediately stopping the process of manufacturing the sheet.

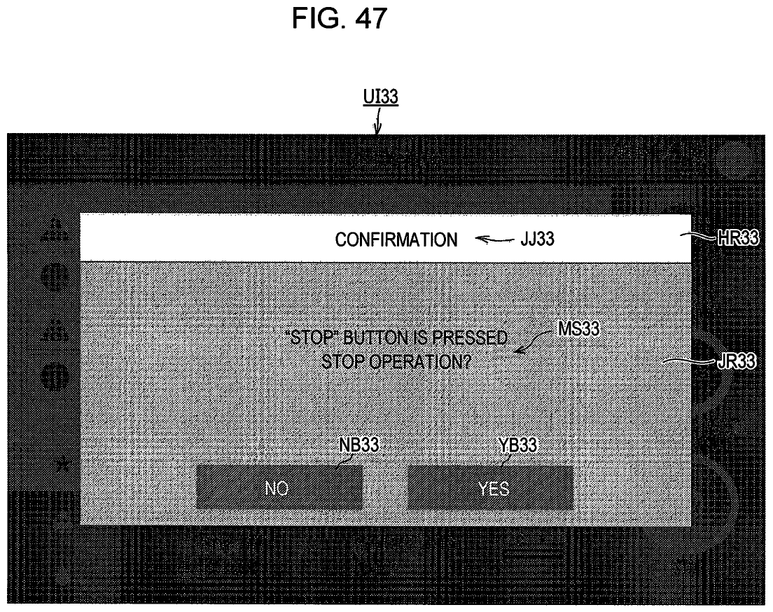

FIG. 47 is a diagram illustrating the thirty-third user interface UI33.

The thirty-third user interface UI33 is a user interface for causing the user to confirm the stoppage of the process of manufacturing the sheet.

As illustrated in FIG. 47, the thirty-third user interface UI33 includes a state display area HR33 and an information display area JR33. State information JJ33 (“confirmation”) that indicates that the stoppage of the process of manufacturing the sheet is being confirmed is displayed in the state display area HR33.

As illustrated in FIG. 47, a message MS33 (“the “stop” button is pressed/stop operation?”) that makes an inquiry to the user about whether or not to stop the process of manufacturing the sheet is displayed in the information display area JR33 of the thirty-third user interface UI33. In addition, in the information display area JR33, a negative button NB33 on which a touch operation is performed in the case of canceling the stoppage of the process, and a positive button YB33 on which a touch operation is performed in the case of providing an instruction to stop the process are displayed below the message MS33. In the case of not executing the stoppage of the process related to manufacturing of the sheet, the user performs a touch operation on the negative button NB33. In the case of executing the stoppage of the process related to manufacturing of the sheet, the user performs a touch operation on the positive button YB33.

It is assumed that even in a case where the user performs a touch operation on the operation stoppage button XX5 of the fifth user interface UI5, the case of canceling the stoppage of the process may occur due to a predetermined matter. In addition, it is assumed that a case where a touch operation is erroneously performed on the operation stoppage button XX5 may occur. Even in those cases, the process related to manufacturing of the sheet is not immediately stopped in response to the touch operation performed on the operation stoppage button XX5. A configuration in which the thirty-third user interface UI33 causes the user to confirm the stoppage of the process related to manufacturing of the sheet and stops the process only after an instruction is provided from the user again is used. Thus, the occurrence of an event in which the process is unnecessarily stopped can be prevented.

In a case where a touch operation performed on the negative button NB33 of the thirty-third user interface UI33 is detected, the control unit 20 cancels the stoppage of the process related to manufacturing of the sheet. That is, the control unit 20 continues executing the process related to manufacturing of the sheet.

In a case where a touch operation performed on the positive button YB33 of the thirty-third user interface UI33 is detected, the control unit 20 executes a necessary stoppage preparation process for stopping the process related to manufacturing of the sheet and displays a thirty-fourth user interface UI34 on the touch panel 5. The stoppage preparation process is a process that is performed in order to normally stop the process related to manufacturing of the sheet.

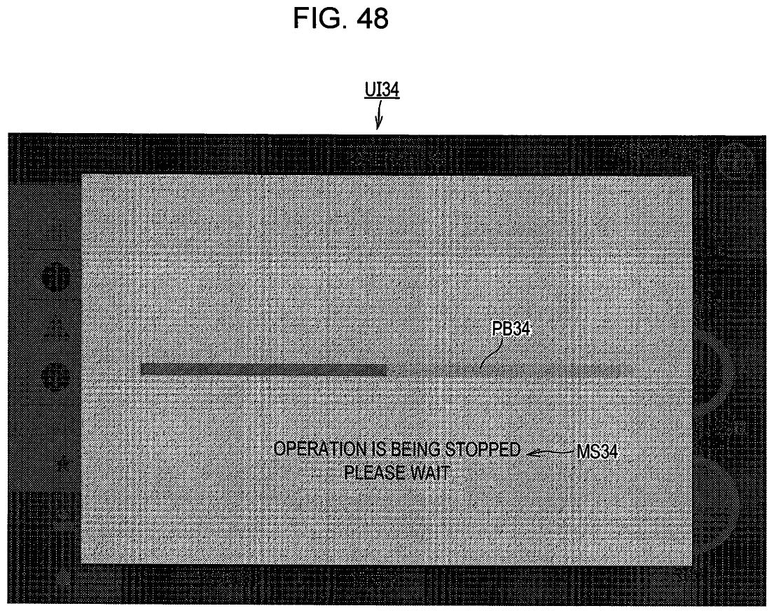

FIG. 48 is a diagram illustrating the thirty-fourth user interface UI34.

The thirty-fourth user interface UI34 is a user interface that represents that the stoppage preparation process is being executed, and represents the progress of the stoppage preparation process.

As illustrated in FIG. 48, the thirty-fourth user interface UI34 includes a progress bar PB34 that represents the progress of the stoppage preparation process.

As illustrated in FIG. 48, in the thirty-fourth user interface UI34, a message MS34 (“operation is being stopped/please wait”) that indicates that the stoppage preparation process is being executed, and the user is to wait is displayed below the progress bar PB34. By referring to the progress bar PB34 and the message MS34, the user can easily and appropriately recognize that the stoppage preparation process is being executed, and recognize a situation in which the user is to wait.

In a case where completion of the stoppage preparation process is detected, the control unit 20 stops displaying the thirty-fourth user interface UI34 and displays the fifth user interface UI5. The displayed fifth user interface UI5 is the fifth user interface UI5 that is displayed in the case of not executing the process like the fifth user interface UI5 illustrated in FIG. 8. The operation initiation button UB5 is displayed in the first block BK5a. The user can initiate the process related to manufacturing of the sheet by the sheet manufacturing apparatus 1 again by performing a touch operation on the operation initiation button UB5.

In a case where a touch operation performed on the item image KGMGg (an image on which a touch operation is performed in the case of providing an instruction to perform a shutdown) of the menu screen MG illustrated in FIG. 13 is detected, the control unit 20 displays a thirty-fifth user interface UI35.

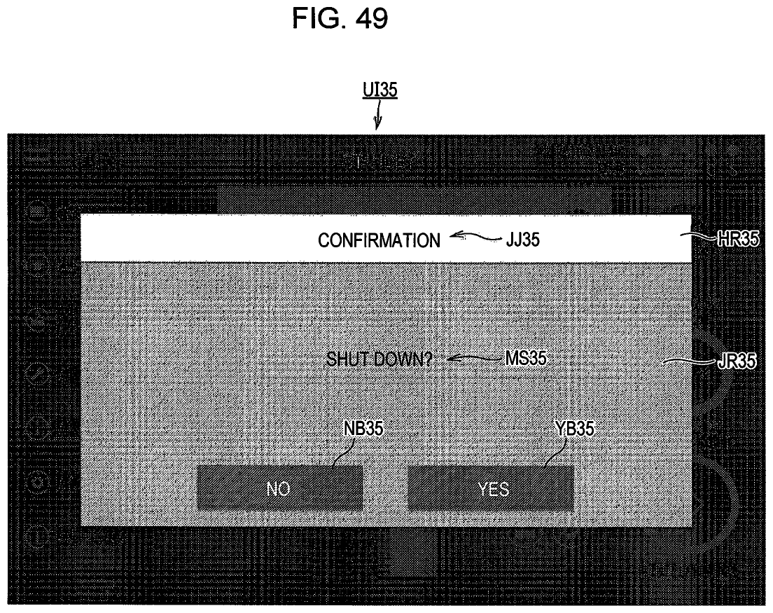

FIG. 49 is a diagram illustrating the thirty-fifth user interface UI35.

The thirty-fifth user interface UI35 is a user interface for causing the user to confirm the shutdown.

As illustrated in FIG. 49, the thirty-fifth user interface UI35 includes a state display area HR35 and an information display area JR35. State information JJ35 that indicates that the shutdown is being confirmed is displayed in the state display area HR35.

As illustrated in FIG. 49, a message MS35 (“shut down?”) that makes an inquiry to the user about whether or not to stop the process of manufacturing the sheet is displayed in the information display area JR35 of the thirty-fifth user interface UI35. In addition, in the information display area JR35, a negative button NB35 on which a touch operation is performed in the case of canceling the stoppage of the process, and a positive button YB35 on which a touch operation is performed in the case of providing an instruction to stop the process are displayed below the message MS35. In the case of canceling the shutdown, the user performs a touch operation on the negative button NB35. In the case of performing the shutdown, the user performs a touch operation on the positive button YB35. In such a manner, by causing the user to confirm the shutdown in the thirty-fifth user interface UI35, an unnecessary shutdown can be prevented in the same manner as the twenty-fifth user interface UI25 and the thirty-third user interface UI33.

In a case where a touch operation performed on the negative button N835 of the thirty-fifth user interface UI35 is detected, the control unit 20 cancels the shutdown.

In a case where a touch operation performed on the positive button YB35 of the thirty-fifth user interface UI35 is detected, the control unit 20 executes a necessary process (hereinafter, referred to as a “termination process”) for the shutdown and displays a thirty-sixth user interface UI36 on the touch panel 5.

The termination process includes a draining process. The draining process is a process of temporarily retaining water retained in the humidifier in the in-apparatus tank QT by draining the water to the in-apparatus tank QT disposed inside the apparatus main body of the sheet manufacturing apparatus 1. Furthermore, the user needs to retain the water retained in the in-apparatus tank QT in a container outside the sheet manufacturing apparatus 1 by draining the water to the container and discard the water retained in the container.

After initiation of the termination process, the control unit 20 first executes the draining process. A configuration in which a process that can be executed in parallel with the draining process is performed in parallel with the draining process may be used.

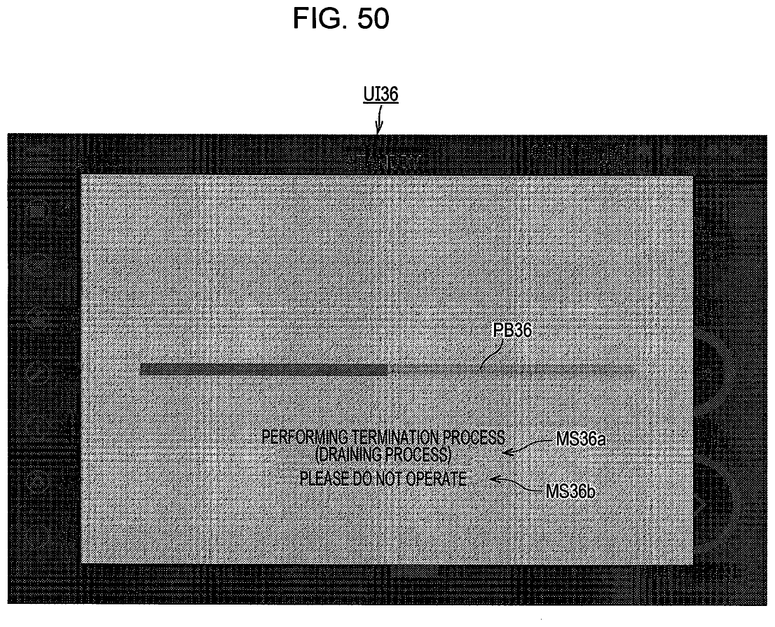

FIG. 50 is a diagram illustrating the thirty-sixth user interface UI36.

The thirty-sixth user interface UI36 is a user interface that represents that the draining process is being executed, and represents the progress of the draining process.

As illustrated in FIG. 50, the thirty-sixth user interface UI36 includes a progress bar PB36 that represents the progress of the draining process.

As illustrated in FIG. 50, in the thirty-sixth user interface UI36, a message MS36a (“performing the termination process (draining process)”) that indicates that the draining process is being executed, and a message MS36b (“please do not operate”) that alerts the user not to operate the sheet manufacturing apparatus 1 are displayed below the progress bar PB36. By referring to the progress bar PB36 and the messages MS36a and MS36b, the user can easily and appropriately recognize that the draining process is being executed, and recognize the progress of the draining process and an alert in the current stage.

In a case where completion of the draining process is detected, the control unit 20 displays a thirty-seventh user interface UI37 on the touch panel 5 instead of the thirty-sixth user interface UI36.

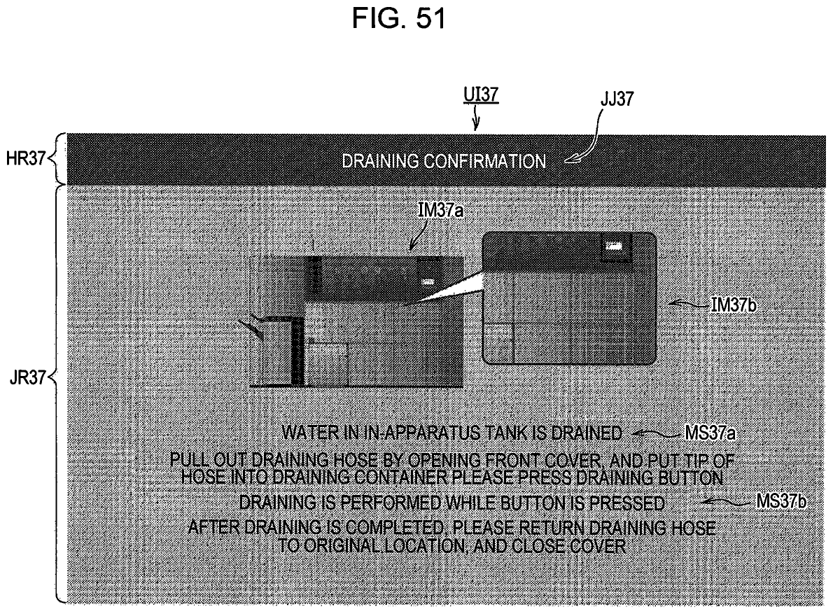

FIG. 51 is a diagram illustrating the thirty-seventh user interface UI37.

The thirty-seventh user interface UI37 is a user interface for prompting draining of water retained in the in-apparatus tank QT and indicating the procedure of draining.

As illustrated in FIG. 51, the thirty-seventh user interface UI37 includes a state display area HR37 and an information display area JR37. State information JJ37 that indicates that the user needs to perform draining is displayed in the state display area HR37.

As illustrated in FIG. 51, an image IM37a that represents the front view of the sheet manufacturing apparatus 1 is displayed in the information display area JR37 of the thirty-seventh user interface UI37. In addition, in the thirty-seventh user interface UI37, an image IM37b of the enlarged front cover 9 is displayed in correlation with the position of the front cover 9 in the image IM37a.

As illustrated in FIG. 51, in the thirty-seventh user interface UI37, a message MS37a (“water in the in-apparatus tank QT is drained”) that indicates the necessity of draining from the in-apparatus tank QT is displayed below the image IM37a. A message MS37b (“pull out a draining hose by opening the front cover, . . . /please press the draining button . . . / after draining is completed . . . ”) that indicates the procedure of draining is displayed below the message MS37a.

By referring to the message MS37a, the user can easily recognize that draining is to be performed. In addition, by referring to the message MS37b, the user can easily recognize the procedure of draining. Particularly, the procedure of draining includes a work of opening the front cover 9 and a work of closing the front cover 9. However, since the position of the front cover 9 in the sheet manufacturing apparatus 1 is explicitly shown by the image IM37a and the image IM37b, the user can appropriately recognize a necessary work for draining by referring to the image IM37a and the image IM37b along with the message MS37b.

In a case where a predetermined work is performed by the user, and completion of draining is detected, the control unit 20 executes the non-processed termination process and displays a thirty-eighth user interface UI38 instead of the thirty-seventh user interface UI37 by controlling the touch panel control unit 21.

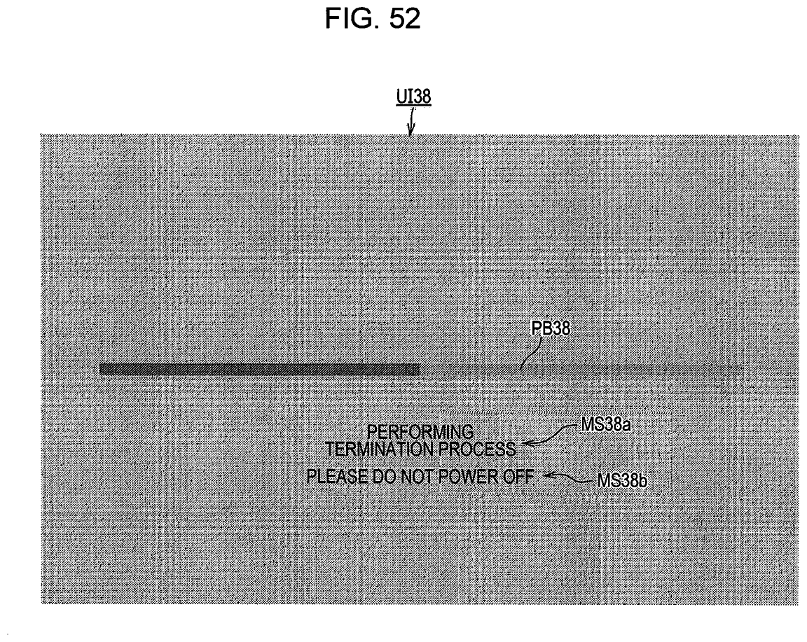

FIG. 52 is a diagram illustrating the thirty-eighth user interface UI38.

The thirty-eighth user interface UI38 is a user interface that represents that the termination process is being executed, and represents the progress of the termination process.

As illustrated in FIG. 52, the thirty-eighth user interface UI38 includes a progress bar PB38 that represents the progress of the draining process.

As illustrated in FIG. 52, in the thirty-eighth user interface UI38, a message MS38a (“performing the termination process”) that indicates that the termination process is being executed, and a message MS38b “please do not power off”) that alerts the user not to power the sheet manufacturing apparatus 1 off are displayed below the progress bar PB38. By referring to the progress bar PB38 and the messages MS38a and MS38b, the user can easily and appropriately recognize that the termination process is being executed, and recognize the progress of the termination process and an alert in the current stage.

In a case where completion of the termination process is detected, the control unit 20 displays a thirty-ninth user interface UI39 on the touch panel 5 instead of the thirty-eighth user interface UI38.

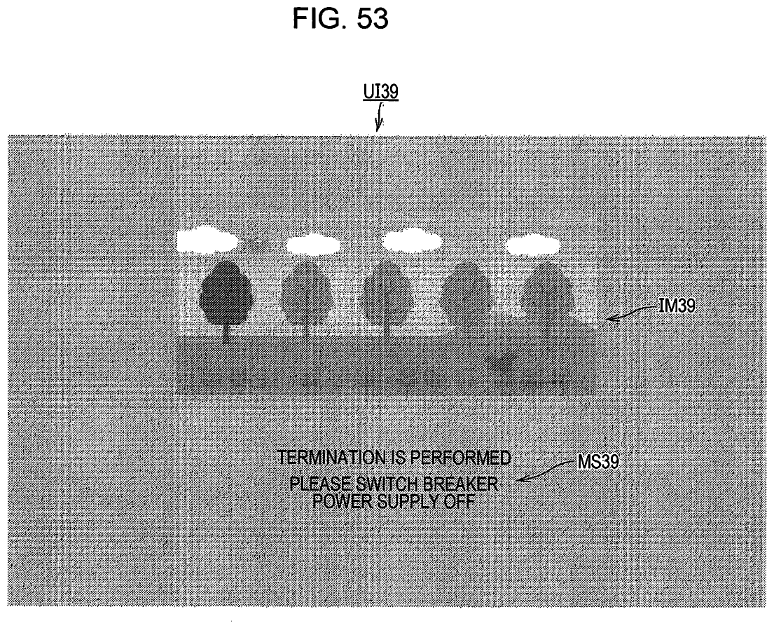

FIG. 53 is a diagram illustrating the thirty-ninth user interface UI39.

As illustrated in FIG. 53, an image IM39 that shows an illustration of a background is displayed in the thirty-ninth user interface UI39. A message MS39 that represents that the termination process is completed, and the breaker switch 8 is to be switched OFF is displayed below the image IM39. By referring to the thirty-ninth user interface UI39, the user can easily and appropriately recognize that the termination process is completed, and the breaker switch 8 is to be switched OFF.

Next, the screen displayed on the touch panel 5 in a case where the emergency stoppage button 6 is switched ON during execution of the process related to manufacturing of the sheet will be described.

In a case where switching ON of the emergency stoppage button 6 is detected, the control unit 20 executes an emergency stoppage process and displays a fortieth user interface UI40 as a pop-up. The emergency stoppage process is a process of stopping the process related to manufacturing of the sheet by performing a necessary process for urgently stopping the process related to manufacturing of the sheet in execution.

In addition, in a case where an operation performed on the emergency stoppage button 6 is detected, the control unit 20 displays the fortieth user interface UI40 as a pop-up.

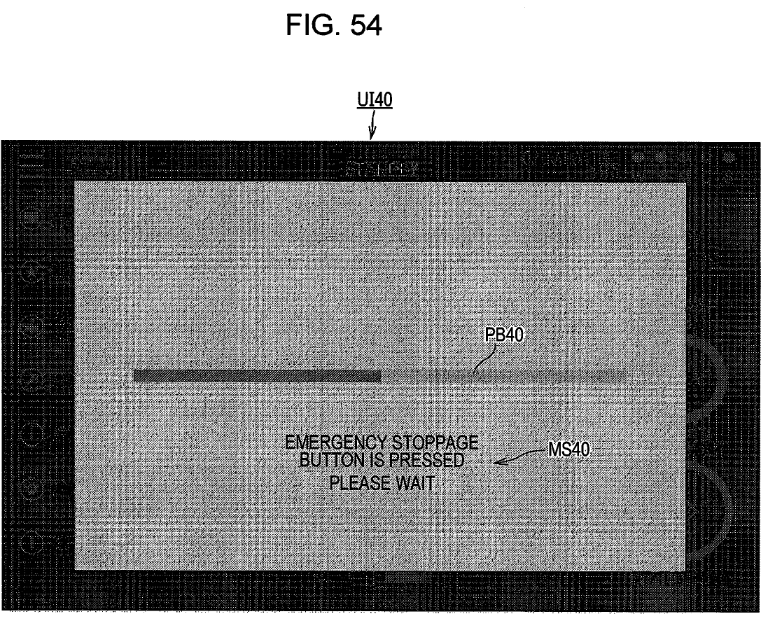

FIG. 54 is a diagram illustrating the fortieth user interface.

As illustrated in FIG. 54, the fortieth user interface UI40 includes a progress bar PB40 that represents the progress of the emergency stoppage process.

As illustrated in FIG. 54, in the fortieth user interface UI40, a message MS40 (“the emergency stoppage button is pressed/please wait”) that indicates that the emergency stoppage button 6 is switched ON, and the user is to wait until completion of the emergency stoppage process is displayed below the progress bar PB40. By referring to the progress bar PB40 and the message MS40, the user can easily and appropriately recognize that the emergency stoppage process is being executed, and recognize a situation in which the user is to wait.

In a case where completion of the emergency stoppage process is detected, the control unit 20 stops displaying the fortieth user interface UI40 and displays a forty-first user interface UI41 on the touch panel 5.

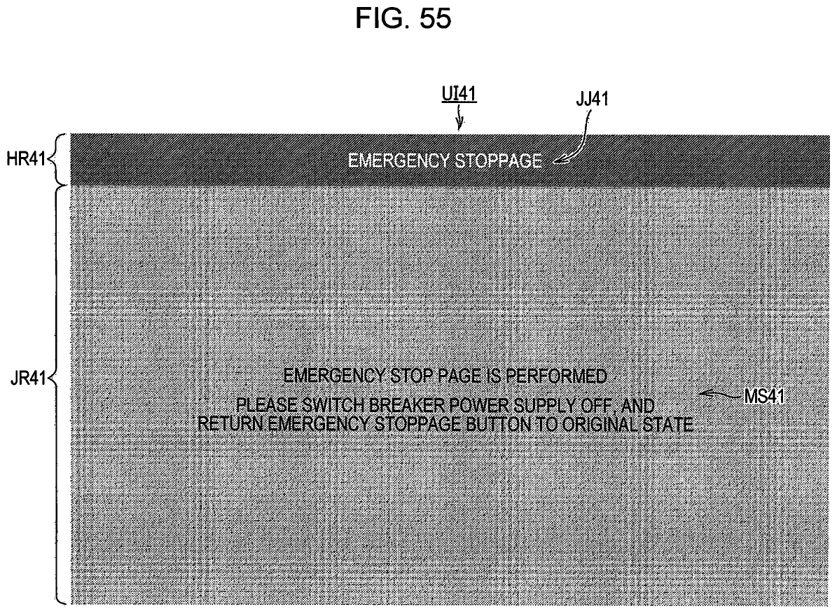

FIG. 55 is a diagram illustrating the forty-first user interface UI41.

As illustrated in FIG. 55, the forty-first user interface UI41 includes a state display area HR41 and an information display area JR41. State information JJ41 (“emergency stoppage”) that indicates that an emergency stoppage is performed is displayed in the state display area HR41. A message MS41 that represents that the emergency stoppage process is completed, the process is stopped, and the user is to switch the emergency stoppage button 6 OFF after switching the breaker switch 8 OFF is displayed in the information display area JR41. By referring to the message MS41, the user can easily and appropriately recognize that the process of manufacturing the sheet by the sheet manufacturing apparatus 1 is stopped, and the emergency stoppage button 6 is to be switched OFF after the breaker switch 8 is switched OFF.

Next, the screen displayed on the touch panel 5 in a case where an error (hereinafter, referred to as a “stoppage error”) for which the process related to manufacturing of the sheet needs to be stopped occurs in the sheet manufacturing apparatus 1 during execution of the process related to manufacturing of the sheet will be described. The stoppage error is, for example, insufficiency of consumables used in manufacturing of the sheet such as insufficiency of resin, insufficiency of water, or insufficiency of the raw material, an error in a transport path (a paper jam or the like), or an abnormal temperature of a predetermined mechanism.

In a case where the occurrence of the stoppage error is detected during execution of the process related to manufacturing of the sheet, the control unit 20 initiates execution of the emergency stoppage process and displays a forty-second user interface UI42 as a pop-up on the touch panel 5.

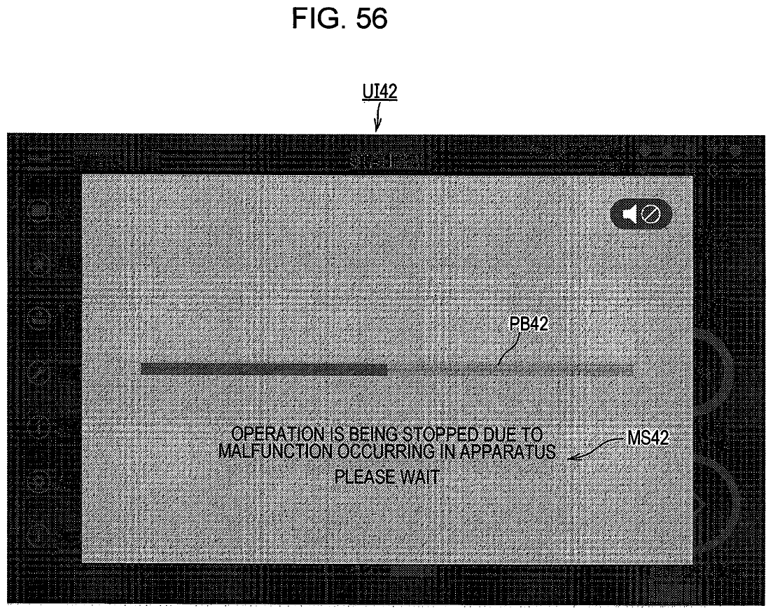

FIG. 56 is a diagram illustrating the forty-second user interface UI42.

The forty-second user interface UI42 is a user interface that represents that the emergency stoppage process accompanied by the occurrence of the stoppage error is being executed, and represents the progress of the emergency stoppage process.

As illustrated in FIG. 56, the forty-second user interface UI42 includes a progress bar PB42 that represents the progress of the emergency stoppage process.

As illustrated in FIG. 56, in the forty-second user interface UI42, a message MS42 (“operation is being stopped due to a malfunction occurring in the apparatus/please wait”) that indicates that the emergency stoppage process is being executed, and the user is to wait is displayed below the progress bar PB42. By referring to the progress bar PB42 and the message MS42, the user can easily and appropriately recognize that the emergency stoppage process is being executed, and recognize a situation in which the user is to wait.

In a case where completion of the emergency stoppage process is detected, the control unit 20 stops displaying the forty-second user interface UI42 and displays a forty-third user interface UI43.

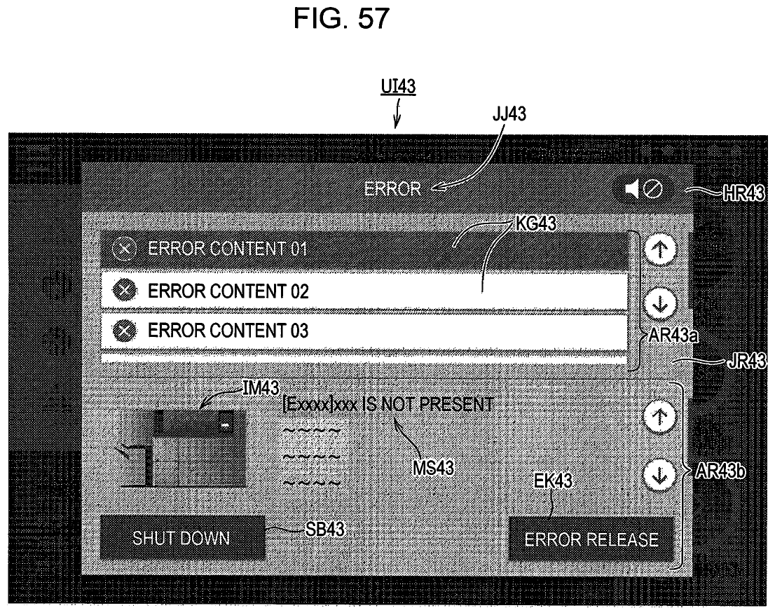

FIG. 57 is a diagram illustrating the forty-third user interface UI43.

As illustrated in FIG. 57, the forty-third user interface UI43 includes a state display area HR43 and an information display area JR43. State information JJ43 that indicates the occurrence of an error is displayed in the state display area HR43.

As illustrated in FIG. 57, the information display area JR43 of the forty-third user interface UI43 includes, as areas, an area AR43a formed in the upper portion and an area AR43b formed in the lower portion. An item image KG43 in which information indicating the content of the error is displayed is displayed in the area AR43a for each occurring error. The item image KG43 is a touch operation button. For an error for which the user wants to refer to detailed information, the user performs a touch operation on the corresponding item image KG43.

Detailed information related to the error selected by the user in the area AR43a is displayed in the area AR43b.

As illustrated in FIG. 57, an image IM43 that represents the front view of the sheet manufacturing apparatus 1 is displayed in the left portion of the area AR43b. Information, images, and other objects related to the error are appropriately displayed in the image represented in the image IM43 depending on the content of the error. For example, in a case where an error occurs at a predetermined position in the sheet manufacturing apparatus 1, information that explicitly shows the predetermined position is displayed in association with the image IM43. In addition, for example, in a case where an operation for the predetermined position in the sheet manufacturing apparatus 1 is needed in order to resolve the error, information that explicitly shows the predetermined position is displayed in association with the image IM43.

As illustrated in FIG. 57, a message MS43 that indicates a detailed content of the error is displayed on the right of the image IM43.

By referring to the image IM43 and the message MS43, the user can easily and appropriately recognize the detailed content of the error.

As illustrated in FIG. 57, in the area AR43b, a shutdown button SB43 for providing an instruction to perform a shutdown is displayed below the image IM43. The screen displayed in a case where a touch operation is performed on the shutdown button SB43, and the process of the control unit 20 are the same as described above.

In addition, an error release button EK43 is displayed on the right of the shutdown button SB43. The error release button EK43 is a touch operation button that is operated in a case where, for the selected error, the error is resolved by performing a work of resolving the error. In a case where a touch operation performed on the error release button EK43 is detected, the control unit 20 determines whether or not the error has been resolved. In a case where the error has been resolved, the control unit 20 removes the corresponding item image KG43 related to the error from the area AR43a.

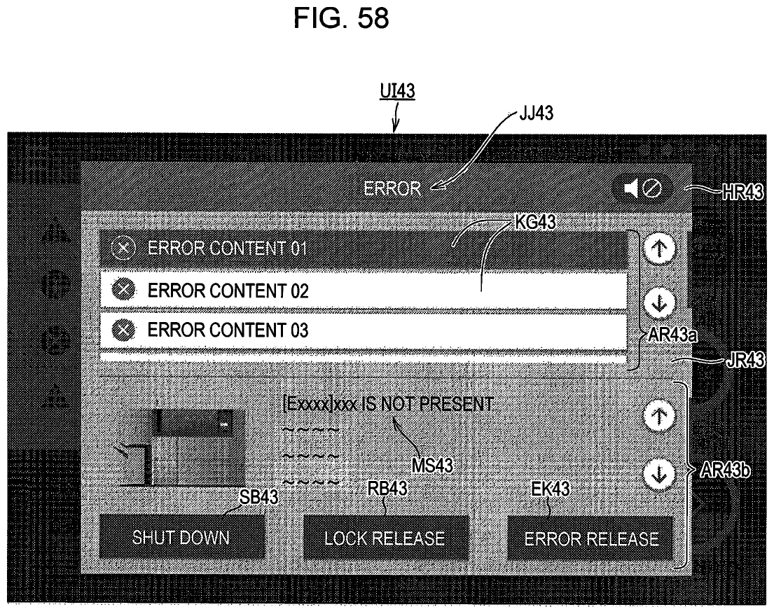

In addition, in a case where, for the selected error, a lock of a predetermined cover needs to be released in order to resolve the error, a lock release button RB43 (FIG. 58) for providing an instruction to release the lock is displayed in the area AR43b. FIG. 57 illustrates the forty-third user interface UI43 in a state where the lock release button RB43 is not displayed. FIG. 58 illustrates the forty-third user interface Ui43 in a state where the lock release button RB43 is displayed.

As illustrated in FIG. 58, in the area AR43b, the lock release button RB43 is displayed at a position that is interposed between the shutdown button SB43 and the error release button EK43. In a case where a touch operation performed on the error release button EK43 is detected, the control unit 20 releases the lock of the predetermined cover by controlling the lock unit 24.

In a case where the lock of the predetermined cover needs to be released in order to resolve the error, the user can release the lock by an easy work of performing a touch operation on the lock release button RB43.

Next, the screen displayed in a case where a service call error occurs, and the process of the control unit 20 will be described.

The service call error is an error for which the apparatus needs to be rebooted, and is an error for which contacting a service center performing maintenance is needed in a case where the error is not resolved even after rebooting of the apparatus.

In a case where the occurrence of the service call error is detected, the control unit 20 displays a forty-fourth user interface UI44 on the touch panel 5.

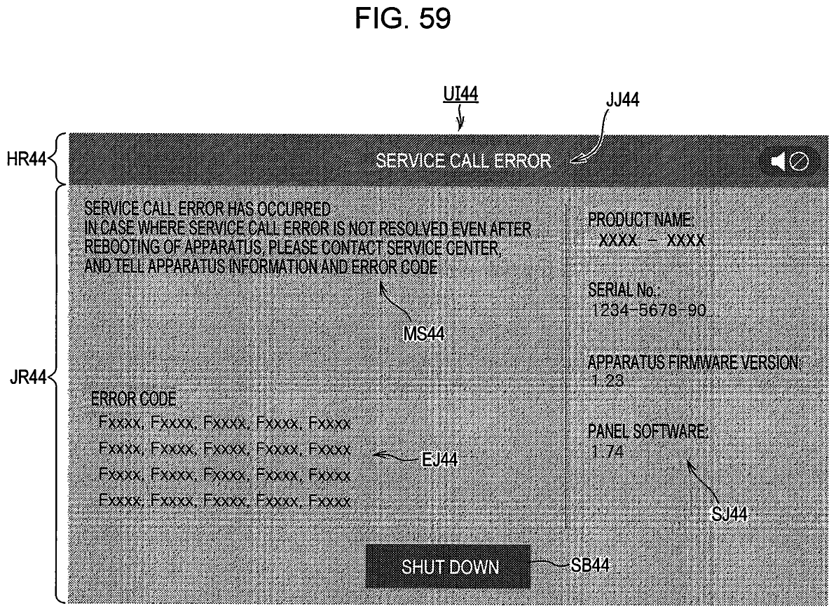

FIG. 59 is a diagram illustrating the forty-fourth user interface UI44.

As illustrated in FIG. 59, the forty-fourth user interface UI44 includes a state display area HR44 and an information display area JR44. State information JJ44 that indicates the occurrence of the service call error is displayed in the state display area HR44.

A message MS44 (“the service call error has occurred/in a case where rebooting the apparatus . . . /contact the service center . . . ”) that indicates the occurrence of the service call error and a measure against the service call error is displayed in the upper portion of the left portion of the information display area JR44 of the forty-fourth user interface UI44.

Error list information EJ44 in which an error code (identification information that uniquely identifies the error) is displayed as a list is displayed below the message MS44 for each occurring error.

By referring to the message MS44, the user can easily and appropriately recognize the measure against the service call error. In addition, in the case of contacting a person of the service center who performs maintenance, the user can appropriately tell the occurring error using the error code displayed in the error list information EJ44.

As illustrated in FIG. 59, apparatus list information SJ44 in which the apparatus information related to the sheet manufacturing apparatus 1 is displayed as a list is displayed in the right portion of the information display area JR44 of the forty-fourth user interface UI44. The apparatus list information SJ44 includes the product name, the serial No, and the version of the firmware of the sheet manufacturing apparatus 1 and the version of the application controlling display of the touch panel 5.

In addition, a shutdown button SB44 is displayed in the lower portion of the information display area JR44 of the forty-fourth user interface UI44.

As described above, the sheet manufacturing apparatus 1 according to the present embodiment is supplied with the raw material including fibers and manufactures the sheet by processing the supplied raw material. The sheet manufacturing apparatus 1 includes the control unit 20 that displays the fifth user interface UI5 (user interface) in which the raw material information related to the supplied raw material, the manufacturing information related to the manufactured sheet, and the processing information related to processing of the sheet are displayed.

According to this configuration, the user can refer to the raw material information, the manufacturing information, and the processing information at the same time through the same user interface without transitioning the user interface, and user's convenience of use is improved. Particularly, the raw material information, the manufacturing information, and the processing information are information having correlating contents and are assumed to be information that the user desires to refer to at the same time and compare. Thus, according to the present embodiment, user's convenience of use can be more appropriately improved.

In addition, in the present embodiment, the raw material information may be configured to include any of information related to the amount of the raw material supplied and consumed in a predetermined period, information related to the remaining amount of the raw material, and information related to the amount of the raw material consumed after manufacturing of the sheet based on the supplied raw material is initiated.

According to this configuration, by referring to the fifth user interface UI5, the user can easily and appropriately recognize the information related to the amount of the raw material supplied and consumed in a predetermined period, the information related to the remaining amount of the raw material, and the information related to the amount of the raw material consumed after manufacturing of the sheet based on the supplied raw material is initiated.

In addition, in the present embodiment, the manufacturing information may be configured to include any of information related to the number of sheets manufactured in a predetermined period and information related to the number of sheets manufactured after manufacturing of the sheet based on the supplied raw material is initiated.

According to this configuration, by referring to the fifth user interface UI5, the user can easily and appropriately recognize the information related to the number of sheets manufactured in a predetermined period and the information related to the number of sheets manufactured after manufacturing of the sheet based on the supplied raw material is initiated.

In addition, in the present embodiment, the raw material is the old paper of a paper shape.

According to this configuration, user's convenience of use of the sheet manufacturing apparatus 1 that is supplied with the old paper of a paper shape and manufactures the sheet can be improved.

In addition, in the present embodiment, the fifth user interface UI5 is configured with a plurality of blocks corresponding to the content of displayed information, and the raw material information and the manufacturing information are displayed in the same first block BK5a.

The content of the raw material information is correlated with the content of the manufacturing information. It is assumed that the user desires to refer to the raw material information and the manufacturing information at the same time and compare the contents of those information. Accordingly, by displaying the manufacturing information and the raw material information in the same block, the user can appropriately recognize that the manufacturing information and the raw material information are correlating information, and can refer to those information at the same time and appropriately compare the contents of those information.

In addition, in the present embodiment, the processing information includes information (recipe correlating information RP5) related to the color of the manufactured sheet.

According to this configuration, by referring to the processing information displayed in the fifth user interface UI5, the user can easily and appropriately recognize the color of the manufactured sheet.

In addition, the sheet manufacturing apparatus 1 according to the present embodiment includes a plurality of resin cartridges KT that retain resin of a plurality of colors by color. In addition, in a predetermined step (mixing step K6) of manufacturing the sheet, resin is supplied from one or a plurality of resin cartridges KT with respect to a predetermined material based on the raw material. The processing information includes information related to the color of the resin supplied with respect to the predetermined material as the information related to the color of the manufactured sheet.

According to this configuration, by referring to the processing information in the fifth user interface UI5, the user can easily and appropriately recognize the color of the resin supplied with respect to a predetermined material.

In addition, in the present embodiment, the processing information includes information related to the proportion of each color as the information related to the color of the resin supplied with respect to a predetermined material.

According to this configuration, by referring to the processing information in the fifth user interface UI5, the user can easily and appropriately recognize the proportion of the color of the supplied resin.

In addition, the sheet manufacturing apparatus 1 according to the present embodiment can manufacture the sheet of a predetermined size. The processing information includes information related to the size of the manufactured sheet.

According to this configuration, by referring to the processing information in the fifth user interface UI5, the user can easily and appropriately recognize the size of the manufactured sheet.

In addition, the sheet manufacturing apparatus 1 according to the present embodiment can manufacture the sheet of a predetermined thickness. The processing information includes information related to the thickness of the manufactured sheet.

According to this configuration, by referring to the processing information in the fifth user interface UI5, the user can easily and appropriately recognize the thickness of the manufactured sheet.

In addition, in the present embodiment, the control unit 20 displays the warning information related to warning as a list in the fifth user interface UI5.

According to this configuration, by referring to the fifth user interface UI5, the user can easily and appropriately recognize warning.

In addition, in the present embodiment, the control unit 20 displays the state information related to the state of the apparatus main body in the fifth user interface UI5.

According to this configuration, by referring to the fifth user interface UI5, the user can easily and appropriately recognize the state of the apparatus main body.

In addition, in the present embodiment, the state information includes information that indicates whether or not the sheet manufacturing apparatus 1 is executing the process of manufacturing the sheet.

According to this configuration, by referring to the fifth user interface UI5, the user can easily and appropriately recognize whether or not the sheet manufacturing apparatus 1 is executing the process of manufacturing the sheet.

In addition, in the present embodiment, the state information includes information related to the operation time from initiation of manufacturing of the sheet based on the supplied raw material.

According to this configuration, by referring to the fifth user interface UI5, the user can easily and appropriately recognize the operation time from initiation of manufacturing of the sheet based on the supplied raw material.

In addition, in the present embodiment, the fifth user interface UI5 includes an operation button (operation initiation button UB5) for providing an instruction to initiate the process of manufacturing the sheet. In a case where a touch operation performed on the operation initiation button UB5 is detected, the control unit 20 initiates the process of manufacturing the sheet.

According to this configuration, the user can initiate manufacturing of the sheet by an easy work of performing a touch operation on the operation initiation button UB5 without transitioning the fifth user interface UI5 to another user interface.

Next, modification examples will be described.

### Modification Example 1

Next, a first modification example (Modification Example 1) of the fifth user interface UI5 will be described.

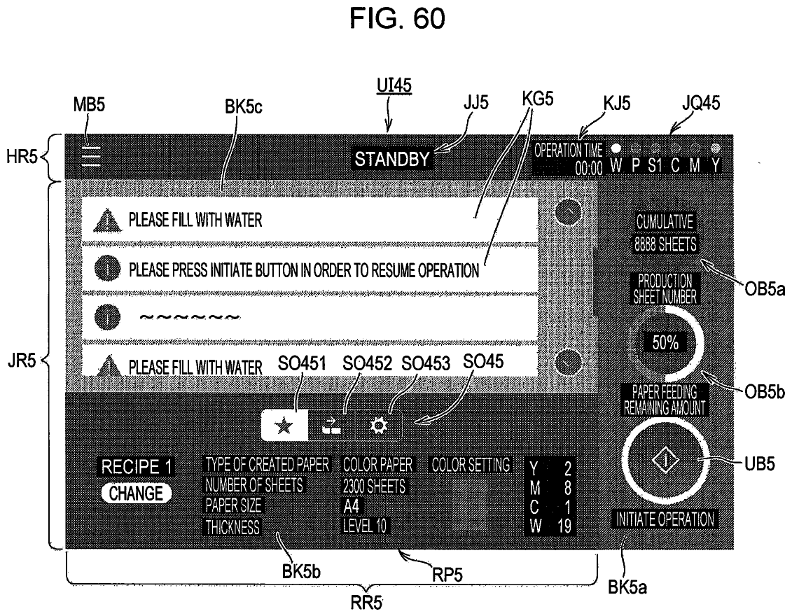

FIG. 60 is a diagram illustrating a forty-fifth user interface UI45 that is the first modification example of the fifth user interface UI5. In the forty-fifth user interface UI45 in FIG. 60, the same constituents as the fifth user interface UI5 in FIG. 8 will be designated by the same reference signs and will not be described.

As described using FIG. 8, the tabs TB5a to TB5c are displayed in the second block BK5b of the fifth user interface UI5. The fifth user interface UI5 is configured such that information displayed in the corresponding information display area RR5 is changed using the tabs TB5a to TB5c.

Meanwhile, in the second block BK5b of the forty-fifth user interface UI45 illustrated in FIG. 60, a selection image S045 is displayed instead of the tabs TB5a to TB5c. The selection image SO45 includes a first image SO451, a second image S0452, and a third image S0453 that are touch operation buttons. The first image SO451 is a touch operation button for providing an instruction to display the recipe correlating information RP5 in the corresponding information display area RR5. The second image SO452 is a touch operation button for providing an instruction to display the paper feeding/paper discharge information KH5 in the corresponding information display area RR5. The third image SO453 is a touch operation button for providing an instruction to display the consumable information SJ5 in the corresponding information display area RR5. The user selects information to be displayed in the corresponding information display area RR5 by performing a touch operation on any of the first image SO451, the second image SO452, and the third image SO453. The color of the background of the image selected by the user from the first image SO451, the second image SO452, and the third image SO453 is changed to a predetermined color, and the selected state of the image is explicitly shown.

As illustrated in the first modification example of the fifth user interface UI5, even in the case of a configuration in which information to be displayed in the corresponding information display area RR5 is selected by performing a touch operation on any image of the first image SO451, the second image SO452, and the third image SO453, the user can easily perform selection, and user's convenience of use is high.

In addition, as illustrated in FIG. 60, resin state information JQ45 is displayed in the state display area HR45. The resin state information JQ45 is information that indicates whether or not a state where resin is insufficient is set for each color of resin. The resin state information JQ45 may be information that indicates the resin supplied with respect to the raw material in manufacturing of the sheet.

### Modification Example 2

Next, a second modification example (Modification Example 2) of the fifth user interface UI5 will be described.

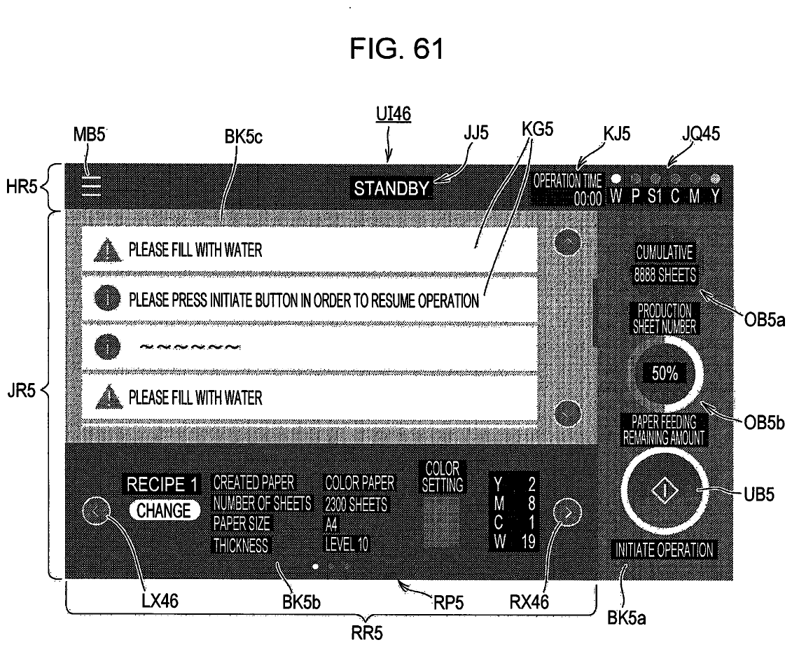

FIG. 61 is a diagram illustrating a forty-sixth user interface UI46 that is the second modification example of the fifth user interface UI5. In the forty-sixth user interface UI46 in FIG. 61, the same constituents as the fifth user interface UI5 in FIG. 8 and the same constituents as the forty-fifth user interface UI45 in FIG. 60 will be designated by the same reference signs and will not be described.

As described using FIG. 8, the tabs TB5a to TB5c are displayed in the second block BK5b of the fifth user interface UI5. The fifth user interface UI5 is configured such that information displayed in the corresponding information display area RR5 is changed using the tabs TB5a to TB5c.

Meanwhile, in the second block BK5b of the forty-sixth user interface UI46 illustrated in FIG. 61, a leftward transition button LX46 and a rightward transition button RX46 are displayed instead of the tabs TB5a to TB5c. Each of the leftward transition button LX46 and the rightward transition button RX46 is a touch operation button for providing an instruction to transition the information displayed in the corresponding information display area RR5 in a predetermined order among the recipe correlating information RP5, the paper feeding/paper discharge information KH5, and the consumable information SJS. For example, the forty-sixth user interface UI46 illustrated in FIG. 61 is in a state where the recipe correlating information RP5 is displayed. In this state, in a case where a touch operation is performed on the rightward transition button RX46, the information displayed in the corresponding information display area RR5 is switched to the paper feeding/paper discharge information KH5 from the recipe correlating information RPS. In this state, in a case where the rightward transition button RX46 is further operated, the information displayed in the corresponding information display area RR5 is switched to the consumable information SJ5 from the paper feeding/paper discharge information KHS.

As illustrated in the second modification example of the fifth user interface UI5, even in the case of a configuration in which information to be displayed in the corresponding information display area RR5 is selected by performing a touch operation on any of the leftward transition button LX46 and the rightward transition button RX46, the user can easily perform selection, and user's convenience of use is high.

### Modification Example 3

Next, a third modification example (Modification Example 3) of the fifth user interface UI5 will be described.

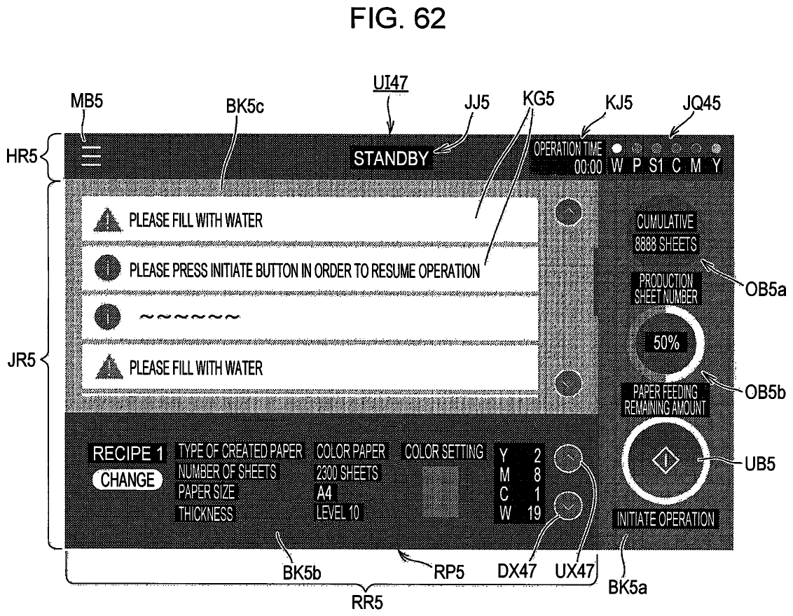

FIG. 62 is a diagram illustrating a forty-seventh user interface UI47 that is the third modification example of the fifth user interface UI5. In the forty-seventh user interface UI47 in FIG. 62, the same constituents as the fifth user interface UI5 in FIG. 8 and the same constituents as the forty-fifth user interface UI45 in FIG. 60 will be designated by the same reference signs and will not be described.

As described using FIG. 8, the tabs TB5a to TB5c are displayed in the second block BK5b of the fifth user interface UI5. The fifth user interface UI5 is configured such that information displayed in the corresponding information display area RR5 is changed using the tabs TB5a to TB5c.

Meanwhile, in the second block BK5b of the forty-seventh user interface UI47 illustrated in FIG. 62, an upward transition button UX47 and a downward transition button DX47 are displayed instead of the tabs TB5a to TB5c. Each of the upward transition button UX47 and the downward transition button DX47 is a touch operation button for providing an instruction to transition the information displayed in the corresponding information display area RR5 in a predetermined order among the recipe correlating information RP5, the paper feeding/paper discharge information KH5, and the consumable information SJ5. For example, the forty-seventh user interface UI47 illustrated in FIG. 62 is in a state where the recipe correlating information RP5 is displayed. In this state, in a case where a touch operation is performed on the downward transition button DX47, the information displayed in the corresponding information display area RR5 is switched to the paper feeding/paper discharge information KH5 from the recipe correlating information RPS. In this state, in a case where the downward transition button DX47 is further operated, the information displayed in the corresponding information display area RR5 is switched to the consumable information SJ5 from the paper feeding/paper discharge information KHS.

As illustrated in the third modification example of the fifth user interface UI5, even in the case of a configuration in which information to be displayed in the corresponding information display area RR5 is selected by performing a touch operation on any of the upward transition button UX47 and the downward transition button DX47, the user can easily perform selection, and user's convenience of use is high.

### Modification Example 4

Next, a fourth modification example (Modification Example 4) of the fifth user interface UI5 will be described.

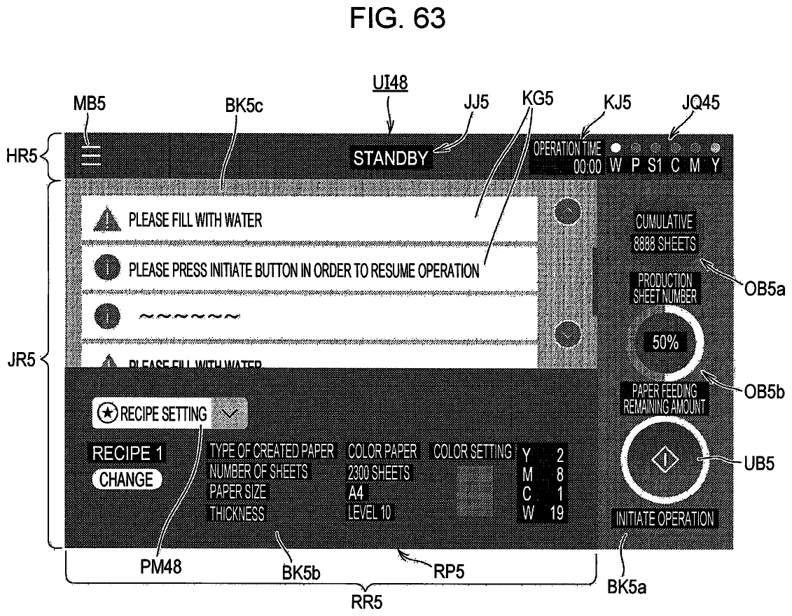

FIG. 63 is a diagram illustrating a forty-eighth user interface UI48 that is the fourth modification example of the fifth user interface UI5. In the forty-eighth user interface UI48 in FIG. 63, the same constituents as the fifth user interface UI5 in FIG. 8 and the same constituents as the forty-fifth user interface UI45 in FIG. 60 will be designated by the same reference signs and will not be described.

As described using FIG. 8, the tabs TB5a to TB5c are displayed in the second block BK5b of the fifth user interface UI5. The fifth user interface UI5 is configured such that information displayed in the corresponding information display area RR5 is changed using the tabs TB5a to TB5c.

Meanwhile, in the second block BK5b of the forty-eighth user interface UI48 illustrated in FIG. 63, a pull-down menu PM48 is displayed instead of the tabs TB5a to TB5c. The pull-down menu PM48 is a pull-down menu in which information (the recipe correlating information RPS, the paper feeding/paper discharge information KH5, and the consumable information SJ5) displayed in the corresponding information display area RR5 is displayed as an item. In FIG. 63, the pull-down menu PM48 is in a state where the pull-down menu is closed. The user can select information to be displayed in the corresponding information display area RR5 by selecting one item among items displayed in the pull-down menu PM48.

As illustrated in the fourth modification example of the fifth user interface UI5, even in the case of a configuration in which information to be displayed in the corresponding information display area RR5 is selected by the pull-down menu PM48, the user can easily perform selection, and user's convenience of use is high.

### Modification Example 5

Next, a fifth modification example (Modification Example 5) of the fifth user interface UI5 will be described.

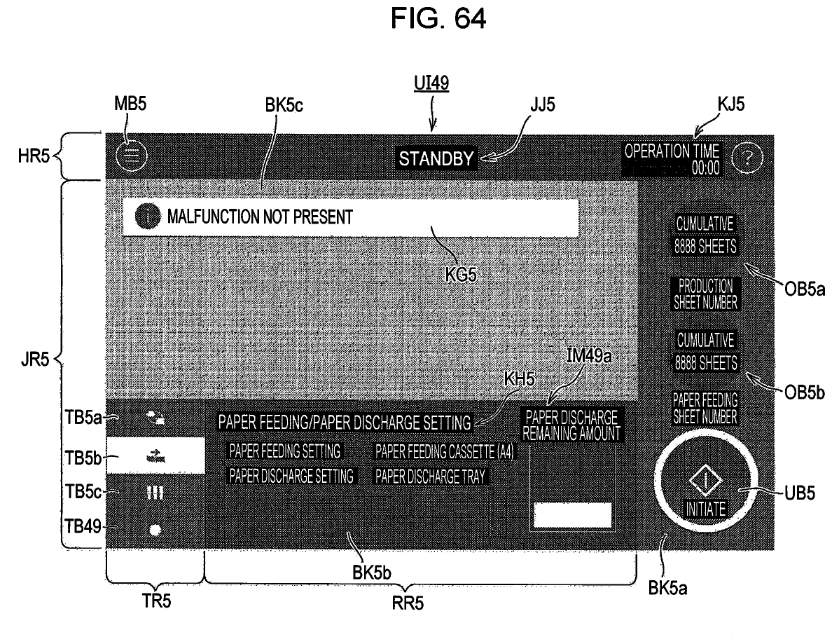

FIG. 64 is a diagram illustrating a forty-ninth user interface UI49 that is the fifth modification example of the fifth user interface UI5. In the forty-ninth user interface UI49 in FIG. 64, the same constituents as the fifth user interface UI5 in FIG. 11 will be designated by the same reference signs and will not be described.

FIG. 64 illustrates the forty-ninth user interface UI49 in a state where the tab TBSb is selected.

As is apparent from comparison between FIG. 11 and FIG. 64, an image IM49a that represents a paper discharge remaining amount is displayed in the corresponding information display area RR5 of the forty-ninth user interface UI49. The paper discharge remaining amount is the ratio of the number of currently manufactured sheets to the automatic stoppage sheet number. The image IM49a is an image that represents the ratio as a bar of which the length varies depending on the magnitude of the value of the ratio.

By referring to the image IM49a, the user can easily and appropriately recognize the paper discharge remaining amount.

As illustrated in FIG. 64, the forty-ninth user interface includes, as a tab, a tab TB49 in addition to the tabs TB5a to TB5c.

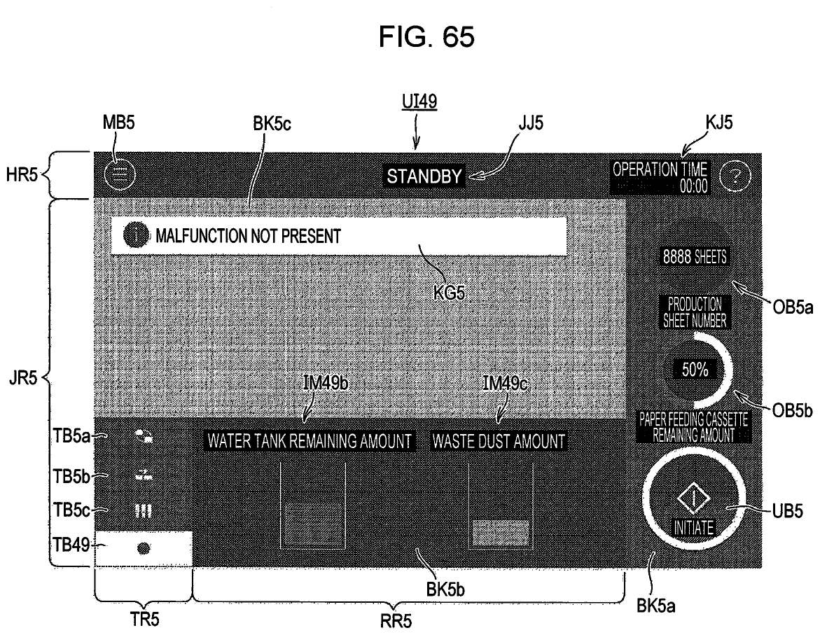

FIG. 65 illustrates the forty-ninth user interface UI49 in a state where the tab TB49 is selected.

As illustrated in FIG. 65, in a case where the tab TB49 is selected, an image IM49b and an image IM49c are displayed in the corresponding information display area RR5.

The image IM49b is an image that shows a water tank remaining amount. The water tank remaining amount is the remaining amount of water in the in-apparatus tank QT. The image IM49b is an image that represents the water tank remaining amount as a bar of which the length varies depending on the magnitude of the water tank remaining amount.

The image IM49c is an image that shows a waste dust amount. The waste dust amount is the amount of waste dust in the waste dust bag HH. The image IM49c is an image that represents the waste dust amount as a bar of which the length varies depending on the magnitude of the waste dust amount.

By referring to the image IM49b, the user can easily and appropriately recognize the water tank remaining amount. In addition, by referring to the image IM49c, the user can easily and appropriately recognize the waste dust amount.

### Modification Example 6

Next, a first modification example (Modification Example 6) of the twelfth user interface UI12 will be described.

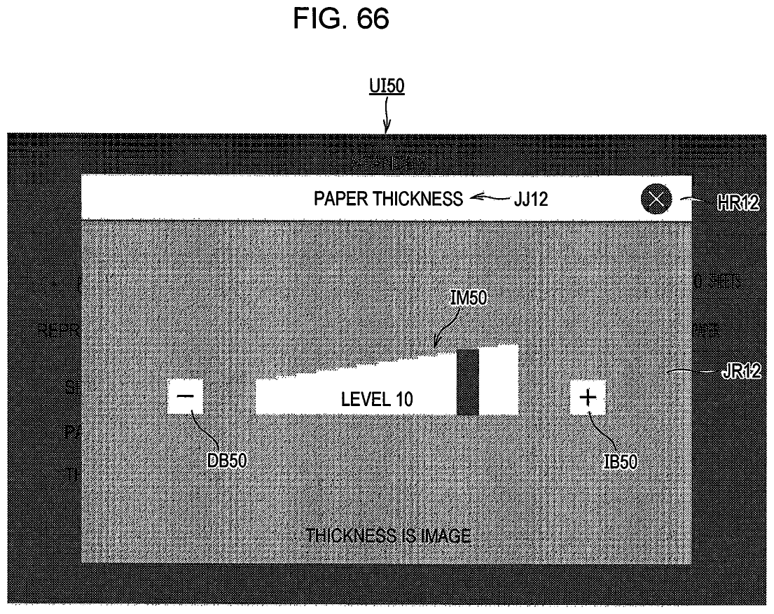

FIG. 66 is a diagram illustrating a fiftieth user interface UI50 that is the first modification example of the twelfth user interface UI12. In the fiftieth user interface UI50 in FIG. 66, the same constituents as the twelfth user interface UI12 in FIG. 20 will be designated by the same reference signs and will not be described.

As illustrated in FIG. 66, an image IM50 that represents the level of the paper thickness as an image of a staircase shape in which steps that are increased stepwise from left toward right are disposed is displayed in the information display area JR12 of the fiftieth user interface UI50. In the image IM50, a mark of a predetermined color is given to a part of a step that corresponds to the currently set level of the paper thickness. Furthermore, in the image IM50, information that represents the level of the paper thickness as a text is displayed.

By referring to the image IM50, the user can easily and appropriately recognize the level of the paper thickness.

As illustrated in FIG. 66, a decrement button DB50 for decrementing the value of the level of the paper thickness is displayed as a touch operation button on the left of the left end portion of the image IM50. In addition, an increment button IB50 for incrementing the value of the level of the paper thickness is displayed on the right of the right end portion of the image IM50. The user can set the value of the level of the paper thickness to a desired value within the range of “level 1” to “level 10” by an easy work of performing a touch operation on the decrement button DB50 and the increment button IB50. In addition, the content of the image IM50 is changed to show the corresponding value in response to a change in the value of the level of the paper thickness made by the user.

### Modification Example 7

Next, a second modification example (Modification Example 7) of the twelfth user interface UI12 will be described.

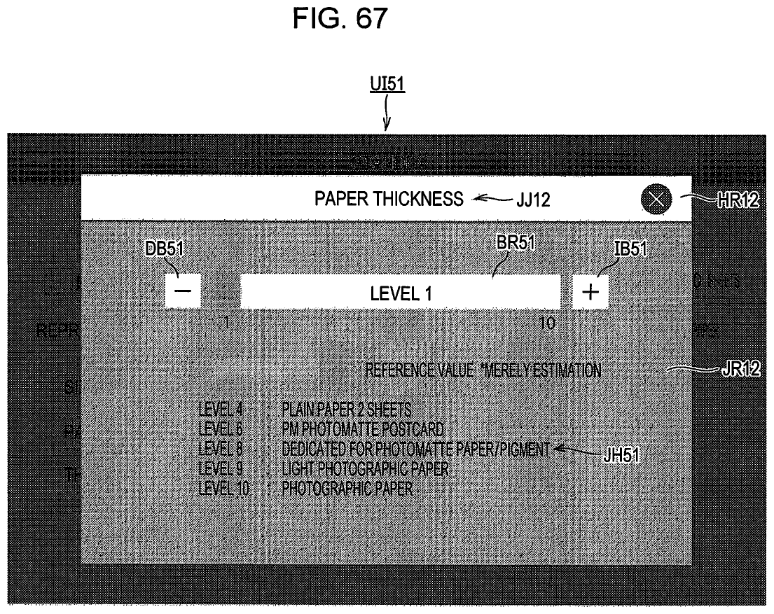

FIG. 67 is a diagram illustrating a fifty-first user interface UI51 that is the second modification example of the twelfth user interface UI12. In the fifty-first user interface UI51 in FIG. 67, the same constituents as the twelfth user interface UI12 in FIG. 20 will be designated by the same reference signs and will not be described.

As illustrated in FIG. 67, a bar BR51 of which the length varies in a frame depending on the magnitude of the value of the level of the paper thickness is displayed in the information display area JR12 of the fifty-first user interface UI51. In the bar BR51, information that represents the level of the paper thickness as a text is displayed. By referring to the bar BR51, the user can easily and appropriately recognize the level of the paper thickness.

As illustrated in FIG. 67, a decrement button DB51 for decrementing the value of the level of the paper thickness is displayed as a touch operation button on the left of the left end portion of the image bar BR51. In addition, an increment button IB51 for incrementing the value of the level of the paper thickness is displayed on the right of the right end portion of the bar BR51. The user can set the value of the level of the paper thickness to a desired value within the range of “level 1” to “level 10” by an easy work of performing a touch operation on the decrement button DB51 and the increment button IB51. In addition, the content of the bar BR51 is changed to show the corresponding value in response to a change in the value of the level of the paper thickness made by the user.

As illustrated in FIG. 67, reference value information JH51 is displayed below the bar BR51.

The reference value information JH51 is information that indicates a specific example of an estimated thickness of the sheet in a case where the sheet is manufactured at each level of a plurality of predetermined levels of the paper thickness. By referring to the reference value information JH51, the user can imagine the thickness of the sheet manufactured in the case of generating the sheet at a predetermined level.

### Modification Example 8

Next, a third modification example (Modification Example 8) of the twelfth user interface UI12 will be described.

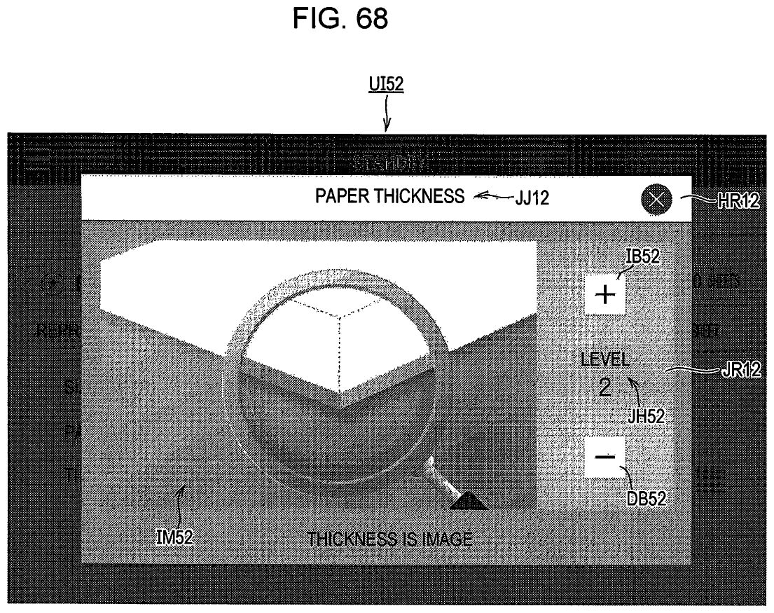

FIG. 68 is a diagram illustrating a fifty-second user interface UI52 that is the third modification example of the twelfth user interface UI12. In the fifty-second user interface UI52 in FIG. 68, the same constituents as the twelfth user interface UI12 in FIG. 20 will be designated by the same reference signs and will not be described.

As illustrated in FIG. 68, an image IM52 is displayed in the information display area JR12 of the fifty-second user interface UI52. The image IM52 includes an image that shows a perspective view of the sheet having an exaggerated thickness, and an image of a loupe that is arranged such that a corner part of the sheet is positioned within a lens.

In the corner part of the sheet within the lens of the loupe of the image IM52, 10 layers are formed in the up-down direction, and the thickness of the sheet is represented by filling the corresponding layers with a predetermined color stepwise from the bottom toward the top depending on the level of the paper thickness. In a case where the level of the paper thickness is the level 1, a state where the lowest layer is filled with the predetermined color within the lens of the loupe of the image IM52 is set. In a case where the level of the paper thickness is the level 10, a state where all layers are filled with the predetermined color within the lens of the loupe of the image IM52 is set.

By referring to the image IM52, the user can intuitively imagine the state of the thickness of the sheet in a case where the paper thickness is at a predetermined level.

As illustrated in FIG. 68, information JH52 that represents the level of the paper thickness as a text is displayed on the right of the image IM52. A decrement button DB52 for decrementing the value of the level of the paper thickness is displayed as a touch operation button below the information JH52. In addition, an increment button IB52 for incrementing the value of the level of the paper thickness is displayed above the information JH52. The user can set the value of the level of the paper thickness to a desired value within the range of “level 1” to “level 10” by an easy work of performing a touch operation on the decrement button DB52 and the increment button IB52. In addition, the contents of the image IM52 and the information JH52 are changed to show the corresponding value in response to a change in the value of the level of the paper thickness made by the user.

### Modification Example 9

Next, a fourth modification example (Modification Example 9) of the twelfth user interface UI12 will be described.

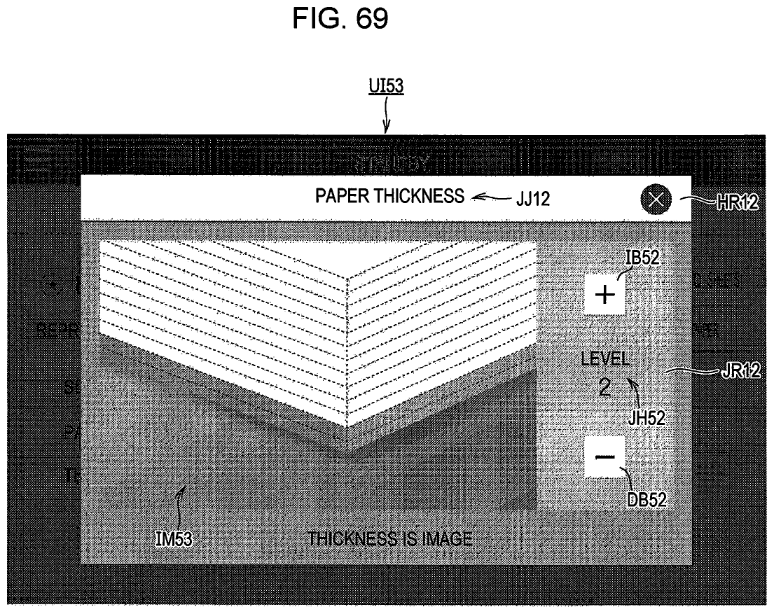

FIG. 69 is a diagram illustrating a fifty-third user interface UI53 that is the fourth modification example of the twelfth user interface UI12. In the fifty-third user interface UI53 in FIG. 69, the same constituents as the twelfth user interface UI12 in FIG. 20 and the same constituents as the fifty-second user interface UI52 in FIG. 68 will be designated by the same reference signs and will not be described.

As illustrated in FIG. 69, an image IM53 is displayed in the information display area JR12 of the fifty-fourth user interface UI54. The image IM53 is a diagram representing a section of each layer of the sheet by a dotted line with the image of the loupe removed from the image IM52 described in FIG. 68.

According to the fifty-third user interface UI53, the same effect as the fifty-second user interface UI52 can be achieved.

### Modification Example 10

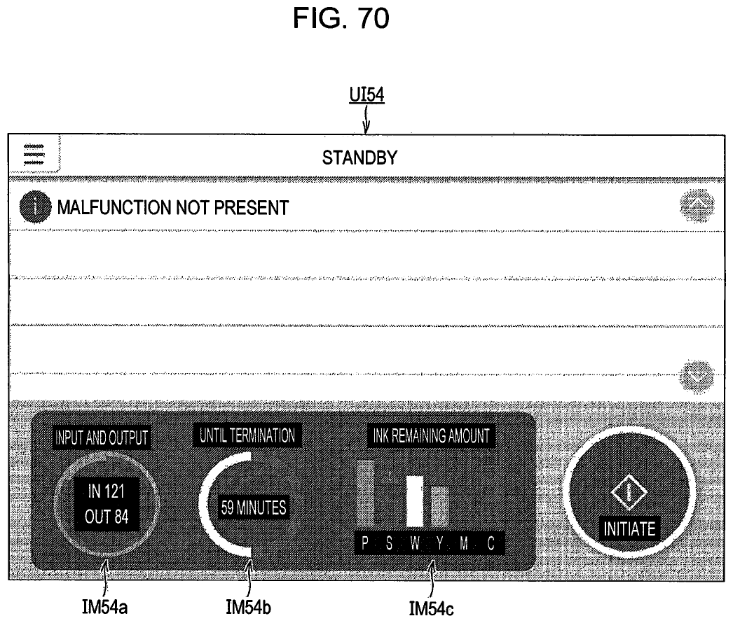

FIG. 70 is a diagram illustrating a fifty-fourth user interface UI54 according to Modification Example 10.

The fifty-fourth user interface UI54 illustrated in FIG. 70 may be configured to be displayed in a predetermined case.

As illustrated in FIG. 70, an image IM54a, an image IM54b, and an image IM54c are displayed in the fifty-fourth user interface UI54.

The image IM54a is an image in which information (“in Δ121”) indicating the number of sheets of the old paper consumed as the raw material and information (“out Δ84”) indicating the number of manufactured sheets are displayed within an image of a frame shape. By referring to the image IM54a, the user can easily and appropriately recognize the number of sheets of the old paper consumed as the raw material and the number of manufactured sheets and can easily compare those numbers.

The image IM54b is an image in which information that indicates the amount of time expected to be required for the number of sheets manufactured by the sheet manufacturing apparatus 1 to reach the automatic stoppage sheet number is displayed within an image of a frame shape. By referring to the image IM54b, the user can easily and appropriately recognize an approximate amount of time required until the automatic stoppage sheet number is reached.

The image IM54c is an image that represents the remaining amount of resin of each color as a bar of which the length varies depending on the magnitude of the remaining amount. By referring to the image IM54c, the user can easily and appropriately recognize the remaining amount of resin of each color.

The embodiment illustrates merely one aspect of the present invention. Any modifications and applications can be made within the scope of the present invention.

For example, the embodiment is configured such that the control unit 20 displays the user interface and other screens on the touch panel 5 disposed in the sheet manufacturing apparatus 1. However, a configuration in which the control unit 20 communicates with an external device and displays the user interface on the external device may be used.

In addition, while a configuration in which the sheet is manufactured by cutting the precut sheet in the cutting step is illustrated in the embodiment, a configuration in which the precut sheet is wound and picked up by a winding pick-up roller may be used.

In addition, at least a part of each function block illustrated in FIG. 3 may be implemented by hardware or may be configured to be implemented by cooperation between hardware and software and is not limited to a configuration in which independent hardware resources are arranged as illustrated in the drawings. In addition, the programs executed by the control unit 20 may be stored in a non-volatile storage unit or other storage devices (not illustrated). In addition, a configuration in which the programs stored in an external device are executed by acquiring the programs through a communication unit may be used.

### REFERENCE SIGNS LIST

1 SHEET MANUFACTURING APPARATUS

5 TOUCH PANEL

6 EMERGENCY STOPPAGE BUTTON

7 POWER SUPPLY SWITCH

8 BREAKER SWITCH

20 CONTROL UNIT

21 TOUCH PANEL CONTROL UNIT

22 STORAGE UNIT

23 INPUT UNIT

24 LOCK UNIT

25 DETECTING UNIT

31 SUPPLY UNIT

32 GRINDING UNIT

33 DEFIBRATING UNIT

34 SELECTING UNIT

35 DISENTANGLING UNIT

36 MIXING UNIT

37 ACCUMULATING UNIT

38 SHEET FORMING UNIT

39 CUTTING UNIT

40 PAPER DISCHARGE UNIT

41 HUMIDIFYING UNIT

1. A sheet manufacturing apparatus that is supplied with a raw material including fibers and manufactures a sheet by processing the supplied raw material, the apparatus comprising:
a control unit that displays a user interface in which raw material information related to the supplied raw material, manufacturing information related to the manufactured sheet, and processing information related to processing of the sheet are displayed.

2. The sheet manufacturing apparatus according to claim 1,
wherein the raw material information includes at least any one information of information related to an amount of the raw material supplied and consumed in a predetermined period, information related to a remaining amount of the raw material, and information related to the amount of the raw material consumed after manufacturing of the sheet based on the supplied raw material is initiated.

3. The sheet manufacturing apparatus according to claim 1,
wherein the manufacturing information includes at least any one information of information related to the number of sheets manufactured in a predetermined period and information related to the number of sheets manufactured after manufacturing of the sheet based on the supplied raw material is initiated.

4. The sheet manufacturing apparatus according to claim 1,
wherein the raw material has a paper shape.

5. The sheet manufacturing apparatus according to claim 1,
wherein the user interface is configured with a plurality of blocks corresponding to a content of displayed information, and
the raw material information and the manufacturing information are displayed in the same block.

6. The sheet manufacturing apparatus according to claim 1,
wherein the sheet of a predetermined color is capable of being manufactured, and
the processing information includes information related to a color of the manufactured sheet.

7. The sheet manufacturing apparatus according to claim 6, further comprising:
a plurality of resin cartridges that retain resin of a plurality of colors by color,
wherein in a predetermined step of manufacturing the sheet, resin is supplied from one or the plurality of resin cartridges with respect to a predetermined material based on the raw material, and
the processing information includes information related to a color of resin supplied with respect to the predetermined material as the information related to the color of the manufactured sheet.

8. The sheet manufacturing apparatus according to claim 7,
wherein the processing information includes information related to a proportion of each color as the information related to the color of resin supplied with respect to the predetermined material.

9. The sheet manufacturing apparatus according to claim 1,
wherein the sheet of a predetermined size is capable of being manufactured, and
the processing information includes information related to a size of the manufactured sheet.

10. The sheet manufacturing apparatus according to claim 1,
wherein the sheet of a predetermined thickness is capable of being manufactured, and
the processing information includes information related to a thickness of the manufactured sheet.

11. The sheet manufacturing apparatus according to claim 1,
wherein the control unit displays warning information related to warning as a list in the user interface.

12. The sheet manufacturing apparatus according to claim 1,
wherein the control unit displays state information related to a state of an apparatus main body in the user interface.

13. The sheet manufacturing apparatus according to claim 12,
wherein the state information includes information that indicates whether or not a process of manufacturing the sheet is being executed.

14. The sheet manufacturing apparatus according to claim 12,
wherein the state information includes information related to an operation time from initiation of manufacturing of the sheet based on the supplied raw material.

15. The sheet manufacturing apparatus according to claim 1,
wherein the user interface includes an operation button that provides an instruction to initiate a process of manufacturing the sheet, and
the control unit initiates the process of manufacturing the sheet in a case where an operation performed on the operation button is detected.

16. A control method for a sheet manufacturing apparatus that is supplied with a raw material including fibers and manufactures a sheet by processing the supplied raw material, the method comprising:
displaying a user interface in which raw material information related to the supplied raw material, manufacturing information related to the manufactured sheet, and processing information related to processing of the sheet are displayed.
